(19) United States
(12) Patent Application Publication
(10) Pub. No.: US 2025/0038604 A1
(43) Pub. Date: Jan. 30, 2025

(54) ROTARY ELECTRIC MACHINE

(71) Applicant: DENSO CORPORATION, Kariya-city (JP)

(72) Inventor: YUKI TAKAHASHI, Kariya-city (JP)

(21) Appl. No.: 18/912,346

(22) Filed: Oct. 10, 2024

Related U.S. Application Data
(63) Continuation of application No. PCT/JP2023/011176, filed on Mar. 22, 2023.

(30) Foreign Application Priority Data
Apr. 14, 2022 (JP) 2022-067192

(51) Int. Cl. H02K 3/47

(52) U.S. Cl. CPC H02K 3/47; H02K 2213/03

(57) ABSTRACT

In an armature, an inter-conductor member is provided between respective conductor portions in a circumferential direction. The inter-conductor member is made of a magnetic material that satisfies a relationship Wt×B100≤Wm×Br. Wt is a circumferential width of the inter-conductor member in one magnetic pole. B100 is a saturation magnetic flux density of the inter-conductor member. Wm is a circumferential width of the magnet in one magnetic pole, and Br is a residual magnetic flux density of the magnet. The saturation magnetic flux density B100 is a saturation magnetic flux density calculated with a magnetic density at a magnetizing force of 10,000 A/m.

### CROSS REFERENCE TO RELATED APPLICATION

The present application is a continuation application of International Patent Application No. PCT/JP2023/011176 filed on Mar. 22, 2023, which designated the U.S. and claims the benefit of priority from Japanese Patent Application No. 2022-067192 filed on Apr. 14, 2022. The entire disclosures of all of the above applications are incorporated herein by reference.

### TECHNICAL FIELD

The present disclosure relates to a rotary electric machine.

### BACKGROUND

Conventionally, a rotary electric machine including a rotor and stator has been known.

### SUMMARY

According to an aspect of the present disclosure, a rotary electric machine comprises: a field element including a magnet unit having a plurality of magnetic poles, in which polarities alternate in a circumferential direction; and an armature including a multi-phase armature winding.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a perspective view illustrating an entire rotary electric machine according to a first embodiment;

FIG. 2 is a plan view of the rotary electric machine;

FIG. 3 is a longitudinal sectional view of the rotary electric machine;

FIG. 4 is a transverse sectional view of the rotary electric machine;

FIG. 5 is an exploded sectional view of the rotary electric machine;

FIG. 6 is a sectional view of a rotor;

FIG. 7 is a partial transverse sectional view illustrating a sectional structure of a magnet unit;

FIG. 8 is a graph illustrating a relationship between an electrical angle and a magnetic flux density for a magnet according to the embodiment;

FIG. 9 is a graph illustrating a relationship between an electrical angle and a magnetic flux density for a magnet according to a comparative example;

FIG. 10 is a perspective view of a stator unit;

FIG. 11 is a longitudinal sectional view of the stator unit;

FIG. 12 is a perspective view of a core assembly as viewed from one side in an axial direction;

FIG. 13 is a perspective view of the core assembly as viewed from the other side in the axial direction;

FIG. 14 is a transverse sectional view of the core assembly;

FIG. 15 is an exploded sectional view of the core assembly;

FIG. 16 is a circuit diagram illustrating a connection state of a winding segment in each three-phase winding;

FIG. 17 is a side view illustrating a first coil module and a second coil module arranged side by side for comparison;

FIG. 18 is a side view illustrating a first winding segment and a second winding segment arranged side by side for comparison;

FIG. 19 is a set of views illustrating a configuration of the first coil module;

FIG. 20 is a sectional view taken along line 20-20 in FIG. 19(a);

FIG. 21 is a perspective view illustrating a configuration of an insulating cover;

FIG. 22 is a view illustrating a configuration of the second coil module;

FIG. 23 is a sectional view taken along line 23-23 in (a) in FIG. 22;

FIG. 24 is a perspective view illustrating a configuration of the insulating cover;

FIG. 25 is a view illustrating an overlapping position of the film member in a state where the coil modules are arranged in a circumferential direction;

FIG. 26 is a plan view illustrating a state where the first coil module is assembled to the core assembly;

FIG. 27 is a plan view illustrating a state where the first coil module and the second coil module are assembled to the core assembly;

FIG. 28 is a longitudinal sectional view illustrating a fixed state by using a fastening pin;

FIG. 29 is a perspective view of a bus bar module;

FIG. 30 is a sectional view illustrating part of a longitudinal section of the bus bar module;

FIG. 31 is a perspective view illustrating a state where the bus bar module is assembled to a stator holder;

FIG. 32 is a longitudinal sectional view of a stationary portion in which the bus bar module is fixed;

FIG. 33 is a longitudinal sectional view illustrating a state where a lead member is attached to the housing cover;

FIG. 34 is a perspective view of the lead member;

FIG. 35 is an electrical circuit diagram illustrating a control system of the rotary electric machine;

FIG. 36 is a functional block diagram illustrating a current feedback control operation by a controller;

FIG. 37 is a functional block diagram illustrating a torque feedback control operation by the controller;

FIG. 38 is a partial transverse sectional view illustrating a sectional structure of the magnet unit in a modification;

FIG. 39 is a view illustrating a configuration of the stator unit having an inner rotor structure;

FIG. 40 is a plan view illustrating a state where the coil modules are assembled to the core assembly;

FIG. 41 is a longitudinal cross-sectional view of a rotary electric machine according to a second embodiment;

FIG. 42 is a transverse sectional view of the rotary electric machine;

FIG. 43 is a transverse sectional view of the rotary electric machine;

FIG. 44 is an exploded sectional view of the rotary electric machine;

FIG. 45 is an exploded perspective view of the fixed piece unit;

FIG. 46 is an exploded perspective view of the stator;

FIG. 47 is an exploded perspective view of the stator;

FIG. 48 is an exploded sectional view of the stator unit;

FIG. 49 includes perspective views illustrating configurations of winding segments;

FIG. 50 is an exploded perspective view illustrating the insulating cover in the winding segment;

FIG. 51 includes perspective views illustrating configurations of winding segments;

FIG. 52 is an exploded perspective view illustrating the insulating cover in the winding segment;

FIG. 53 is a plan view illustrating a state where the winding segments are disposed side by side in the circumferential direction;

FIG. 54 is a transverse sectional view of the stator holder;

FIG. 55 is a perspective view of the stator unit as viewed from the side of a wiring module;

FIG. 56 is an exploded sectional view illustrating the rotary electric machine divided into the stationary portion and a rotary portion;

FIG. 57 is a circuit diagram of a stator winding according to the second embodiment;

FIG. 58 is a developed view of the stator winding and bus bars;

FIG. 59 is a circuit diagram of a stator winding according to a comparative example;

FIG. 60 is a set of side views schematically illustrating a first winding segment and a second winding segment according to yet another example;

FIG. 61 is a set of perspective views schematically illustrating the first winding segment and the second winding segment according to the other example;

FIG. 62 is a set of perspective views schematically illustrating the first winding segment and the second winding segment according to the other example;

FIG. 63 is a set of side views schematically illustrating a first winding segment and a second winding segment according to yet another example;

FIG. 64 is a set of side views schematically illustrating a first winding segment and a second winding segment according to yet another example;

FIG. 65 is a set of perspective views schematically illustrating the first winding segment and the second winding segment according to the other example;

FIG. 66 is a set of side views schematically illustrating a first winding segment and a second winding segment according to yet another example;

FIG. 67 is a cross-sectional view of a conductor according to a third embodiment;

FIG. 68 is a schematic cross-sectional view of a magnet unit and a stator in a fourth embodiment;

FIG. 69 is a schematic cross-sectional view of a magnet unit and a stator in another example of the fourth embodiment;

FIG. 70 is a schematic cross-sectional view of a magnet unit and a stator in another example of the fourth embodiment;

FIG. 71 is a schematic cross-sectional view of a magnet unit in another example of the fourth embodiment;

FIG. 72 is a schematic cross-sectional view of a magnet unit in another example of the fourth embodiment;

FIG. 73 is a schematic cross-sectional view of a magnet unit in another example of the fourth embodiment;

FIG. 74 is a schematic cross-sectional view of a magnet unit in a fifth embodiment;

FIG. 75 is a flowchart showing a flow of a magnet manufacturing method according to the fifth embodiment;

FIG. 76 is a schematic diagram of a molded body;

FIG. 77 is a cross-sectional view showing a schematic diagram of a die;

FIG. 78 is a schematic diagram showing a plastic forming step of the molded body;

FIG. 79 is a schematic diagram showing the plastic forming step of the molded body;

FIG. 80 is a longitudinal cross-sectional view of a rotary electric machine according to a sixth embodiment;

FIG. 81 is a transverse cross-sectional view of the rotary electric machine according to the sixth embodiment;

FIG. 82 is a schematic vertical cross-sectional view of a rotary electric machine according to a seventh embodiment;

FIG. 83 is a diagram illustrating an arrangement of a magnet unit and a stator in the seventh embodiment;

FIG. 84 is a vertical cross-sectional view showing a schematic configuration of an axial gap type rotary electric machine according to an eighth embodiment;

FIG. 85 is a diagram showing a configuration of a rotor according to the eighth embodiment;

FIG. 86 is a diagram showing a configuration of the rotor according to the eighth embodiment;

FIG. 87 is a plan view showing a configuration of a stator according to the eighth embodiment;

FIG. 88 is a perspective view showing a configuration of a stator core according to the eighth embodiment;

FIG. 89 is a diagram showing a configuration of a magnet section of the eighth embodiment;

FIG. 90 is a diagram showing the configuration of the magnet section of the eighth embodiment;

FIG. 91 is a vertical cross-sectional view showing a schematic configuration of an axial gap type rotary electric machine having a double stator structure;

FIG. 92 is a vertical cross-sectional view showing a schematic configuration of an axial gap type rotary electric machine having a double rotor structure;

FIG. 93 is a schematic diagram showing a magnetic flux path of a magnet;

FIG. 94 is a schematic diagram showing a magnetic flux path of a magnet according to another embodiment;

FIG. 95 is a schematic diagram showing a magnetic flux path of a magnet according to another embodiment;

FIG. 96 is a cross-sectional view of another example of a conductor; and

FIG. 97 is a diagram showing another example of a magnet and a stator.

### DETAILED DESCRIPTION

Hereinafter, examples of the present disclosure will be described.

According to an example of the present disclosure, an IPM (Interior Permanent Magnet) type rotor is employed as a rotary electric machine. In the IPM motor, a rotor core is made of stacked electromagnetic steel sheets, a magnet accommodating holes are formed in the rotor core, and magnets are inserted into the magnet accommodating holes. The example of the magnet may enable to produce a magnet with a surface magnetic flux density distribution that is close to a sine wave, and eddy current loss can be suppressed due to the gradual change in the magnetic flux compared to a radial magnet. In addition, the example of the magnet may enable to increase the magnetic flux density.

However, when the surface magnetic flux density of the rotor core is increased, magnetic saturation is more likely to occur on the stator side. This tendency becomes particularly noticeable when a permanent magnet with a high residual magnetic flux density Br is used for the rotor core. When magnetic saturation occurs on the stator side, magnetic flux leakage is likely to occur from the designed magnetic circuit. This results in a issue that the magnetic flux from the rotor core is not effectively utilized, resulting in a limited torque. In other words, even in the configuration in which the surface magnetic flux density of the rotor core is increased, the torque cannot be increased as intended.

According to an example of the present disclosure, a rotary electric machine comprises: a field element including a magnet unit having a plurality of magnetic poles, in which polarities alternate in a circumferential direction; and an armature including a multi-phase armature winding. The field element or the armature is a rotor. The magnet unit includes a plurality of magnets arranged in the circumferential direction. The magnet unit is configured, so that a direction of an easy axis of magnetization is closer to parallel to a d-axis on a side of the d-axis, which is a magnetic pole center, than an easy axis of magnetization on a side of the q-axis, which is a magnetic pole boundary. The armature winding includes conductor portions arranged at predetermined intervals in the circumferential direction and facing the field element, and an inter-conductor member provided between the conductor portions in the circumferential direction. The inter-conductor member is made of a magnetic material that satisfies a relationship Wt×B100≤Wm×Br. Wt is a circumferential width of the inter-conductor member in one magnetic pole. B100 is a saturation magnetic flux density of the inter-conductor member. Wm is a circumferential width of the magnet in one magnetic pole. Br is a residual magnetic flux density of the magnet. B100 is the saturation magnetic flux density calculated with a magnetic flux density under a magnetizing force of 10,000 A/m.

According to the above configuration, the inter-conductor member provided between the respective conductor portions are magnetically saturated by the magnetic flux from the magnet unit. In other words, the inter-conductor member does not induce magnetic flux into the magnetic circuit. This enables the magnetic flux to flow according to the designed magnetic circuit, and to eliminate torque limitations due to the magnetic saturation. Furthermore, the inter-conductor member can be easily designed. The saturation magnetic flux density B100 is the saturation magnetic flux density calculated at a magnetizing force of 10,000 A/m. This enables more accurate design when a strong magnet unit is used.

According to an example of the present disclosure, the armature winding is formed by a concentrated winding. The inter-conductor member includes a plurality of the inter-conductor members in one magnetic pole of the magnet unit. Wt is a sum of widths of the inter-conductor members in one magnetic pole of the magnet unit in the circumferential direction.

According to the above configuration, it is possible to carry out design easily and accurately.

According to an example of the present disclosure, the circumferential widths of the inter-conductor members are not uniform in the radial direction. Wt is a narrowest value among the circumferential widths of the inter-conductor members.

Magnetic saturation is likely to occur at the narrowest point of the inter-conductor member. Therefore, the above configuration enables to carry out the design accurately.

According to an example of the present disclosure, the magnet unit is formed by arranging a plurality of first magnets and a plurality of second magnets alternately in the circumferential direction. A magnetic flux path of the first magnet is closer to parallel to a radial direction than a magnetic flux path of the second magnet. The first magnet is provided on the side of the d-axis. The second magnet is provided on the side of the q-axis. Wm is the circumferential width of the magnet unit in one magnetic pole that is calculated by a sum of a circumferential width of the first magnet in one magnetic pole and a circumferential width of the second magnet in the one magnetic pole.

Even when the magnets are arranged in this way, the configuration enables simple and accurate design.

According to an example of the present disclosure, the magnet unit is formed by embedding the magnet in an iron core. The magnet is divided into a plurality of magnet portions in one magnetic pole. Wm is obtained by subtracting a circumferential width of a gap between the magnet portions from a circumferential width from an end of the magnet to an end of the magnet in the one magnetic pole.

According to the configuration, the circumferential width Wm of the magnet unit in one magnetic pole can be set accurately, taking into consideration the magnetic flux path that is short-circuited via the iron core between the magnets.

According to an example of the present disclosure, the conductor portion has a cross section in a flat shape between the inter-conductor wire members. The cross section is longer in the circumferential direction than the cross section in the radial direction.

This configuration enables to suppress magnetic flux leakage.

According to an example of the present disclosure, the conductor portion is formed by bundling a wire.

The embodiments will be described below with reference to the drawings. Parts of the embodiments functionally and/or structurally corresponding to each other and/or associated with each other will be denoted by the same reference numbers or by reference numbers which are different in the hundreds place from each other. The corresponding and/or associated parts may refer to the explanation in the other embodiments.

The rotary electric machine according to the embodiments is configured to be used, for example, as a power source for vehicles. The rotary electric machine may, however, be used widely for industrial, automotive, aerial, domestic, office automation, or game applications. In the following embodiments, the same or equivalent parts will be denoted by the same reference numbers in the drawings, and explanation thereof in detail will be omitted.

### First Embodiment

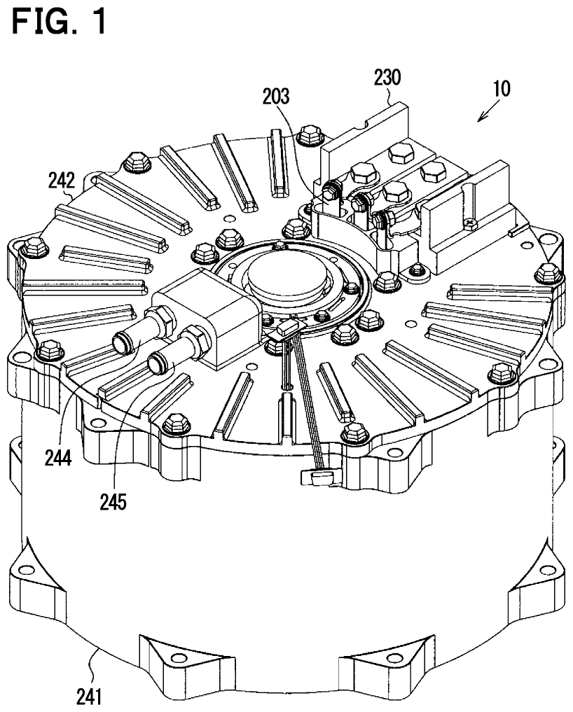

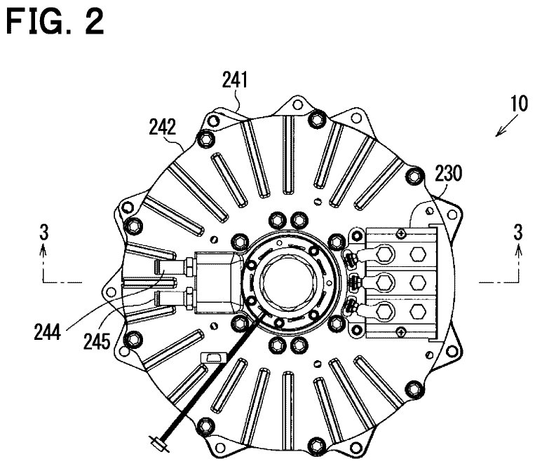

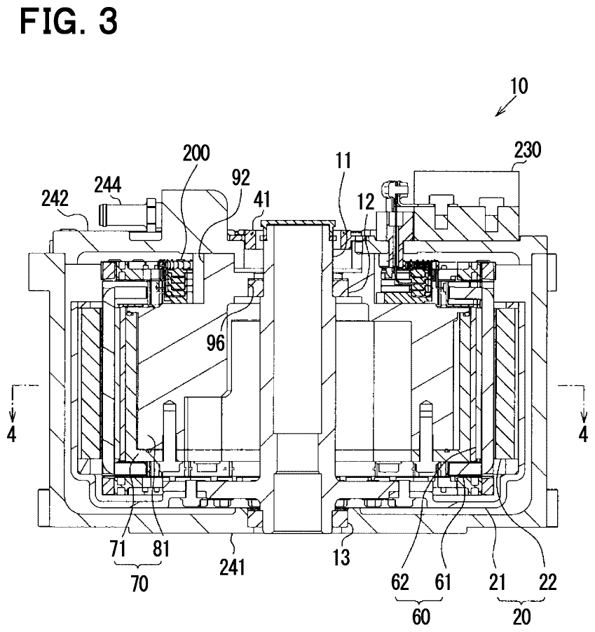

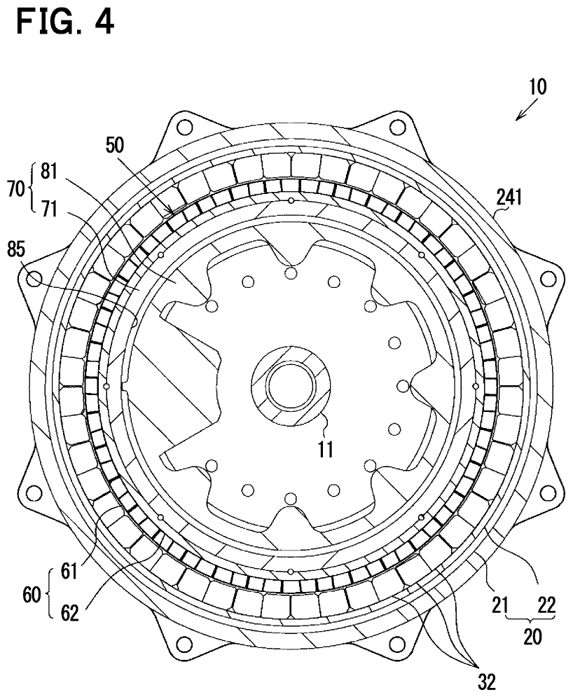

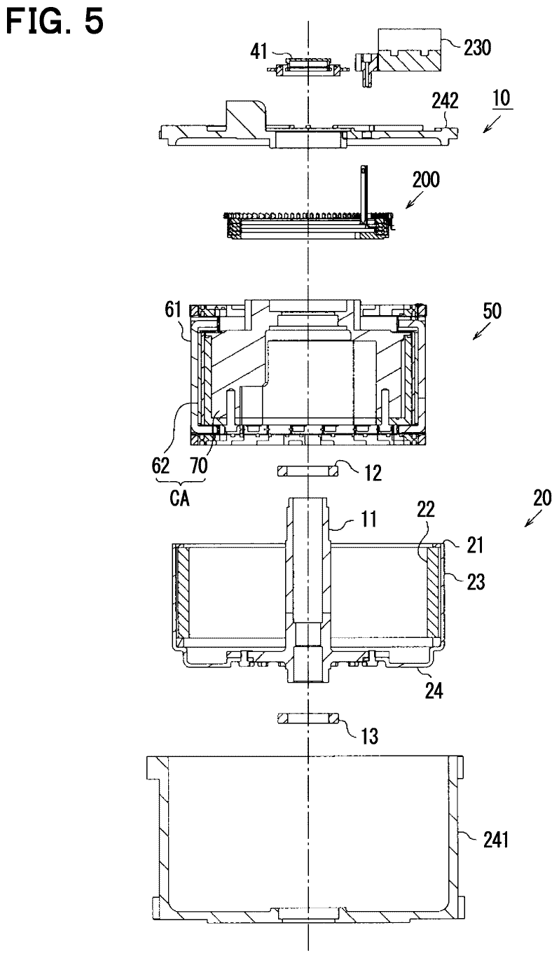

A rotary electric machine 10 according to the present embodiment is a synchronous multi-phase alternating current (AC) motor and has an outer rotor structure (outer rotating structure). A schema of the rotary electric machine 10 is illustrated in FIGS. 1 to 5. FIG. 1 is a perspective view illustrating the entire rotary electric machine 10. FIG. 2 is a plan view of the rotary electric machine 10. FIG. 3 is a longitudinal sectional view of the rotary electric machine 10 (a sectional view taken along line 3-3 in FIG. 2). FIG. 4 is a transverse sectional view of the rotary electric machine 10 (a sectional view taken along line 4-4 in FIG. 3). FIG. 5 is an exploded sectional view illustrating components of the rotary electric machine 10 in an exploded manner. In the following description, in the rotary electric machine 10, a direction in which a rotary shaft 11 extends is defined as an axial direction, a direction radially extending from a center of the rotary shaft 11 is defined as a radial direction, and a direction circumferentially extending around the rotary shaft 11 is defined as a circumferential direction.

In a broad classification, the rotary electric machine 10 includes: a rotary electric machine body including a rotor 20, a stator unit 50, and a bus bar module 200; and a housing 241 and a housing cover 242 both of which are provided so as to surround the rotary electric machine body. Each of these members is disposed coaxially with the rotary shaft 11 integrally provided in the rotor 20, and is assembled in the axial direction in a predetermined order to form the rotary electric machine 10. The rotary shaft 11 is supported by a pair of bearings 12 and 13 provided in the stator unit 50 and the housing 241, respectively, and is rotatable in this state. The bearings 12 and 13 are, for example, radial ball bearings having an inner race, an outer race, and a plurality of balls disposed therebetween. The rotation of the rotary shaft 11 causes, for example, the axle of a vehicle to rotate. The rotary electric machine 10 can be mounted on a vehicle by fixing the housing 241 to a vehicle body frame or the like.

In the rotary electric machine 10, the stator unit 50 is provided so as to surround the rotary shaft 11, and the rotor 20 is disposed on the outer side of the stator unit 50 in the radial direction. The stator unit 50 includes a stator 60 and a stator holder 70 assembled to the inner side of the stator 60 in the radial direction. The rotor 20 and the stator 60 are disposed to face each other in the radial direction with an air gap interposed therebetween. The rotor 20 rotates integrally with the rotary shaft 11, so that the rotor 20 rotates on the outer side of the stator 60 in the radial direction. The rotor 20 corresponds to a “field element”, and the stator 60 corresponds to an “armature”.

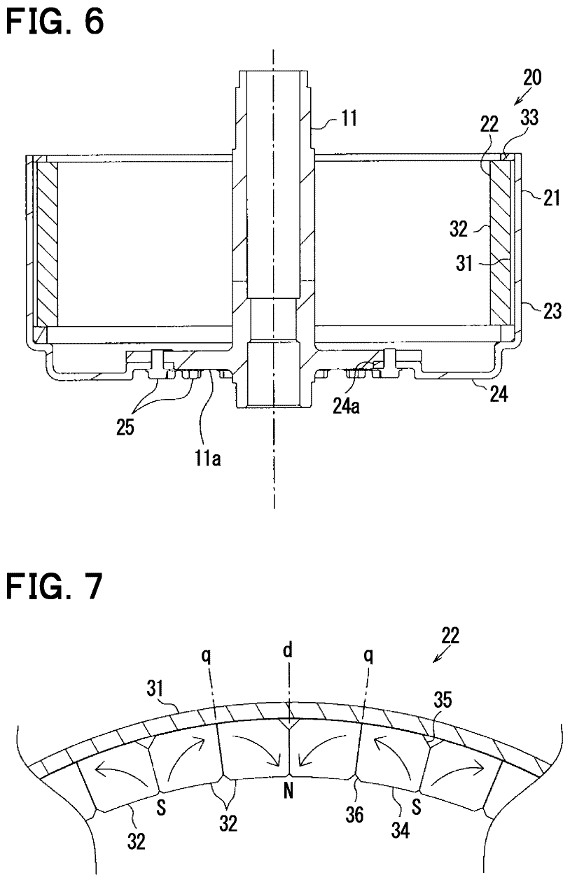

FIG. 6 is a longitudinal sectional view of the rotor 20. As illustrated in FIG. 6, the rotor 20 includes a substantially cylindrical rotor carrier 21 and an annular magnet unit 22 fixed to the rotor carrier 21. The rotor carrier 21 includes a cylinder 23 having a cylindrical shape and an end plate portion 24 provided at one end of the cylinder 23 in the axial direction. The cylinder 23 and the end plate portion 24 are integrated to form the rotor carrier 21. The rotor carrier 21 functions as a magnet retainer, and the magnet unit 22 is fixed to the inner side of the cylinder 23 in the radial direction in an annular shape. A through-hole 24a is formed in the end plate portion 24. The rotary shaft 11 is fixed to the end plate portion 24 by using a fastener 25 such as a bolt while the rotary shaft 11 is inserted through the through-hole 24a. The rotary shaft 11 has a flange 11a extending in a direction intersecting (orthogonal to) the axial direction. The rotor carrier 21 is fixed to the rotary shaft 11 while the flange 11a and the end plate portion 24 are surface-joined.

The magnet unit 22 includes a cylindrical magnet holder 31, a plurality of magnets 32 fixed to an inner peripheral surface of the magnet holder 31, and an end plate 33 fixed to an opposite side of the end plate portion 24 of the rotor carrier 21 among both sides in the axial direction. The magnet holder 31 has the same length dimension as the magnet 32 in the axial direction. The magnet 32 is provided in a state of being surrounded by the magnet holder 31 from the outer side in the radial direction. The magnet holder 31 and the magnet 32 are fixed while being in contact with the end plate 33 at the end on one side in the axial direction. The magnet unit 22 corresponds to a “magnet unit”.

FIG. 7 is a partial transverse sectional view illustrating a sectional structure of the magnet unit 22. In FIG. 7, the direction of the easy axis of magnetization of the magnet 32 is indicated by an arrow.

In the magnet unit 22, the magnets 32 are provided side by side such that the polarities are alternately changed along the circumferential direction of the rotor 20. Thus, the magnet unit 22 has a plurality of magnetic poles in the circumferential direction. The magnet 32 is a polar anisotropic permanent magnet, and is formed using a sintered neodymium magnet having an intrinsic coercive force of 400 [kA/m] or more and a remanent flux density Br of 1.0 [T] or more.

A peripheral surface of the magnet 32 on the inner side in the radial direction (stator 60 side) is a magnetic flux acting surface 34 on which a magnetic flux is transmitted and received. The magnet unit 22 intensively generates a magnetic flux in a region on or near the d-axis serving as the center of the magnetic pole on the magnetic flux acting surface 34 of the magnet 32. Specifically, in the magnet 32, the directions of the easy axis of magnetization differ between the d-axis side (portion closer to the d-axis) and the q-axis side (portion closer to the q-axis). The direction of the easy axis of magnetization on the d-axis side is parallel to the d-axis, whereas the direction of the easy axis of magnetization on the q-axis side is orthogonal to the q-axis. In this case, an arc-shaped magnetic path is formed along the direction of the easy axis of magnetization. In short, the magnet 32 is oriented such that the direction of the easy axis of magnetization is parallel to the d-axis serving as the center of the magnetic pole on a side of the d-axis as compared with that on a side of the q-axis serving as the boundary of the magnetic pole.

In the magnet 32, since the magnetic path is formed in an arc shape, the length of the magnetic path is greater than the thickness dimension of the magnet 32 in the radial direction. With this configuration, the permeance of the magnet 32 increases, and the magnet 32 can exhibit an ability equivalent or corresponding to a magnet having a large volume of magnets, without changing the volume of magnets.

Two magnets 32 adjacent to each other in the circumferential direction as one set constitutes one magnetic pole. That is, the plurality of magnets 32 arranged in the circumferential direction in the magnet unit 22 has division surfaces on the d-axis and the q-axis. The magnets 32 are disposed while being in contact with or close to each other. The magnet 32 has an arc-shaped magnetic path as described above. On the q-axis, the N-pole and the S-pole face each other in the magnets 32 adjacent to each other in the circumferential direction. Therefore, the permeance on or near the q-axis can be improved. In addition, since the magnets 32 on both sides across the q-axis attract each other, the magnets 32 can maintain a state where the magnets 32 are in contact with each other. Therefore, this also contributes to improvement of permeance.

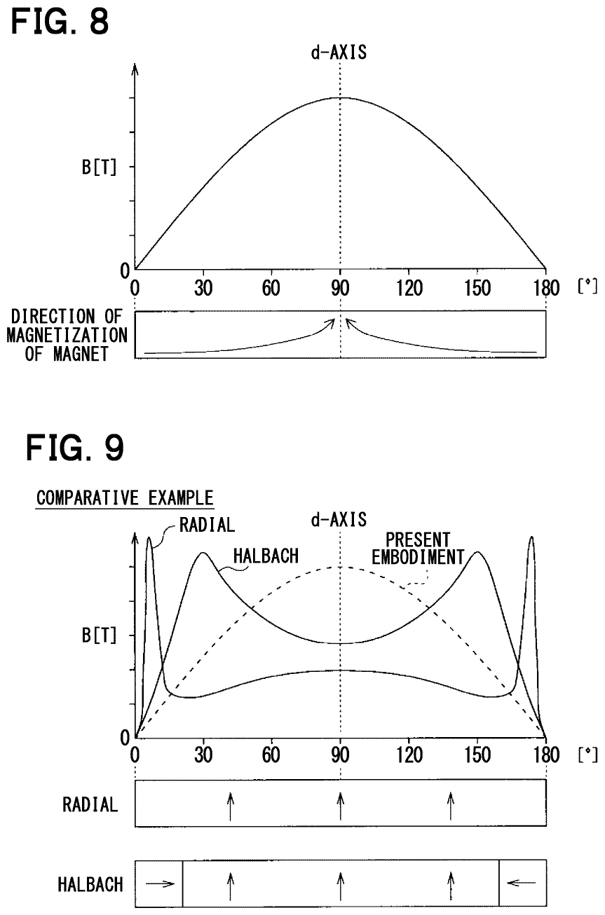

In the magnet unit 22, since a magnetic flux flows in an arc shape between the adjacent N-pole and S-pole by each magnet 32, the magnetic path thereof is longer than, for example, that of the radial anisotropic magnet. Therefore, as illustrated in FIG. 8, the shape of the magnetic flux density distribution is close to a sine wave. As a result, unlike the magnetic flux density distribution of the radial anisotropic magnet illustrated in FIG. 9 as a comparative example, the magnetic flux can be concentrated on the center side of the magnetic pole, and the torque of the rotary electric machine 10 can be increased. Further, in the magnet unit 22 according to the present embodiment, the fact that there is a difference in the magnetic flux density distribution as compared with the conventional Halbach array magnet can be confirmed. In FIGS. 8 and 9, the horizontal axis represents the electrical angle, and the vertical axis represents the magnetic flux density. In FIGS. 8 and 9, 90° on the horizontal axis represents the d-axis (i.e., the center of the magnetic pole), and 0° and 180° on the horizontal axis each represent the q-axis.

That is, according to each magnet 32 having the above-described configuration, the magnetic flux on the d-axis is strengthened in the magnet unit 22, and the change in the magnetic flux on or near the q-axis is suppressed. Accordingly, implementation of the magnet unit 22 can be suitably performed in which the surface magnetic flux change from the q-axis to the d-axis is gentle in each magnetic pole.

The sine wave matching percentage of the magnetic flux density distribution is only required to be a certain value, for example, a value of 40% or more. This value setting can reliably improve the amount of magnetic flux in the central portion of the waveform, as compared with the case of using a radially oriented magnet or a parallel oriented magnet having a sine wave matching percentage of about 30%. Alternatively, when the sine wave matching percentage is set to 60% or more, the amount of magnetic flux in the central portion of the waveform can be reliably improved, as compared with a concentrated magnetic flux array such as a Halbach array.

In the radial anisotropic magnet illustrated in FIG. 9, the magnetic flux density changes steeply on or near the q-axis. As the change in the magnetic flux density is steeper, the eddy current undesirably increases in a stator winding 61 of the stator 60 to be described later. The magnetic flux change on the stator winding 61 side is also steep. On the other hand, in the present embodiment, the magnetic flux density distribution has a magnetic flux waveform close to a sine wave. Therefore, on or near the q-axis, the change in the magnetic flux density is smaller than the change in the magnetic flux density of the radial anisotropic magnet. This feature makes it possible to prevent the generation of eddy currents.

In the magnet 32, a recess 35 is formed in a predetermined range including the d-axis on the outer peripheral surface on the outer side in the radial direction, and a recess 36 is formed in a predetermined range including the q-axis on the inner peripheral surface on the inner side in the radial direction. In this case, according to the direction of the easy axis of magnetization of the magnet 32, the magnetic path is shortened on or near the d-axis on the outer peripheral surface of the magnet 32, and the magnetic path is shortened on or near the q-axis on the inner peripheral surface of the magnet 32. Therefore, considering the difficulty in causing the magnet 32 to generate a sufficient magnetic flux at a place where the length of the magnetic path is small, the magnet is removed at a place where the magnetic flux is weak.

The magnet unit 22 may use the magnets 32 whose number is identical to the number of the magnetic poles. For example, the magnet 32 is preferably provided such that one magnet is disposed between the d-axes, which serve as the centers of two magnetic poles adjacent to each other in the circumferential direction. In this case, the magnet 32 has a center in the circumferential direction on the q-axis and has a division surface on the d-axis. Alternatively, the magnet 32 may have a center in the circumferential direction on the d-axis instead of the q-axis. As the magnet 32, instead of using magnets whose number is twice the number of magnetic poles or magnets whose number is identical to the number of magnetic poles, an annular magnet connected in an annular shape may be used.

As illustrated in FIG. 3, a resolver 41 as a rotation sensor is provided at an end (upper end in the drawing) on the opposite side of the joint portion with the rotor carrier 21 among both sides in the axial direction of the rotary shaft 11. The resolver 41 includes a resolver rotor fixed to the rotary shaft 11 and a resolver stator disposed to face the outer side of the resolver rotor in the radial direction. The resolver rotor has a disk ring shape. The resolver rotor is provided coaxially with the rotary shaft 11 while the rotary shaft 11 is inserted therethrough. The resolver stator includes a stator core and a stator coil, and is fixed to the housing cover 242.

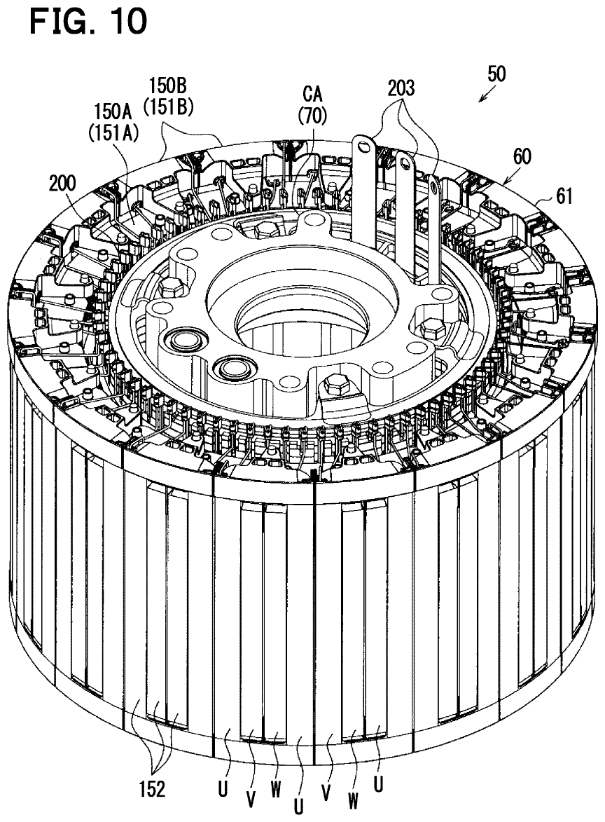

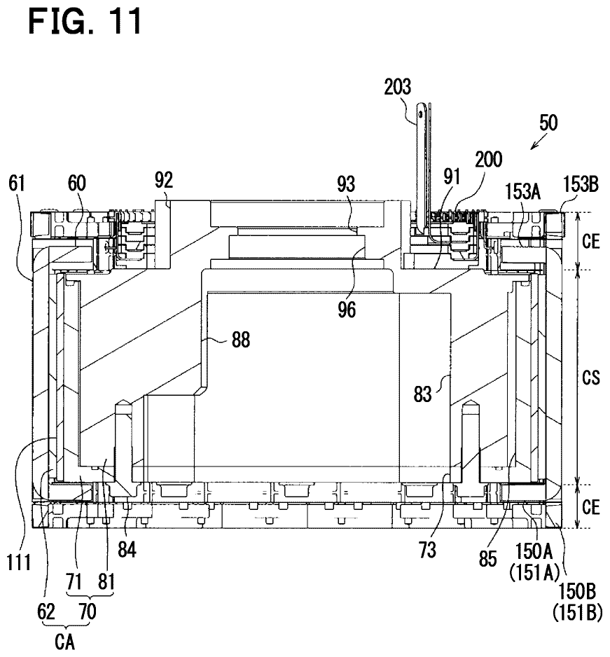

Next, a configuration of the stator unit 50 will be described. FIG. 10 is a perspective view of the stator unit 50, and FIG. 11 is a longitudinal sectional view of the stator unit 50. FIG. 11 is a longitudinal sectional view at the same position as FIG. 3.

The stator unit 50 includes the stator 60 and the stator holder 70 on the inner side of the stator 60 in the radial direction. The stator 60 includes the stator winding 61 and a stator core 62. The stator core 62 and the stator holder 70 are integrally provided as a core assembly CA, and a plurality of winding segments 151 constituting the stator winding 61 are assembled to the core assembly CA. The stator winding 61 corresponds to an “armature winding”, the stator core 62 corresponds to an “armature core”, and the stator holder 70 corresponds to an “armature retainer”. The core assembly CA corresponds to a “support member”.

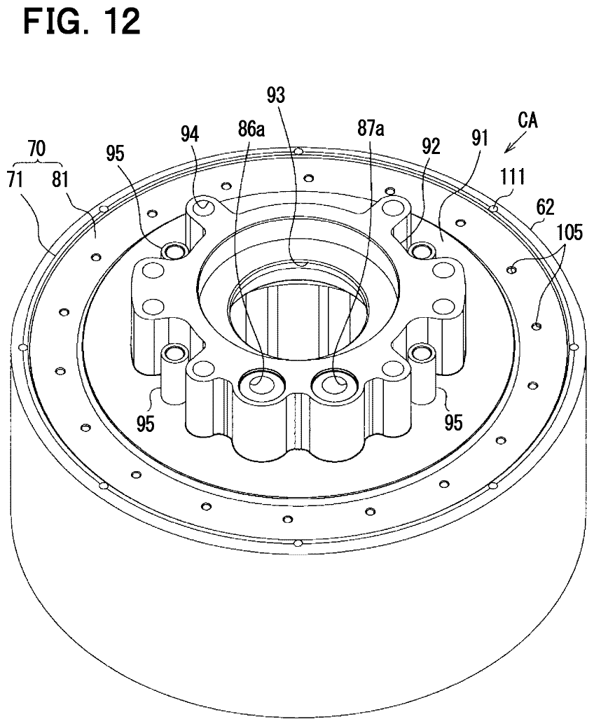

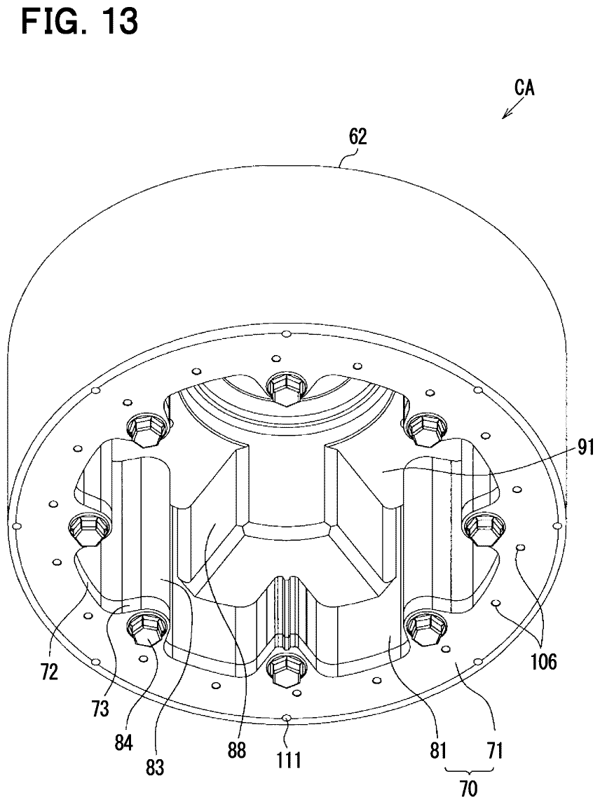

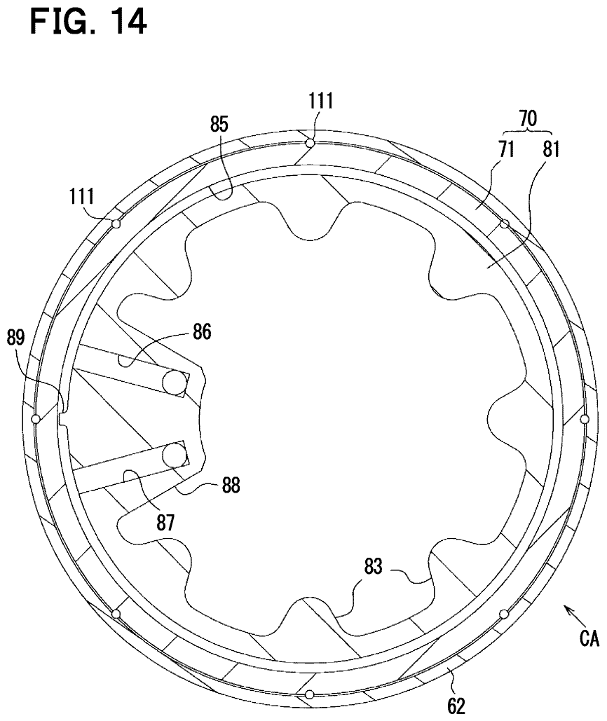

First, the core assembly CA will now be described. FIG. 12 is a perspective view of the core assembly CA as viewed from one side in the axial direction. FIG. 13 is a perspective view of the core assembly CA as viewed from the other side in the axial direction. FIG. 14 is a transverse sectional view of the core assembly CA. FIG. 15 is an exploded sectional view of the core assembly CA.

As described above, the core assembly CA includes the stator core 62 and the stator holder 70 assembled on the inner side of the stator core 62 in the radial direction. In other words, the stator core 62 is integrally assembled to the outer peripheral surface of the stator holder 70.

The stator core 62 is formed as a core sheet stacked body in which core sheets 62a including a magnetic steel sheet, which is a magnetic member, are stacked in the axial direction. The stator core 62 has a cylindrical shape having a predetermined thickness in the radial direction. The stator winding 61 is assembled to the outer side of the stator core 62 in the radial direction, that is, the rotor 20 side. The outer peripheral surface of the stator core 62 has a curved surface shape without protrusions and recesses. The stator core 62 functions as a back yoke. The stator core 62 is formed by stacking a plurality of the core sheets 62a in the axial direction. The core sheet 62a is punched into, for example, an annular plate shape. However, a stator core having a helical core structure may be used as the stator core 62. In the stator core 62 having a helical core structure, a strip-shaped core sheet is used. This core sheet is wound in an annular shape and is stacked in the axial direction to form the stator core 62 having a cylindrical shape as a whole.

In the present embodiment, the stator 60 has a slot-less structure having no tooth for forming a slot, but the configuration thereof may use any of the following (A) to (C).

(A) The stator 60 includes a conductor-to-conductor member between each adjacent two of the conductor portions (intermediate conductor portions 152 to be described later) in the circumferential direction. As the conductor-to-conductor member, a magnetic material having a relationship of Wt×Bs≤Wm×Br is used, where Wt represents a width dimension in the circumferential direction of the conductor-to-conductor member in one magnetic pole, Bs represents a saturation magnetic flux density of the conductor-to-conductor member, Wm represents a width dimension in the circumferential direction of the magnet 32 in one magnetic pole, and Br represents a remanent flux density of the magnet 32.

(B) The stator 60 includes a conductor-to-conductor member between each adjacent two of the conductor portions (intermediate conductor portions 152) in the circumferential direction. A non-magnetic material is used as the conductor-to-conductor member.

(C) The stator 60 does not include a conductor-to-conductor member between each adjacent two of the conductor portions (intermediate conductor portions 152) in the circumferential direction.

As illustrated in FIG. 15, the stator holder 70 includes an outer cylinder member 71 and an inner cylinder member 81. The outer cylinder member 71 is disposed on the outer side in the radial direction and the inner cylinder member 81 is disposed on the inner side in the radial direction, and they are integrally assembled to form the stator holder 70. Each of these members 71 and 81 includes, for example, metal such as aluminum or cast iron, or carbon fiber reinforced plastic (CFRP).

The outer cylinder member 71 is a cylindrical member having the outer peripheral surface and the inner peripheral surface, both of which are formed into an exact circular curved surface. An annular flange 72 extending inward in the radial direction is formed on one end side in the axial direction. The flange 72 includes a plurality of protrusions 73 extending inward in the radial direction at predetermined intervals in the circumferential direction (see FIG. 13). The outer cylinder member 71 includes facing surfaces 74 and 75 each facing the inner cylinder member 81 in the axial direction on one end side and the other end side in the axial direction, respectively. Annular grooves 74a and 75a that extend annularly are formed on the facing surfaces 74 and 75.

The inner cylinder member 81 is a cylindrical member having an outer diameter dimension smaller than an inner diameter dimension of the outer cylinder member 71. An outer peripheral surface of the inner cylinder member 81 is an exact circular curved surface concentric with the outer cylinder member 71. The inner cylinder member 81 includes an annular flange 82 extending outward in the radial direction on one end side in the axial direction. The inner cylinder member 81 is to be assembled to the outer cylinder member 71 while being in contact with the facing surfaces 74 and 75 of the outer cylinder member 71 in the axial direction. As illustrated in FIG. 13, the outer cylinder member 71 and the inner cylinder member 81 are assembled to each other by using a fastener 84 such as a bolt. Specifically, a plurality of protrusions 83 extending inward in the radial direction is formed on the inner peripheral side of the inner cylinder member 81 at predetermined intervals in the circumferential direction. The protrusions 73 and 83 are fastened to each other by using the fastener 84 while the end surface of the protrusion 83 in the axial direction and the protrusion 73 of the outer cylinder member 71 are stacked.

As illustrated in FIG. 14, the outer cylinder member 71 and the inner cylinder member 81 are assembled to each other. In this state, an annular gap is formed between the inner peripheral surface of the outer cylinder member 71 and the outer peripheral surface of the inner cylinder member 81. This gap space serves as a coolant path 85 through which a coolant such as cooling water flows. The coolant path 85 is provided in an annular shape in the circumferential direction of the stator holder 70. More specifically, the inner cylinder member 81 includes a path formation wall 88. The path formation wall 88 protrudes inward in the radial direction on the inner peripheral side of the inner cylinder member 81. In the path formation wall 88, an inlet path 86 and an outlet path 87 are formed, and each of the paths 86 and 87 is open to the outer peripheral surface of the inner cylinder member 81. The inner cylinder member 81 includes, on the outer peripheral surface thereof, a partition 89 for partitioning the coolant path 85 into an inlet side and an outlet side. This configuration allows a coolant flowing in from the inlet path 86 to flow through the coolant path 85 in the circumferential direction, and then flow out from the outlet path 87.

The inlet path 86 and the outlet path 87 each include a one end extending in the radial direction to be open to the outer peripheral surface of the inner cylinder member 81, and each include the other end extending in the axial direction to be open to the end surface of the inner cylinder member 81 in the axial direction. FIG. 12 illustrates an inlet opening 86a communicating with the inlet path 86 and an outlet opening 87a communicating with the outlet path 87. The inlet path 86 and the outlet path 87 respectively communicate with an inlet port 244 and an outlet port 245 (see FIG. 1) attached to the housing cover 242. The coolant enters and exits through the ports 244 and 245, respectively.

A sealing members 101 and 102 for preventing leakage of the coolant in the coolant path 85 is provided at a joint portion between the outer cylinder member 71 and the inner cylinder member 81 (see FIG. 15). Specifically, the sealing members 101 and 102 are, for example, O-rings. The sealing members 101 and 102 are provided in a manner that the annular grooves 74a and 75a of the outer cylinder member 71 respectively receive the sealing members 101 and 102, and the outer cylinder member 71 and the inner cylinder member 81 respectively compress the sealing members 101 and 102.

As illustrated in FIG. 12, the inner cylinder member 81 has an end plate portion 91 on one end side in the axial direction. The end plate portion 91 includes a boss 92 having a hollow cylindrical shape extending in the axial direction. The Boss 92 is provided so as to surround an insertion hole 93 through which the rotary shaft 11 is inserted. The boss 92 includes a plurality of fastener 94 for fixing the housing cover 242. The end plate portion 91 includes a plurality of rods 95 extending in the axial direction on the outer side of the boss 92 in the radial direction. The rod 95 is a portion serving as a fixing portion for fixing the bus bar module 200, and details thereof will be described later. The boss 92 serves as a bearing retainer that retains the bearing 12. The bearing 12 is fixed to a bearing fixing portion 96 provided on the inner peripheral portion of the boss 92 (see FIG. 3).

As illustrated in FIGS. 12 and 13, the outer cylinder member 71 and the inner cylinder member 81 are respectively formed with recesses 105 and 106, both of which are used for fixing a plurality of coil modules 150 to be described later.

Specifically, as illustrated in FIG. 12, a plurality of the recesses 105 are formed at equal intervals in the circumferential direction on the end surface of the inner cylinder member 81 in the axial direction, more specifically, the outer end surface of the end plate portion 91 in the axial direction around the boss 92. As illustrated in FIG. 13, a plurality of the recesses 106 are formed at equal intervals in the circumferential direction on the end surface of the outer cylinder member 71 in the axial direction, more specifically, on the outer end surface of the flange 72 in the axial direction. These recesses 105 and 106 are each provided so as to be arranged on an imaginary circle concentric with the core assembly CA. The recesses 105 and 106 are provided at the same position in the circumferential direction, and the intervals and the number thereof are the same.

The stator core 62 is assembled while generating a compression force in the radial direction with respect to the stator holder 70 in order to secure the strength of assembly with respect to the stator holder 70. Specifically, the stator core 62 is fitted and fixed to the stator holder 70 with a predetermined interference by shrink-fitting or press-fitting. In this case, the stator core 62 and the stator holder 70 can be said to be assembled while stress in the radial direction from one of them to the other is generated. In the case of increasing the torque of the rotary electric machine 10, for example, increase of the diameter of the stator 60 is conceivable. In such a case, the tightening force of the stator core 62 is increased in order to strengthen the joining of the stator core 62 to the stator holder 70. However, if the compressive stress (in other words, residual stress) of the stator core 62 is increased, there is a concern that the stator core 62 may be damaged.

To avoid the above problem, in the present embodiment, in the configuration in which the stator core 62 and the stator holder 70 are fitted and fixed to each other with predetermined interference, a regulation portion is provided at portions where the stator core 62 and the stator holder 70 face each other in the radial direction. The regulation portion regulates displacement of the stator core 62 in the circumferential direction by engagement in the circumferential direction. That is, as illustrated in FIGS. 12 to 14, a plurality of engagement members 111 as regulation portions are provided at predetermined intervals in the circumferential direction between the stator core 62 and the outer cylinder member 71 of the stator holder 70 in the radial direction. The engagement members 111 suppress positional shift between the stator core 62 and the stator holder 70 in the circumferential direction. In this case, a recess is preferably provided in at least one of the stator core 62 and the outer cylinder member 71, and the engagement member 111 may be engaged in the recess. Instead of the engagement member 111, a protrusion may be provided on one of the stator core 62 and the outer cylinder member 71.

In the above-described configuration, the stator core 62 and the stator holder 70 (outer cylinder member 71) are provided while mutual displacement in the circumferential direction is regulated by the engagement member 111 in addition to being fitted and fixed with predetermined interference. Therefore, even if the interference in the stator core 62 and the stator holder 70 is relatively small, the stator core 62 can be prevented from being displaced in the circumferential direction. Since a desired displacement prevention effect can be obtained even if the interference is relatively small, the stator core 62 can be prevented from being damaged due to an excessively large interference. As a result, the displacement of the stator core 62 can be appropriately prevented.

An annular internal space may be formed on the inner peripheral side of the inner cylinder member 81 so as to surround the rotary shaft 11. For example, an electrical component constituting an inverter as a power converter may be disposed in the internal space. The electrical component is, for example, an electrical module making a semiconductor switching element and a capacitor into a package. The electrical module is disposed in contact with the inner peripheral surface of the inner cylinder member 81, so that the electrical module can be cooled by the coolant flowing through the coolant path 85. On the inner peripheral side of the inner cylinder member 81, the plurality of protrusions 83 may be eliminated or the protruding height of the protrusions 83 may be reduced. This change can expand the internal space on the inner peripheral side of the inner cylinder member 81.

Next, the configuration of the stator winding 61 assembled to the core assembly CA will be described in detail. As illustrated in FIGS. 10 and 11, the stator winding 61 is assembled to the core assembly CA. The plurality of winding segments 151 constituting the stator winding 61 are assembled to the outer side of the core assembly CA in the radial direction, that is, to the outer side of the stator core 62 in the radial direction, to be arranged in the circumferential direction.

The stator winding 61 has a plurality of phase windings. The phase windings of respective phases are disposed in a predetermined order in the circumferential direction to be formed in a cylindrical shape (annular shape). In the present embodiment, the stator winding 61 has a three-phase windings including the U-phase, the V-phase, and the W-phase windings.

As illustrated in FIG. 11, the stator 60 includes, in the axial direction, a portion corresponding to a coil side CS facing the magnet unit 22 in the rotor 20 in the radial direction, and a portion corresponding to a coil end CE that is the outer side of the coil side CS in the axial direction. In this case, the stator core 62 is provided in a range corresponding to the coil side CS in the axial direction.

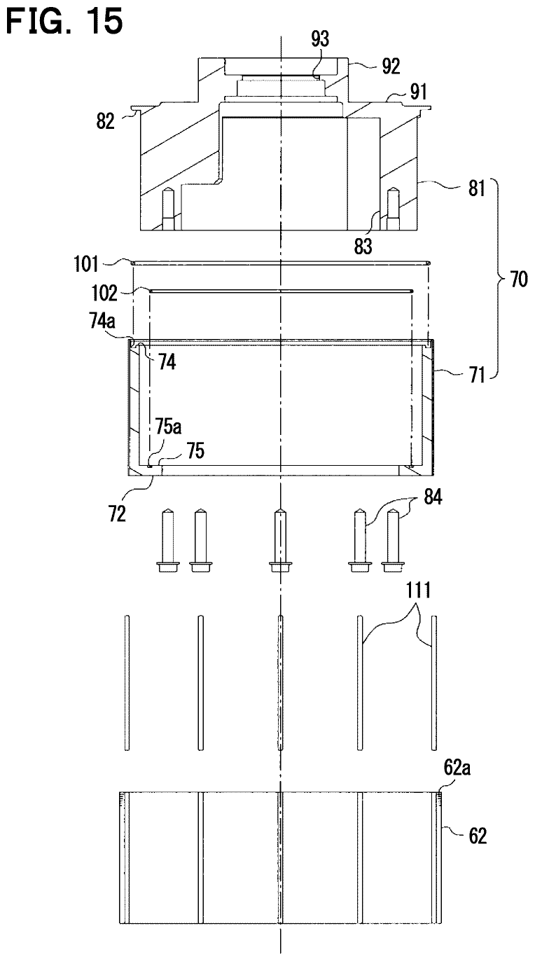

In the stator winding 61, the phase winding of each phase has the plurality of winding segments 151 (see FIG. 16), and the winding segments 151 are individually provided as the coil module 150. That is, the winding segments 151 in the phase windings of each phase are integrally provided to form the coil module 150. The coil modules 150 whose number is predetermined and corresponds to the number of poles constitute the stator winding 61. The coil modules 150 (winding segments 151) of the respective phases are disposed side by side in a predetermined order in the circumferential direction. The conductor portion of the respective phases are thus disposed side by side in a predetermined order at the coil side CS of the stator winding 61. FIG. 10 illustrates an arrangement order of the U-phase, V-phase, and W-phase conductor portions at the coil side CS. In the present embodiment, the number of magnetic poles is set to 24, but the number thereof can be freely set.

In the stator winding 61, the winding segments 151 of the coil modules 150 are connected in parallel or in series for respective phases, thereby forming phase windings of respective phases. FIG. 16 is a circuit diagram illustrating a connection state of the winding segment 151 in each three-phase winding. FIG. 16 illustrates the winding segments 151 in the phase windings of respective phases in a state of being connected in parallel.

As illustrated in FIG. 11, the coil module 150 is assembled on the outer side of the stator core 62 in the radial direction. In this case, the coil module 150 is assembled while both end portions thereof in the axial direction protrude outward in the axial direction from the stator core 62 (that is, the coil end CE side). In other words, the stator winding 61 has a portion corresponding to the coil end CE protruding outward in the axial direction from the stator core 62, and a portion corresponding to the coil side CS on the inner side of the coil end CE in the axial direction.

The coil module 150 has two types of shapes. One is a shape in which the winding segment 151 is bent inward in the radial direction, that is, bent toward the stator core 62 at the coil end CE. The other is a shape in which the winding segment 151 is not bent inward in the radial direction and extends linearly in the axial direction at the coil end CE. In the following description, for convenience, the winding segment 151 having a bent shape on both end sides in the axial direction is also referred to as a “first winding segment 151A”, and the coil module 150 having the first winding segment 151A is also referred to as a “first coil module 150A”. On the other hand, the winding segment 151 not having a bent shape on both end sides in the axial direction is also referred to as a “second winding segment 151B”, and the coil module 150 having the second winding segment 151B is also referred to as a “second coil module 150B”.

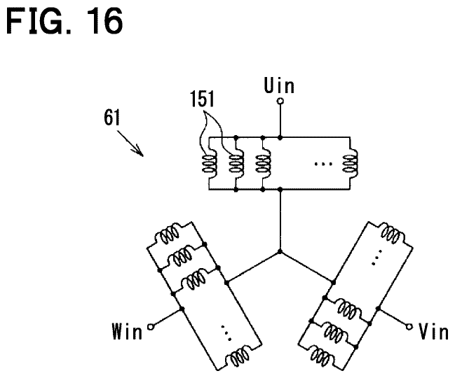

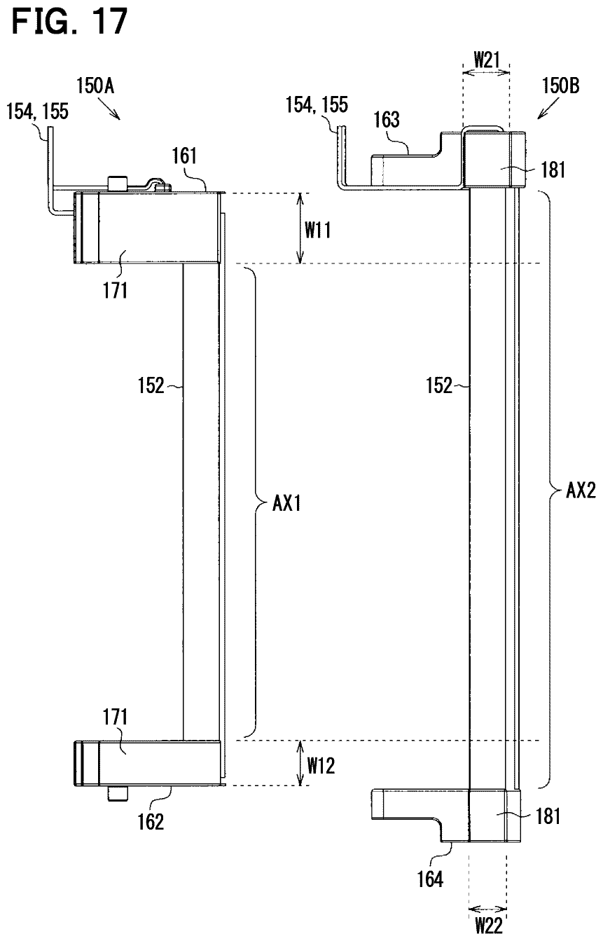

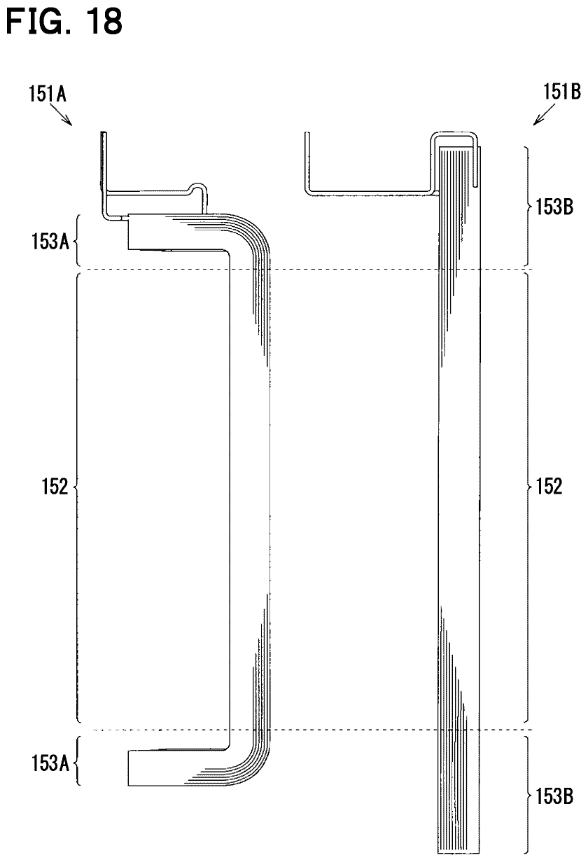

FIG. 17 is a side view illustrating the first coil module 150A and the second coil module 150B arranged side by side for comparison. FIG. 18 is a side view illustrating the first winding segment 151A and the second winding segment 151B arranged side by side for comparison. As illustrated in these drawings, the coil modules 150A and 150B and the winding segments 151A and 151B have different lengths in the axial direction and different end shapes on both sides in the axial direction. The first winding segment 151A has a substantially C shape in a side view, and the second winding segment 151B has a substantially I shape in a side view. The first winding segment 151A is mounted with insulating covers 161 and 162 as “first insulating covers” on both sides in the axial direction, and the second winding segment 151B is mounted with insulating covers 163 and 164 as “second insulating covers” on both sides in the axial direction.

Next, the configurations of the coil modules 150A and 150B will be described in detail.

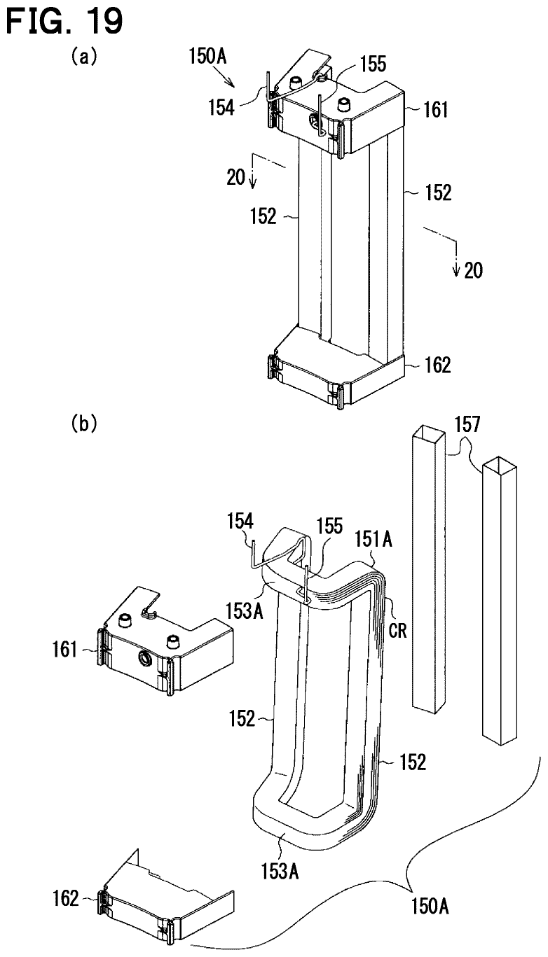

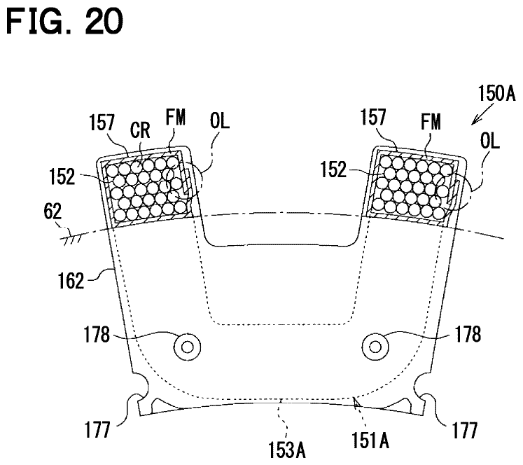

Of the coil modules 150A and 150B, first, the first coil module 150A will now be described. FIG. 19(a) is a perspective view illustrating a configuration of the first coil module 150A. In FIG. 19, (b) is an exploded perspective view illustrating components of the first coil module 150A. FIG. 20 is a sectional view taken along line 20-20 in (a) in FIG. 19.

As illustrated in (a) and (b) in FIG. 19, the first coil module 150A includes the first winding segment 151A and the insulating covers 161 and 162. The first winding segment 151A is formed by multiply winding a conductive wire member CR. The insulating covers 161 and 162 are respectively attached to one end side and the other end side of the first winding segment 151A in the axial direction. The insulating covers 161 and 162 are each formed of an insulating material such as synthetic resin.

The first winding segment 151A includes a pair of intermediate conductor portions 152 and a pair of link portions 153A. The pair of intermediate conductor portions 152 are provided to be in parallel to each other and have a linear shape. The pair of link portions 153A respectively connect the pair of intermediate conductor portions 152 at both ends in the axial direction. The first winding segment 151A is formed in an annular shape by the pair of intermediate conductor portions 152 and the pair of link portions 153A. The pair of intermediate conductor portions 152 are separated at a predetermined coil pitch. The intermediate conductor portions 152 of the winding segments 151 of the other phases can be disposed between the pair of intermediate conductor portions 152 in the circumferential direction. In the present embodiment, the pair of intermediate conductor portions 152 are separated at two coil pitches. One intermediate conductor portion 152 for each of the winding segments 151 of the other two phases is disposed between the pair of intermediate conductor portions 152.

The pair of link portions 153A have the shape identical to each other on both sides in the axial direction, and are provided as portions corresponding to the coil ends CE (see FIG. 11). Each of the link portions 153A is provided so as to be bent in a direction orthogonal to the intermediate conductor portion 152, that is, in a direction orthogonal to the axial direction.

As illustrated in FIG. 18, the first winding segment 151A has the link portion 153A on both sides in the axial direction, and the second winding segment 151B has a link portion 153B on both sides in the axial direction. The link portions 153A and 153B of the respective winding segments 151A and 151B have different shapes. In order to clarify the distinction, the link portion 153A of the first winding segment 151A is also referred to as a “first link portion 153A”, and the link portion 153B of the second winding segment 151B is also referred to as a “second link portion 153B”.

In each of the winding segments 151A and 151B, the intermediate conductor portion 152 is provided as a coil side conductor portion arranged one by one in the circumferential direction at the coil side CS. Each of the link portions 153A and 153B is provided as a coil end conductor portion connecting the intermediate conductor portions 152 of the same phase at two positions different in the circumferential direction at the coil end CE.

As illustrated in FIG. 20, the first winding segment 151A is formed by multiply winding the conductive wire member CR such that the transverse section of a bunch of conductive wire members is quadrangular. FIG. 20 illustrates a transverse section of the intermediate conductor portion 152. In the intermediate conductor portion 152, the conductive wire member CR is multiply wound so as to be arranged in the circumferential direction and the radial direction. In other words, the conductive wire member CR is arranged in a plurality of rows in the circumferential direction and arranged in a plurality of rows in the radial direction in the intermediate conductor portion 152. With this arrangement, the first winding segment 151A is formed such that the transverse section of a bunch of conductive wire members has a substantially rectangular shape. At the extending end of the first link portion 153A, the conductive wire member CR is multiply wound so as to be arranged in the axial direction and the radial direction by being bent in the radial direction. In the present embodiment, the conductive wire member CR is concentrically wound to form the first winding segment 151A. However, any winding method of the conductive wire member CR may be employed. The conductive wire member CR may be multiply wound in a form of alpha winding instead of concentric winding.

In the first winding segment 151A, an end of the conductive wire member CR is drawn out from one first link portion 153A (the first link portion 153A on the upper side of (b) in FIG. 19) among the first link portions 153A on both sides in the axial direction. These ends serve as winding ends 154 and 155. The winding ends 154 and 155 are portions that respectively start and end winding of the conductive wire member CR. One of the winding ends 154 and 155 is connected to a current (input/output) I/O terminal, and the other is connected to a neutral point.

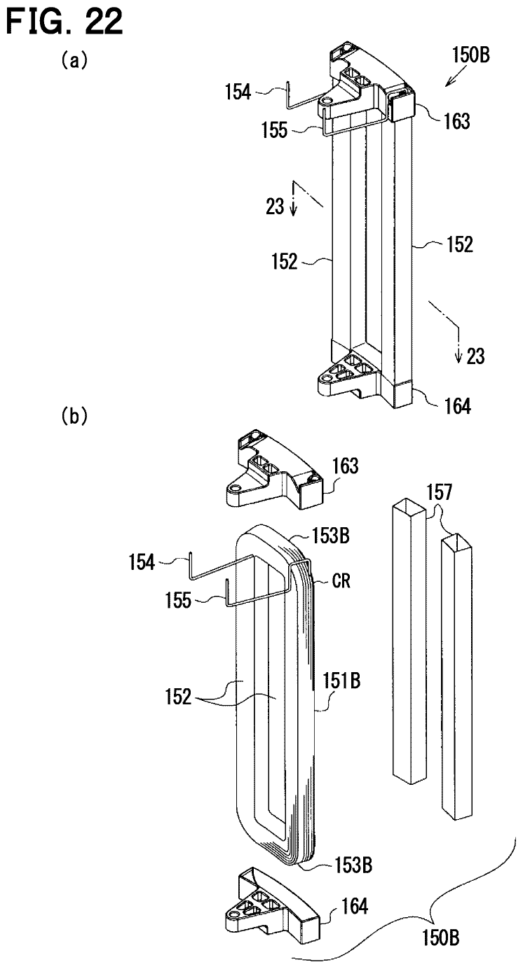

In the first winding segment 151A, each intermediate conductor portion 152 is covered with a sheet-like insulating jacket 157. In FIG. 19, (a) illustrates the first coil module 150A in which the intermediate conductor portion 152 is covered with the insulating jacket 157 and is on the inner side of the insulating jacket 157. However, for convenience, such a portion is referred to as an intermediate conductor portion 152 (the same applies to (a) in FIG. 22 to be described later).

The insulating jacket 157 employs a film member FM having at least a length of a range of the intermediate conductor portion 152 to be covered with and insulated in the axial direction as a dimension in the axial direction. The insulating jacket 157 is provided by winding the film member FM around the intermediate conductor portion 152. The film member FM is made of, for example, a polyethylene naphthalate (PEN) film. More specifically, the film member FM includes a film base material and an adhesion layer provided on one of both surfaces of the film base material and having foamability. The film member FM is wound around the intermediate conductor portion 152 while being adhered by an adhesion layer. A non-foamable adhesive can also be used as the adhesion layer.

As illustrated in FIG. 20, the conductive wire member CR is arranged in the circumferential direction and the radial direction, whereby the intermediate conductor portion 152 has a substantially rectangular transverse section. The film member FM covers around the intermediate conductor portion 152 with the ends of the film member FM in the circumferential direction overlapping each other, whereby the insulating jacket 157 is provided. The film member FM is a rectangular sheet whose longitudinal dimension is greater than the length of the intermediate conductor portion 152 in the axial direction and whose lateral dimension is greater than a single wrap-around length of the intermediate conductor portion 152. The film member FM is wound around the intermediate conductor portion 152 while being creased to fit to a sectional shape of the intermediate conductor portion 152. When the film member FM is wound around the intermediate conductor portion 152, a gap between the conductive wire member CR of the intermediate conductor portion 152 and the film base material can be filled with foam generated from the adhesion layer. In an overlapping portion OL of the film member FM, the ends of the film member FM in the circumferential direction are joined to each other by an adhesion layer.

In the intermediate conductor portion 152, the insulating jacket 157 is provided so as to cover all of the two side surfaces in the circumferential direction and the two side surfaces in the radial direction. In this case, the insulating jacket 157 surrounding the intermediate conductor portion 152 includes the overlapping portion OL where the film member FM overlaps. The overlapping portion OL is provided at a portion facing the intermediate conductor portion 152 in the winding segment 151 of the other phase, that is, one of two side surfaces of the intermediate conductor portion 152 in the circumferential direction. In the present embodiment, the overlapping portions OL are respectively provided on the same side in the circumferential direction in the pair of intermediate conductor portions 152.

In the first winding segment 151A, the insulating jacket 157 is provided in a range from the intermediate conductor portion 152 to a portion covered with the insulating covers 161 and 162 in the first link portion 153A on both sides in the axial direction (i.e., a portion on the inner side of the insulating covers 161 and 162). With reference to FIG. 17, a range of AX1 in the first coil module 150A is a portion not covered with the insulating covers 161 or 162, and the insulating jacket 157 is provided in a range vertically expanded from the range AX1.

Next, a configuration of the insulating covers 161 and 162 will be described.

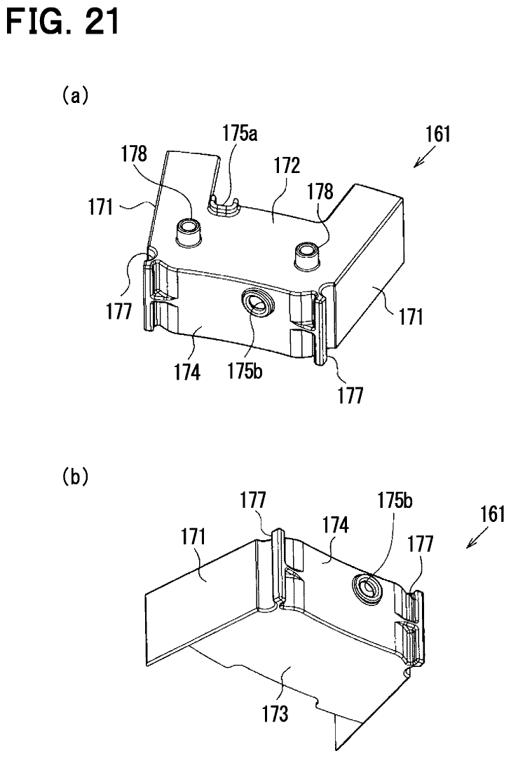

The insulating cover 161 is mounted to the first link portion 153A on one side of the first winding segment 151A in the axial direction. The insulating cover 162 is mounted to the first link portion 153A on the other side of the first winding segment 151A in the axial direction. Among them, the configuration of the insulating cover 161 is illustrated in (a) and (b) of FIG. 21. (a) and (b) of FIG. 21 are perspective views of the insulating cover 161 as viewed from two different directions.

As illustrated in (a) and (b) of FIG. 21, the insulating cover 161 includes a pair of side surface portions 171 serving as side surfaces in the circumferential direction, the outer surface portion 172 on the outer side in the axial direction, an inner surface portion 173 on the inner side in the axial direction, and a front surface portion 174 on the inner side in the radial direction. Each of these portions 171 to 174 is formed in a plate shape, and is three-dimensionally joined to each other such that only the outer side in the radial direction is open. Each of the pair of side surface portions 171 is provided in a direction extending toward the axial center of the core assembly CA with the core assembly CA being assembled. Therefore, in a state where the plurality of first coil modules 150A are disposed side by side in the circumferential direction, the side surface portions 171 of the insulating cover 161 face each other while being in contact with or close to each other in the adjacent first coil modules 150A. As a result, the first coil modules 150A adjacent to each other in the circumferential direction can be disposed in a suitable annular shape while being insulated from each other.

In the insulating cover 161, the outer surface portion 172 includes an opening 175a for drawing out the winding end 154 of the first winding segment 151A, and the front surface portion 174 includes an opening 175b for drawing out the winding end 155 of the first winding segment 151A. In this case, one winding end 154 is drawn out in the axial direction from the outer surface portion 172, whereas the other winding end 155 is drawn out in the radial direction from the front surface portion 174.

In the insulating cover 161, the pair of side surface portions 171 each include semicircular recesses 177 extending in the axial direction at both ends of the front surface portion 174 in the circumferential direction, that is, positions where the side surface portions 171 and the front surface portion 174 intersect. The outer surface portion 172 includes a pair of protrusions 178 extending in the axial direction at positions symmetrical on both sides in the circumferential direction with the center line of the insulating cover 161 in the circumferential direction as a reference.

The supplementary description of the recess 177 of the insulating cover 161 will be provided. As illustrated in FIG. 20, the first link portion 153A of the first winding segment 151A has a curved shape that protrudes inward in the radial direction, that is, toward the core assembly CA, among inward and outward in the radial direction. In such a configuration, a gap that becomes wider toward the extending end side of the first link portion 153A is formed between the first link portions 153A adjacent to each other in the circumferential direction. In the present embodiment, by utilizing the gap between the first link portions 153A arranged in the circumferential direction, the recess 177 is provided at a position on the outer side of the curved portion of the first link portion 153A at the side surface portion 171 of the insulating cover 161.

A temperature detector (thermistor) may be provided in the first winding segment 151A. In such a configuration, an opening for drawing out a signal line extending from the temperature detector is preferably provided in the insulating cover 161. In this case, the temperature detector can be suitably accommodated in the insulating cover 161.

Although not described in detail with reference to the drawings, the insulating cover 162 on the other side in the axial direction has a configuration substantially the same as or similar to the insulating cover 161. Similarly to the insulating cover 161, the insulating cover 162 includes the pair of side surface portions 171, the outer surface portion 172 on the outer side in the axial direction, the inner surface portion 173 on the inner side in the axial direction, and the front surface portion 174 on the inner side in the radial direction. In the insulating cover 162, the pair of side surface portions 171 each include the semicircular recesses 177 at both ends of the front surface portion 174 in the circumferential direction, and the outer surface portion 172 includes the pair of protrusions 178. A difference from the insulating cover 161 is that the insulating cover 162 does not include an opening for drawing out the winding ends 154 and 155 of the first winding segment 151A.

In the insulating covers 161 and 162, the height dimensions thereof in the axial direction (i.e., the width dimension in the axial direction of the pair of side surface portions 171 and the front surface portion 174) differ from each other. Specifically, as illustrated in FIG. 17, W11>W12 is satisfied, where W11 represents a height dimension of the insulating cover 161 in the axial direction, and W12 represents a height dimension of the insulating cover 162 in the axial direction. The reasons for the above are as follows. The multiply wound conductive wire member CR requires the winding stage of the conductive wire member CR to be shifted to the subsequent stage (lane-changed) in a direction orthogonal to the winding direction (turning direction). Accordingly, the winding width is considered to be increased due to the shift thereof. To supplement, the insulating cover 161 among the insulating cover 161 and 162 is a portion covering the first link portion 153A on the side including the winding start and the winding end of the conductive wire member CR. Since the first link portion 153A includes the winding start and the winding end of the conductive wire member CR, the winding margin (overlapping margin) of the conductive wire member CR at the first link portion 153A becomes larger than that at the other portions, resulting in the potentially large winding width. Taking these factors into consideration, the height dimension W11 of the insulating cover 161 in the axial direction is greater than the height dimension W12 of the insulating cover 162 in the axial direction. The above configuration can eliminate the inconvenience that the number of turns of the conductive wire member CR is limited by the insulating covers 161 and 162, unlike the case where the respective height dimensions W11 and W12 of the insulating covers 161 and 162 have the dimension identical to each other.

Next, the second coil module 150B will be described.

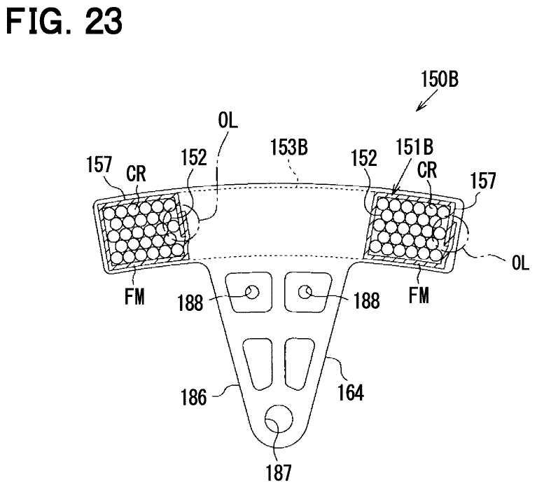

In FIG. 22, (a) is a perspective view illustrating a configuration of the second coil module 150B, and in FIG. 22, (b) is an exploded perspective view illustrating components of the second coil module 150B. FIG. 23 is a sectional view taken along line 23-23 in (a) in FIG. 22.

As illustrated in (a) and (b) in FIG. 22, the second coil module 150B includes the second winding segment 151B and the insulating covers 163 and 164. Similarly to the first winding segment 151A, the second winding segment 151B is formed by multiply winding the conductive wire member CR. The insulating covers 163 and 164 are respectively attached to one end side and the other end side of the second winding segment 151B in the axial direction. The insulating covers 163 and 164 are each formed of an insulating material such as synthetic resin.

The second winding segment 151B includes a pair of intermediate conductor portions 152 and a pair of second link portions 153B. The pair of intermediate conductor portions 152 are provided to be in parallel to each other and have a linear shape. The pair of second link portions 153B connect the pair of intermediate conductor portions 152 at both ends in the axial direction. The second winding segment 151B is formed in an annular shape by the pair of intermediate conductor portions 152 and the pair of second link portions 153B. In the second winding segment 151B, the pair of intermediate conductor portions 152 have the same configuration as the intermediate conductor portions 152 of the first winding segment 151A. On the other hand, the pair of second link portions 153B is different in configuration from the first link portions 153A of the first winding segment 151A. The second link portions 153B of the second winding segment 151B are provided so as to linearly extend in the axial direction from the intermediate conductor portion 152 without being bent in the radial direction. FIG. 18 clearly illustrates the difference between the winding segments 151A and 151B in comparison.

In the second winding segment 151B, an end of the conductive wire member CR is drawn out from one second link portion 153B (the second link portion 153B on the upper side of (b) in FIG. 22) among the second link portions 153B on both sides in the axial direction. These ends serve as the winding ends 154 and 155. Also in the second winding segment 151B, similarly to the first winding segment 151A, one of the winding ends 154 and 155 is connected to the current I/O terminal, and the other is connected to a neutral point.

In the second winding segment 151B, similarly to the first winding segment 151A, each intermediate conductor portion 152 is covered with a sheet-like insulating jacket 157. The insulating jacket 157 employs the film member FM having at least a length of a range of the intermediate conductor portion 152 to be covered with and insulated in the axial direction as a dimension in the axial direction. The insulating jacket 157 is provided by winding the film member FM around the intermediate conductor portion 152.

The configuration related to the insulating jacket 157 is substantially the same or similar to each other in the winding segments 151A and 151B. That is, as illustrated in FIG. 23, the film member FM covers around the intermediate conductor portion 152 with the ends of the film member FM in the circumferential direction overlapping each other. In the intermediate conductor portion 152, the insulating jacket 157 is provided so as to cover all of the two side surfaces in the circumferential direction and the two side surfaces in the radial direction. In this case, the insulating jacket 157 surrounding the intermediate conductor portion 152 includes the overlapping portion OL where the film member FM overlaps. The overlapping portion OL is provided at a portion facing the intermediate conductor portion 152 in the winding segment 151 of the other phase, that is, one of two side surfaces of the intermediate conductor portion 152 in the circumferential direction. In the present embodiment, the overlapping portions OL are respectively provided on the same side in the circumferential direction in the pair of intermediate conductor portions 152.

In the second winding segment 151B, the insulating jacket 157 is provided in a range from the intermediate conductor portion 152 to a portion covered with the insulating covers 163 and 164 in the second link portion 153B on both sides in the axial direction (i.e., a portion on the inner side of the insulating covers 163 and 164). With reference to FIG. 17, a range of AX2 in the second coil module 150B is a portion not covered with the insulating covers 163 and 164, and the insulating jacket 157 is provided in a range vertically expanded from the range AX2.

In each of the winding segments 151A and 151B, the insulating jacket 157 is provided in a range including part of the link portions 153A and 153B. In other words, in each of the winding segments 151A and 151B, the insulating jacket 157 is provided in the intermediate conductor portion 152 and a portion of the link portions 153A and 153B continuously extending linearly from the intermediate conductor portion 152. However, since the lengths of the winding segments 151A and 151B in the axial direction differ from each other, the ranges of the insulating jacket 157 in the axial direction also differ from each other.

Next, a configuration of the insulating covers 163 and 164 will be described.

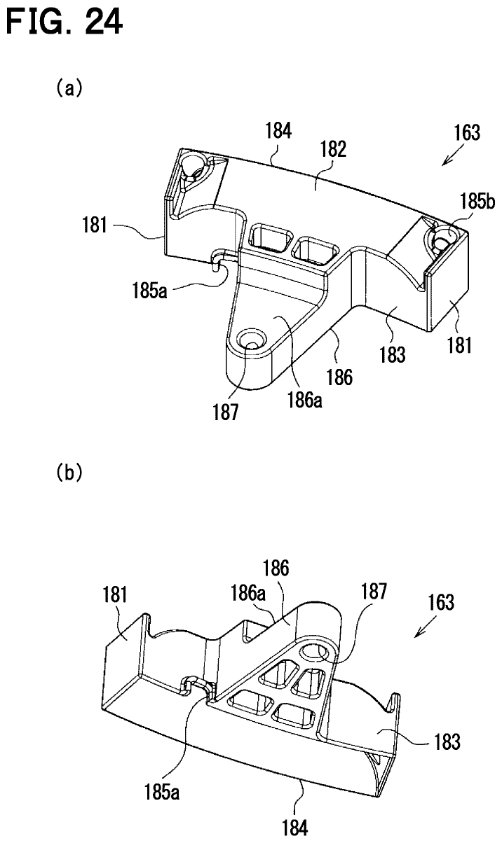

The insulating cover 163 is mounted to the second link portion 153B on one side of the second winding segment 151B in the axial direction. The insulating cover 164 is mounted to the second link portion 153B on the other side of the second winding segment 151B in the axial direction. Among them, the configuration of the insulating cover 163 is illustrated in (a) and (b) of FIG. 24. (a) and (b) of FIG. 24 are perspective views of the insulating cover 163 as viewed from two different directions.

As illustrated in (a) and (b) of FIG. 24, the insulating cover 163 includes a pair of side surface portions 181 serving as side surfaces in the circumferential direction, an outer surface portion 182 on the outer side in the axial direction, a front surface portion 183 on the inner side in the radial direction, and a rear surface portion 184 on the outer side in the radial direction. Each of these portions 181 to 184 is formed in a plate shape, and is three-dimensionally joined to each other such that only the inner side in the axial direction is open. Each of the pair of side surface portions 181 is provided in a direction extending toward the axial center of the core assembly CA with the core assembly CA being assembled. Therefore, in a state where the plurality of second coil modules 150B are disposed side by side in the circumferential direction, the side surface portions 181 of the insulating cover 163 face each other while being in contact with or close to each other in the adjacent second coil modules 150B. As a result, the second coil modules 150B adjacent to each other in the circumferential direction can be disposed in a suitable annular shape while being insulated from each other.

In the insulating cover 163, the front surface portion 183 includes an opening 185a for drawing out the winding end 154 of the second winding segment 151B, and the outer surface portion 182 includes an opening 185b for drawing out the winding end 155 of the second winding segment 151B.

The front surface portion 183 of the insulating cover 163 includes a protrusion 186 protruding inward in the radial direction. The protrusion 186 is provided at a central position between one end and the other end in the circumferential direction of the insulating cover 163 so as to protrude inward in the radial direction from the second link portion 153B. The protrusion 186 has a tapered shape that tapers toward the inner side in the radial direction in plan view. A through-hole 187 extending in the axial direction is provided at an extending end thereof. The protrusion 186 can employ any configurations as long as the protrusion 186 protrudes inward in the radial direction from the second link portion 153B and has the through-hole 187 at the central position between one end and the other end of the insulating cover 163 in the circumferential direction. However, assuming a state of overlapping with the insulating cover 161 on the inner side in the axial direction, the protrusion 186 is desirably formed to have a small width in the circumferential direction so as to avoid interference with the winding ends 154 and 155.

The protrusion 186 is thinned in the axial direction in a stepwise manner at the extending end on the inner side in the radial direction. The through-hole 187 is provided at a low step portion 186a thus thinned. The low step portion 186a corresponds to a portion where the height from the end surface of the inner cylinder member 81 in the axial direction is smaller than the height of the second link portion 153B in a state where the second coil module 150B is assembled to the core assembly CA.

As illustrated in FIG. 23, the protrusion 186 includes a through-hole 188 passing therethrough in the axial direction. Accordingly, in a state where the insulating covers 161 and 163 overlap each other in the axial direction, a space between the insulating covers 161 and 163 can be filled with the adhesive through the through-hole 188.

Although not described in detail with reference to the drawings, the insulating cover 164 on the other side in the axial direction has a configuration substantially the same as or similar to the insulating cover 163. Similarly to the insulating cover 163, the insulating cover 164 includes the pair of side surface portions 181, the outer surface portion 182 on the outer side in the axial direction, the front surface portion 183 on the inner side in the radial direction, and the rear surface portion 184 on the outer side in the radial direction. The insulating cover 164 further includes the through-hole 187 provided at the extending end of the protrusion 186. A difference from the insulating cover 163 is that the insulating cover 164 does not include an opening for drawing out the winding ends 154 and 155 of the second winding segment 151B.

In the insulating covers 163 and 164, the width dimensions of the pair of side surface portions 181 in the radial direction differ from each other. Specifically, as illustrated in FIG. 17, W21>W22 is satisfied, where W21 represents a width dimension of the side surface portion 181 in the insulating cover 163 in the radial direction, and W22 represents a width dimension of the side surface portion 181 in the insulating cover 164 in the radial direction. In other words, the insulating cover 163 among the insulating cover 163 and 164 is a portion covering the second link portion 153B on the side including the winding start and the winding end of the conductive wire member CR. Since the second link portion 153B includes the winding start and the winding end of the conductive wire member CR, the winding margin (overlapping margin) of the conductive wire member CR at the second link portion 153B becomes larger than that at the other portions, resulting in the potentially large winding width. Taking this factor into consideration, the width dimension W21 of the insulating cover 163 in the radial direction is greater than the width dimension W22 of the insulating cover 164 in the radial direction. The above configuration can eliminate the inconvenience that the number of turns of the conductive wire member CR is limited by the insulating covers 163 and 164, unlike the case where the respective width dimensions W21 and W22 of the insulating covers 163 and 164 have the dimension identical to each other.

FIG. 25 is a view illustrating an overlapping position of the film member FM in a state where the coil modules 150A and 150B are arranged in the circumferential direction. As described above, in each of the coil modules 150A and 150B, the periphery of the intermediate conductor portion 152 is covered with the film member FM so as to overlap with each other at the portion of the winding segment 151 of the other phase facing the intermediate conductor portion 152, that is, at the side surface of the intermediate conductor portion 152 in the circumferential direction (see FIGS. 20 and 23). In a state where the coil modules 150A and 150B are disposed in the circumferential direction, the overlapping portions OL of the film members FM are disposed on the same side among both sides in the circumferential direction (the right side in the circumferential direction in the drawing). With this arrangement, in the intermediate conductor portions 152 of the winding segments 151A and 151B of different phases adjacent to each other in the circumferential direction, the overlapping portions OL of the film members FM do not overlap with each other in the circumferential direction. In this case, a maximum of three film members FM overlap with each other between the intermediate conductor portions 152 arranged in the circumferential direction.

Next, a configuration related to assembly of the coil modules 150A and 150B to the core assembly CA will be described.

The coil modules 150A and 150B have different lengths in axial direction and different shapes of the link portions 153A and 153B of the winding segments 151A and 151B. The coil modules 150A and 150B are attached to the core assembly CA while the first link portion 153A of the first coil module 150A is disposed on the inner side in the axial direction and the second link portion 153B of the second coil module 150B is disposed on the outer side in the axial direction. As for the insulating covers 161 to 164, each of the insulating covers 161 to 164 is fixed to the core assembly CA while the insulating covers 161 and 163 are overlapped in the axial direction on one end side of the respective coil modules 150A and 150B in the axial direction and the insulating covers 162 and 164 are overlapped in the axial direction on the other end side of the respective coil modules 150A and 150B in the axial direction.

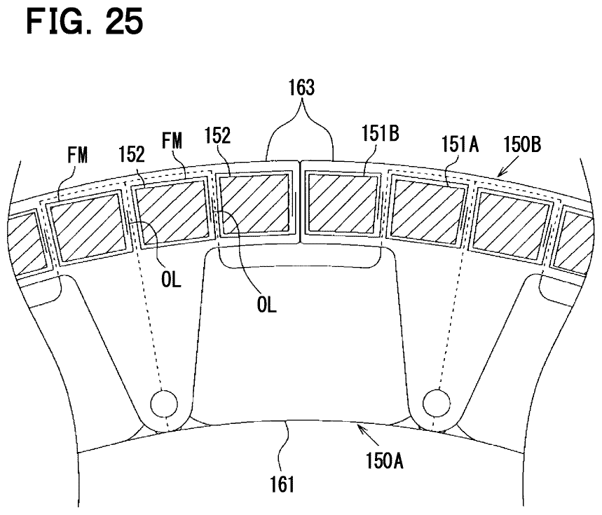

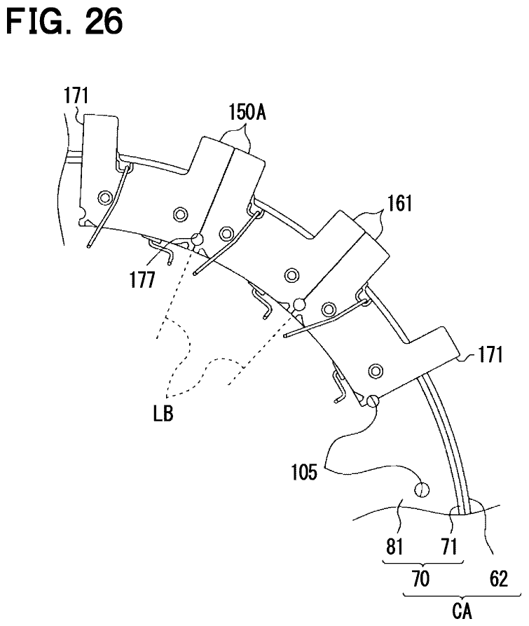

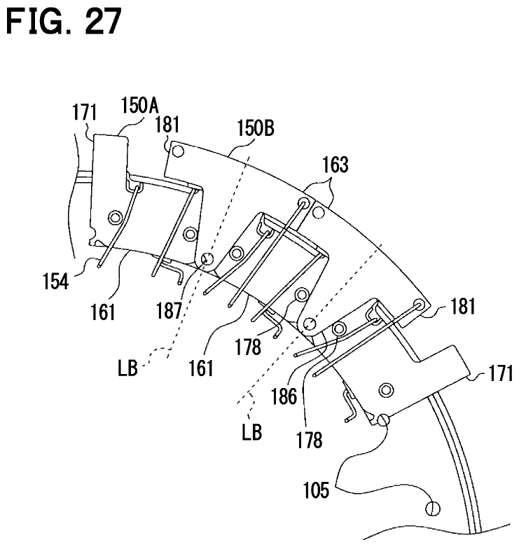

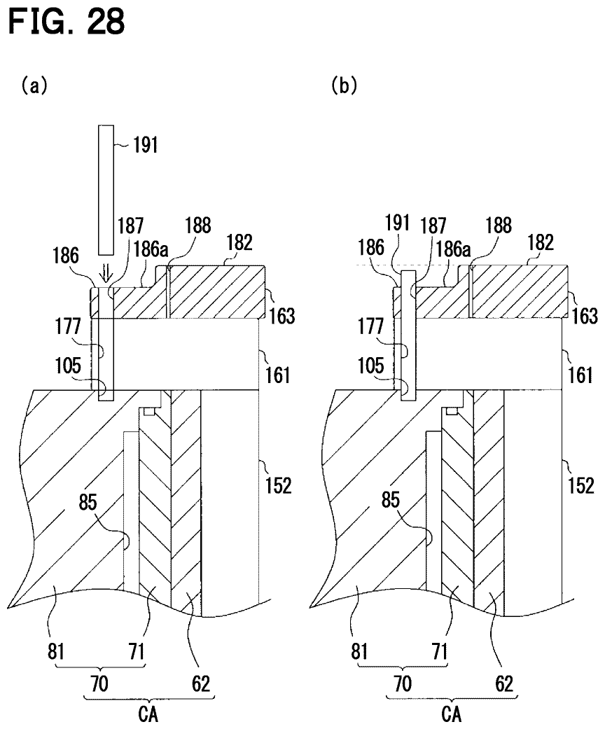

FIG. 26 is a plan view illustrating a state where the plurality of insulating covers 161 are arranged in the circumferential direction while the first coil module 150A is assembled to the core assembly CA. FIG. 27 is a plan view illustrating a state where the plurality of insulating covers 161 and 163 are arranged in the circumferential direction while the first coil module 150A and the second coil module 150B are assemble to the core assembly CA. In FIG. 28, (a) is a longitudinal sectional view illustrating a state before fixation with a fastening pin 191 while the coil modules 150A and 150B are assemble to the core assembly CA. In FIG. 28, (b) is a longitudinal sectional view illustrating a state after fixation with the fastening pin 191 while the coil modules 150A and 150B are assemble to the core assembly CA.

As illustrated in FIG. 26, in a state where the plurality of first coil modules 150A are assembled to the core assembly CA, the plurality of insulating covers 161 are disposed with the side surface portions 171 being in contact with or close to each other. Each of the insulating covers 161 is disposed such that a boundary line LB at which the side surface portions 171 face each other lays over the recess 105 on the end surface of the inner cylinder member 81 in the axial direction. In this case, when the side surface portions 171 of the insulating covers 161 adjacent to each other in the circumferential direction are brought into contact with or close to each other, a through-hole portion extending in the axial direction is formed by each of the recesses 177 of the insulating covers 161. The positions of the through-hole portion and the recess 105 then match each other.

As illustrated in FIG. 27, the second coil module 150B is further assembled to the integrated object of the core assembly CA and the first coil module 150A. This assembly involves disposing the plurality of insulating covers 163 with the side surface portions 181 being in contact with or close to each other. In this state, the link portions 153A and 153B are disposed so as to cross each other on a circle in which the intermediate conductor portions 152 are arranged in the circumferential direction. Each insulating cover 163 is disposed such that the protrusion 186 overlaps the insulating cover 161 in the axial direction and the through-hole 187 of the protrusion 186 is connected in the axial direction to the through-hole portion formed by each recess 177 of the insulating cover 161.

At this time, the protrusion 186 of the insulating cover 163 is guided to a predetermined position by the pair of protrusions 178 provided on the insulating cover 161. In this way, the position of the through-hole 187 on the insulating cover 163 side matches the position of the through-hole portion and the recess 105 of the inner cylinder member 81 on the insulating cover 161 side. More specifically, in a state where the coil modules 150A and 150B are assembled to the core assembly CA, the recess 177 of the insulating cover 161 is positioned on the back side of the insulating cover 163. Thus, the through-hole 187 of the protrusion 186 may be difficult to be aligned with the recess 177 of the insulating cover 161. In this respect, the protrusion 186 of the insulating cover 163 is guided by the pair of protrusions 178 of the insulating cover 161, so that the alignment of the insulating cover 163 with respect to the insulating cover 161 is facilitated.

As illustrated in (a) and (b) of FIG. 28, fixing with the fastening pin 191 as a fastening member is then performed while the insulating cover 161 and the protrusion 186 of the insulating cover 163 are engaged with the fastening pin 191 at their overlapping portion. More specifically, the fastening pin 191 is inserted into the recesses 105 and 177 and the through-hole 187 while the recess 105 of the inner cylinder member 81, the recess 177 of the insulating cover 161, and the through-hole 187 of the insulating cover 163 are aligned. Accordingly, the insulating covers 161 and 163 are integrally fixed to the inner cylinder member 81. According to this configuration, the coil modules 150A and 150B adjacent to each other in the circumferential direction are fixed to the core assembly CA by the common fastening pin 191 at the coil end CE. The fastening pin 191 desirably includes a material having good thermal conductivity, and is, for example, a metal pin.

As illustrated in (b) in FIG. 28, the fastening pin 191 is assembled to the low step portion 186a of the protrusion 186 of the insulating cover 163. In this state, the upper end of the fastening pin 191 protrudes above the low step portion 186a, but does not protrude upward from the upper surface (outer surface portion 182) of the insulating cover 163. In this case, the length of the fastening pin 191 is greater than the height dimension in the axial direction of the overlapping portion between the insulating cover 161 and the protrusion 186 (low step portion 186a) of the insulating cover 163 and has a margin protruding upward. Thus, conceivably, when the fastening pin 191 is inserted into the recesses 105 and 177 and the through-hole 187 (that is, when the fastening pin 191 is fixed), such an insertion (fixing) work can be easily performed. In addition, the upper end of the fastening pin 191 does not protrude upward from the upper surface (outer surface portion 182) of the insulating cover 163. This configuration can eliminate an inconvenience that the axial length of the stator 60 becomes large due to the protrusion of the fastening pin 191.

After fixing the insulating covers 161 and 163 by the fastening pin 191, the adhesive is filled through the through-hole 188 provided in the insulating cover 163. In this way, the insulating covers 161 and 163 overlapping in the axial direction are securely joined to each other. In (a) and (b) of FIG. 28, for convenience, the through-hole 188 is illustrated in a range from the upper surface to the lower surface of the insulating cover 163. In practice, however, the through-hole 188 is provided in a thin plate portion formed by lightening or the like.

As illustrated in (b) in FIG. 28, the position of each of the insulating covers 161 and 163 fixed with the fastening pin 191 is the end surface of the stator holder 70 in the axial direction further on the inner side than the stator core 62 in the radial direction (on the left side in the drawing), and the fastening pin 191 is fixed to the stator holder 70. That is, the first link portion 153A is fixed to the end surface of the stator holder 70 in the axial direction. In this case, since the stator holder 70 includes the coolant path 85, the heat generated at the first winding segment 151A is directly transferred from the first link portion 153A to the portion at or near the coolant path 85 of the stator holder 70. The fastening pin 191 is inserted into the recess 105 of the stator holder 70, and heat transfer to the stator holder 70 side is promoted through the fastening pin 191. With this configuration, improvement of cooling performance of the stator winding 61 is achieved.

In the present embodiment, 18 of the insulating covers 161 and 18 of the insulating covers 163 are disposed to overlap each other on the inner side and the outer side in the axial direction at the coil end CE. Recesses 105 are provided at 18 locations that is the same as the number of the insulating covers 161 and the number of the insulating covers 163 on the end surface of the stator holder 70 in the axial direction. The recesses 105 at the 18 locations are fixed with the fastening pins 191.

Although not illustrated, the same applies to the insulating covers 162 and 164 on the opposite side in the axial direction. In other words, first, when the side surface portions 171 of the insulating covers 162 adjacent to each other in the circumferential direction are brought into contact with or close to each other upon assembly of the first coil module 150A, a through-hole portion extending in the axial direction is formed by each of the recesses 177 of the insulating covers 162. The positions of the through-hole portion and the recess 106 at the end surface of the outer cylinder member 71 in the axial direction then match each other. Thereafter, due to the assembly of the second coil module 150B, the position of the through-hole 187 on the insulating cover 164 side matches the positions of the through-hole portion on the insulating cover 163 side and the recess 106 of the outer cylinder member 71. Subsequently, the fastening pin 191 is inserted into the recesses 106 and 177 and the through-hole 187, whereby the insulating covers 162 and 164 is integrally fixed to the outer cylinder member 71.

When the coil modules 150A and 150B are assembled to the core assembly CA, all the first coil modules 150A are assembled first to the outer peripheral side of the core assembly CA, and then all the second coil modules 150B are assembled and fixed with the fastening pins 191. Alternatively, the two first coil modules 150A and the one second coil module 150B may be first fixed to the core assembly CA with one fastening pin 191, and thereafter, the assembly of the first coil module 150A, the assembly of the second coil module 150B, and fixing with the fastening pin 191 may be repeatedly performed in this order.

Next, the bus bar module 200 will be described.

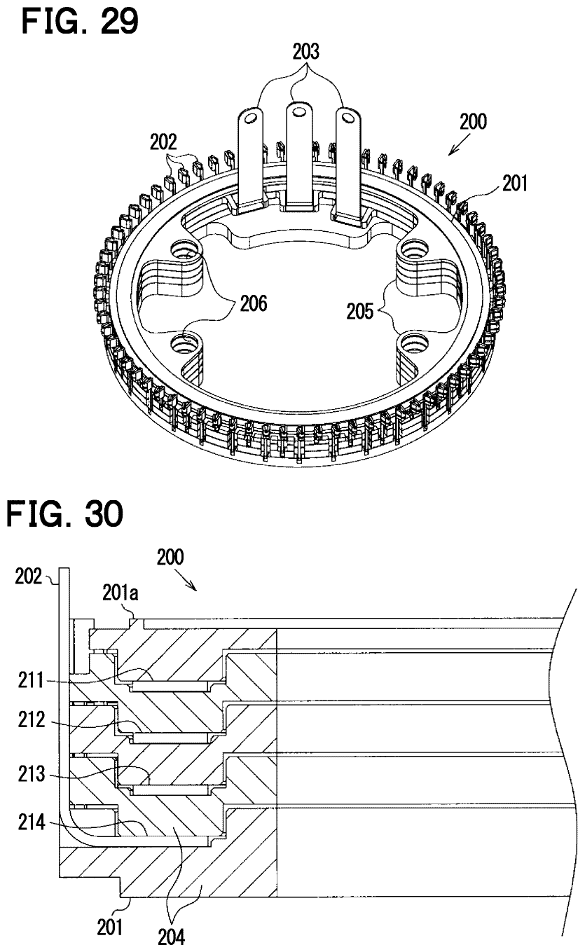

The bus bar module 200 is a winding connection member that is electrically connected to the winding segment 151 of each coil module 150 in the stator winding 61, connects one end of the winding segment 151 of each phase in parallel for each phase, and connects the other ends of the winding segments 151 at a neutral point. FIG. 29 is a perspective view of the bus bar module 200. FIG. 30 is a sectional view illustrating part of a longitudinal section of the bus bar module 200.

The bus bar module 200 includes an annular ring 201 having an annular shape, a plurality of connection terminals 202 extending from the annular ring 201, and three I/O terminals 203 provided for each phase winding. The annular ring 201 is formed in an annular shape by using, for example, an insulating member such as resin.

As illustrated in FIG. 30, the annular ring 201 has a substantially annular plate shape and includes stacked plates 204 stacked in multiple layers (five layers in the present embodiment) in the axial direction. Four bus bars 211 to 214 are provided while being sandwiched between each adjacent two of the stacked plates 204. Each of the bus bars 211 to 214 has an annular shape, and includes a U-phase bus bar 211, a V-phase bus bar 212, a W-phase bus bar 213, and a neutral-point bus bar 214. These bus bars 211 to 214 are disposed side by side in the axial direction with plate surfaces facing each other in the annular ring 201. Each stacked plate 204 and each of the bus bars 211 to 214 are joined to each other by using an adhesive. An adhesive sheet is desirably used as the adhesive. However, a liquid or semi-liquid adhesive may be applied. The connection terminal 202 is connected to each of the bus bars 211 to 214 so as to protrude outward in the radial direction from the annular ring 201.

A protrusion 201a annularly extending in an annular shape is provided on the upper surface of the annular ring 201, that is, the upper surface of the stacked plate 204 on the outermost layer side of the stacked plates 204 provided in the form of five layers.

The bus bar module 200 only needs to be provided in a state where the bus bars 211 to 214 are embedded in the annular ring 201. The bus bars 211 to 214 disposed at predetermined intervals may be integrally insert-molded. The arrangement of the bus bars 211 to 214 is not limited to the configuration in which all the bus bars are arranged in the axial direction and all the plate surfaces face the same direction. For example, the bus bars 211 to 214 may be arranged in the radial direction, may be arranged in two rows in the axial direction and in two rows in the radial direction, and may include different extending directions.

In FIG. 29, the connection terminals 202 are arranged in the circumferential direction of the annular ring 201 and extend in the axial direction on the outer side in the radial direction. The connection terminals 202 include a connection terminal connected to the U-phase bus bar 211, a connection terminal connected to the V-phase bus bar 212, a connection terminal connected to the W-phase bus bar 213, and a connection terminal connected to the neutral-point bus bar 214. The connection terminals 202 are provided as many as the winding ends 154 and 155 of the respective winding segments 151 in the coil module 150. One winding end 154 or one winding end 155 of each winding segment 151 is connected to the corresponding connection terminal 202. With this configuration, the bus bar module 200 is connected to each of the U-phase winding segment 151, the V-phase winding segment 151, and the W-phase winding segment 151.

The I/O terminal 203 is made of, for example, a bus bar member, and is provided in a direction extending in the axial direction. The I/O terminal 203 includes a U-phase I/O terminal 203U, a V-phase I/O terminal 203V, and a W-phase I/O terminal 203W. These I/O terminals 203 are connected to the respective bus bars 211 to 213 for each phase in the annular ring 201. Through the I/O terminals 203, power is input from an inverter (not illustrated) and output to the phase winding of each phase of the stator winding 61.

A current sensor that detects the phase current of each phase may be integrally provided in the bus bar module 200. In this case, preferably, a current detection terminal is provided in the bus bar module 200 and a detection result of the current sensor is output to a controller (not illustrated) through the current detection terminal.

The annular ring 201 has a plurality of protrusions 205 protruding toward the inner peripheral side as fixed portions with respect to the stator holder 70. A through-hole 206 extending in the axial direction is formed in the protrusion 205.

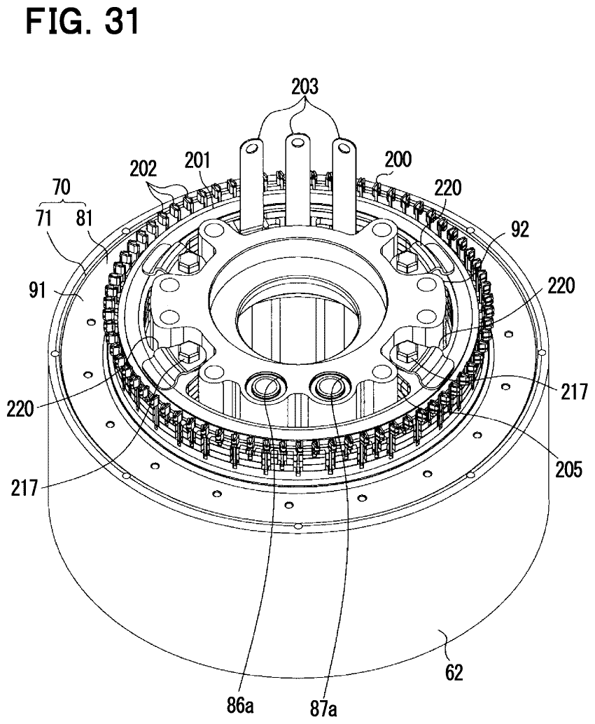

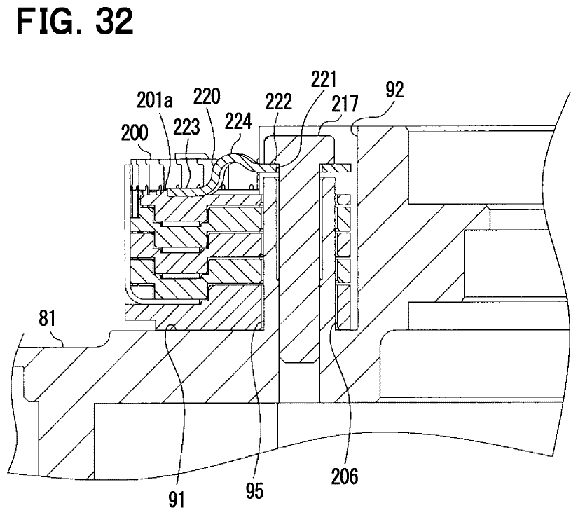

FIG. 31 is a perspective view illustrating a state where the bus bar module 200 is assembled to the stator holder 70, and FIG. 32 is a longitudinal sectional view of the stationary portion in which the bus bar module 200 is fixed. For information about the configuration of the stator holder 70 before the bus bar module 200 is assembled thereto, please refer to FIG. 12.

In FIG. 31, the bus bar module 200 is provided on the end plate portion 91 so as to surround the boss 92 of the inner cylinder member 81. The bus bar module 200 is fixed to the stator holder 70 (inner cylinder member 81) by using a fastener 217 such as a bolt while the bus bar module 200 is positioned through assembling the inner cylinder member 81 to the rod 95 (see FIG. 12).

More specifically, as illustrated in FIG. 32, the end plate portion 91 of the inner cylinder member 81 includes the rod 95 extending in the axial direction. The bus bar module 200 is fixed to the rod 95 by using the fasteners 217 while the rods 95 are inserted through the through-holes 206 respectively provided in the plurality of protrusions 205. In the present embodiment, the bus bar module 200 is fixed using a retainer plate 220 made of a metal material such as iron. The retainer plate 220 includes a mating fastener portion 222, a press portion 223, and a bent portion 224. The mating fastener portion 222 has an insertion hole 221 through which the fastener 217 is inserted. The press portion 223 presses the upper surface of the annular ring 201 of the bus bar module 200. The bent portion 224 is provided between the mating fastener portion 222 and the press portion 223.

When the retainer plate 220 is mounted, the fastener 217 is screwed to the rod 95 of the inner cylinder member 81 while the fastener 217 is inserted through the insertion hole 221 of the retainer plate 220. The press portion 223 of the retainer plate 220 is in contact with the upper surface of the annular ring 201 of the bus bar module 200. In this case, as the fastener 217 is screwed into the rod 95, the retainer plate 220 is pushed downward as viewed in the drawing, and accordingly, the annular ring 201 is pressed downward by the press portion 223. The downward pressure as viewed in the drawing, generated by the screwing of the fastener 217, is transmitted to the press portion 223 through the bent portion 224. Thus, pressing by the press portion 223 is performed while accompanying the elastic pressure at the bent portion 224.

As described above, the annular protrusion 201a is provided on the upper surface of the annular ring 201, and the extending end of the retainer plate 220 on the press portion 223 side can be brought into contact with the protrusion 201a. This configuration can prevent the downward pressure of the retainer plate 220 as viewed in the drawing from being released outward in the radial direction. That is, the pressure generated by the screwing of the fastener 217 is appropriately transmitted to the press portion 223 side.

As illustrated in FIG. 31, when the bus bar module 200 is assembled with respect to the stator holder 70, the I/O terminal 203 is provided at a position 180° opposite to the inlet opening 86a and the outlet opening 87a communicating with the coolant path 85 in the circumferential direction. However, the I/O terminal 203 and the openings 86a and 87a may be collectively provided at the same position (that is, positions close to each other).

Next, a lead member 230 that electrically connects the I/O terminal 203 of the bus bar module 200 to an external device outside the rotary electric machine 10 will be described.

As illustrated in FIG. 1, in the rotary electric machine 10, the I/O terminal 203 of the bus bar module 200 is provided so as to protrude outward from the housing cover 242, and is connected to the lead member 230 on the outer side of the housing cover 242. The lead member 230 relays connection between the I/O terminal 203 for each phase extending from the bus bar module 200 and a power line for each phase extending from an external device such as an inverter.

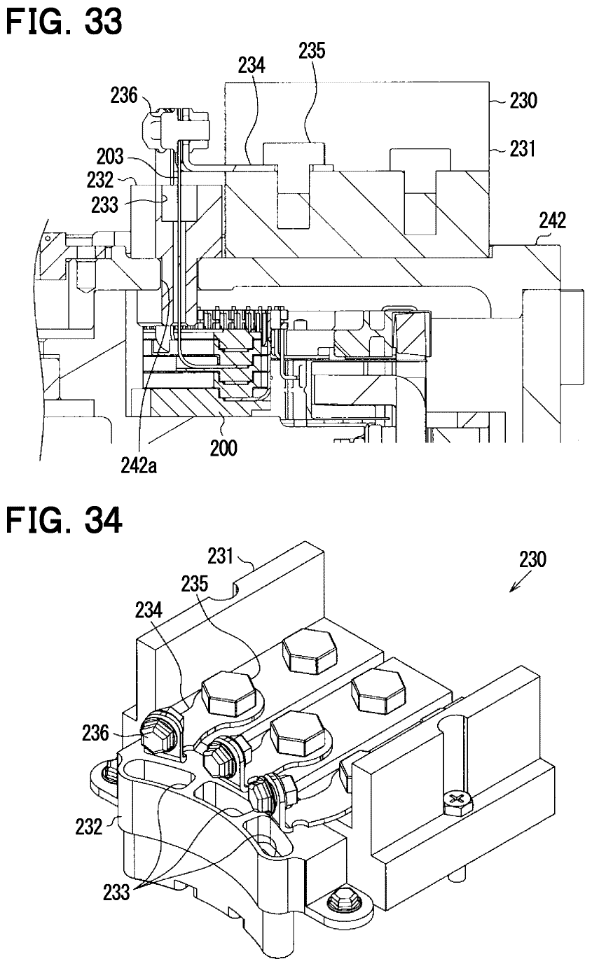

FIG. 33 is a longitudinal sectional view illustrating a state where the lead member 230 is attached to the housing cover 242. FIG. 34 is a perspective view of the lead member 230. As illustrated in FIG. 33, a through-hole 242a is formed at the housing cover 242, and the I/O terminal 203 can be drawn out through the through-hole 242a.

The lead member 230 includes a base 231 fixed to the housing cover 242 and a terminal plug 232 inserted into the through-hole 242a of the housing cover 242. The terminal plug 232 has three insertion holes 233. The I/O terminals 203 of the respective phases are inserted through the respective insertion hole 233 on a one-to-one basis. In each of the three insertion holes 233, the section of the opening has an elongated shape. The three insertion holes 233 are formed such that their longitudinal directions are substantially aligned with each other.

The base 231 is attached with three lead bus bars 234 provided for each phase. The lead bus bar 234 is bent and formed in a substantially L shape and is fixed to the base 231 by a fastener 235 such as a bolt. The lead bus bar 234 is further fixed to an extending end of the I/O terminal 203 inserted through the insertion hole 233 of the terminal plug 232 by using a fastener 236 such as a bolt and a nut.

Although not illustrated, a power line for each phase extending from an external device can be connected to the lead member 230. Thus, power can be input to and output from the I/O terminal 203 for each phase.

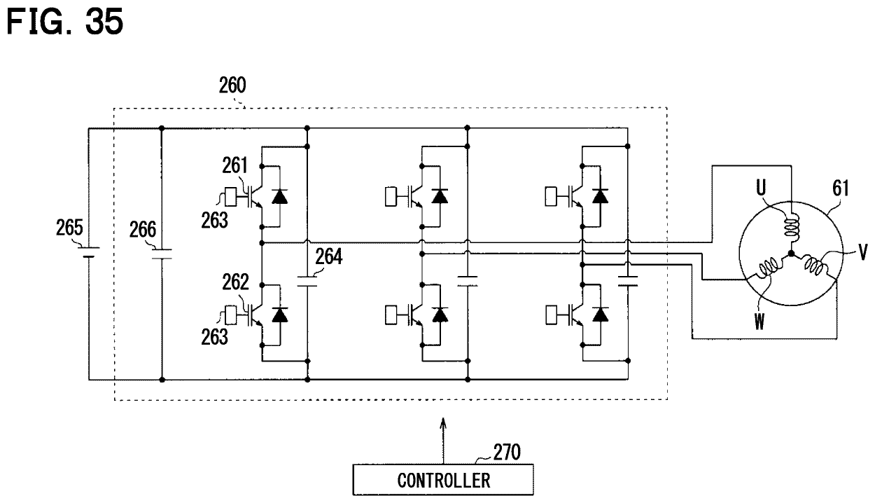

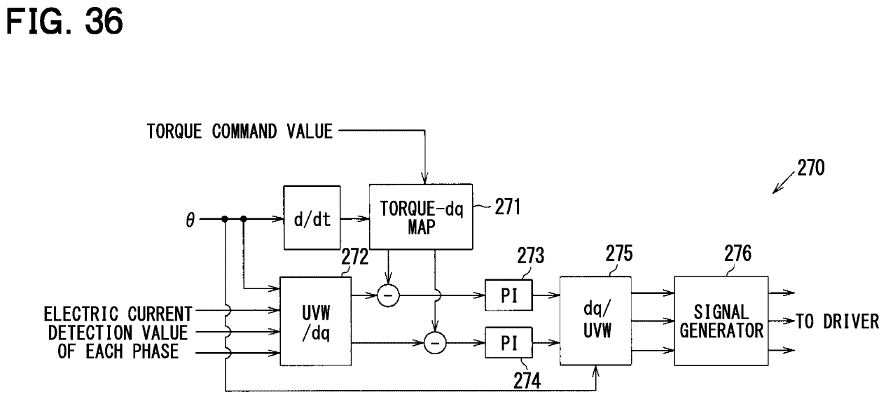

Next, a configuration of a control system that controls the rotary electric machine 10 will be described. FIG. 35 is an electrical circuit diagram of a control system of the rotary electric machine 10, and FIG. 36 is a functional block diagram illustrating control operation by a controller 270.

As illustrated in FIG. 35, the stator winding 61 includes a U-phase winding, a V-phase winding, and a W-phase winding, and an inverter 260 corresponding to a power converter is connected to the stator winding 61. The inverter 260 is configured by a bridge circuit having upper and lower arms whose numbers are respectively identical to the number of phases. The inverter 260 includes a series-connected part including an upper arm switch 261 and a lower arm switch 262 for each phase. Each of these switches 261 and 262 is turned on and off by a driver circuit 263 to control energization of the phase windings of each phase. Each of the switches 261 and 262 includes a semiconductor switch such as a metal-oxide-semiconductor field-effect transistor (MOSFET) or an insulated-gate bipolar transistor (IGBT). A capacitor 264 for charge supply that supplies charges required at the time of switching to the switches 261 and 262 is connected to the upper and lower arms of each phase in parallel to the series-connected part of the switches 261 and 262.

One ends of the U-phase winding, the V-phase winding, and the W-phase winding are respectively connected to intermediate connection points between the switches 261 and 262 of the upper and lower arms. The phase windings are connected in a form of the star connection (Y-connection), and the other ends of the phase windings are connected to one another at the neutral point.

The controller 270 includes a microcomputer including a central processing unit (CPU) and various memories. The controller 270 performs energization control by turning on and off each of the switches 261 and 262 on the basis of various detection information and a request for a motor mode or a generator mode of the rotary electric machine 10. The detection information of the rotary electric machine 10 includes, for example, an angular position (electrical angle) of the rotor 20 detected by an angle detector such as a resolver, a power supply voltage (voltage inputted to the inverter) detected by a voltage sensor, and an exciting current for each phase winding detected by a current sensor. The controller 270 performs on/off control of each of the switches 261 and 262 by, for example, pulse width modulation (PWM) control at a predetermined switching frequency (carrier frequency) or rectangular wave control. The controller 270 may be a built-in controller incorporated into the rotary electric machine 10 or may be an external controller provided outside the rotary electric machine 10.

Since the rotary electric machine 10 according to the present embodiment has a slot-less structure (tooth-less structure), the inductance of the stator 60 is reduced and the electrical time constant is small. Under a condition where the electrical time constant is small, the switching frequency (carrier frequency) is desirably increased to increase the switching speed. In this respect, the capacitor 264 for charge supply is connected in parallel to the series-connected part of the switches 261 and 262 of each phase, thereby reducing the wiring inductance. Therefore, an appropriate countermeasure against surge can be taken even in a configuration in which the switching speed is increased.

The high-potential side terminal of the inverter 260 is connected to the positive electrode terminal of a direct current (DC) power supply 265, and the low-potential side terminal is connected to the negative electrode terminal (ground) of the DC power supply 265. The DC power supply 265 includes, for example, an assembled battery in which a plurality of unit cells are connected in series. In addition, a smoothing capacitor 266 is connected in parallel to the DC power supply 265 to the high-potential side terminal and the low-potential side terminal of the inverter 260.

FIG. 36 is a block diagram illustrating a current feedback control operation for controlling the phase currents of U-, V-, and W-phases.

In FIG. 36, a current command determiner 271 uses a torque-dq map to determine a current command value for the d-axis and a current command value for the q-axis. This command determination is based on: a motor-mode torque command value or a generator-mode torque command value for the rotary electric machine 10; and an electrical angular velocity ω obtained by differentiating an electrical angle θ with respect to time. When the rotary electric machine 10 is used as, for example, a power source for an automotive application, the generator-mode torque command value is a regenerative torque command value.

A d-q converter 272 converts a current value (three phase currents) detected by a current sensor provided for each phase into a d-axis current and a q-axis current. The d-axis current and the q-axis current are components of a two-dimensional rotating Cartesian coordinate system having a direction of an axis of a magnetic field, or field direction, as a d-axis.

The d-axis current feedback control device 273 calculates a d-axis command voltage as a manipulated variable for bringing the d-axis current into agreement with the current command value for the d-axis in a feedback mode. The q-axis current feedback control device 274 calculates a q-axis command voltage as a manipulated variable for bringing the q-axis current into agreement with the current command value for the q-axis in a feedback mode. In each of the feedback control devices 273 and 274, the command voltage is calculated using proportional integral (PI) feedback techniques on the basis of the deviation of the d-axis current and the q-axis current with respect to the current command value.

The three-phase converter 275 converts the d-axis and q-axis command voltages into U-phase, V-phase, and W-phase command voltages. Each of the units 271 to 275 described above is a feedback control device that performs feedback control of the fundamental wave current according to the d-q transformation theory. The command voltages of the U-phase, the V-phase, and the W-phase are feedback control values.

An operation signal generator 276 generates an operation signal of the inverter 260 on the basis of a three-phase command voltage by using a well-known triangle wave carrier comparison. Specifically, the operation signal generator 276 generates switch operation signals (duty signals) for the upper and lower arms in each phase by PWM control. The PWM control is based on magnitude comparison between a signal obtained by normalizing command voltages of three phases with a power supply voltage and a carrier signal such as a triangle wave signal. The switch operation signal generated by the operation signal generator 276 is output to the driver circuit 263 of the inverter 260. The driver circuit 263 turns on and off the switches 261 and 262 of the respective phases.

Next, torque feedback control operation will be described. This operation is mainly used for the purpose of increasing the output power and reducing the loss of the rotary electric machine 10 under an operating condition where the output voltage of the inverter 260 increases. Examples of a situation under such an operating condition include a high rotation operation region and a high output operation region. The controller 270 selects and executes either the torque feedback control operation or the current feedback control operation based on the operating condition of the rotary electric machine 10.

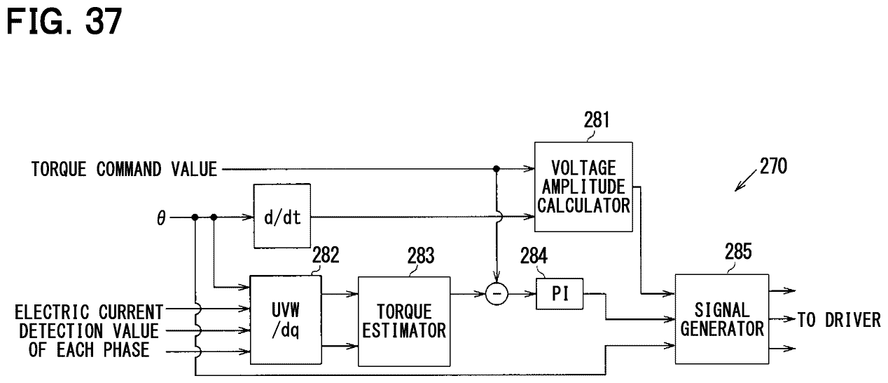

FIG. 37 is a block diagram illustrating a torque feedback control operation corresponding to the U-, V-, and W-phases.

A voltage amplitude calculator 281 calculates a voltage amplitude command that is a command value of the magnitude of the voltage vector. The calculation is based on the motor-mode torque command value or the generator-mode torque command value for the rotary electric machine 10 and the electrical angular velocity ω obtained by differentiating the electrical angle θ with respect to time.

Similarly to the d-q converter 272, a d-q converter 282 converts a current value detected by a current sensor provided for each phase into a d-axis current and a q-axis current. A torque estimator 283 calculates estimated torque values corresponding to the U-, V-, and W-phases based on the d-axis current and the q-axis current. The torque estimator 283 is only required to calculate the voltage amplitude command on the basis of map information in which the d-axis current, the q-axis current, and the voltage amplitude command are associated with each other.

A torque feedback control device 284 calculates a voltage phase command as a manipulated variable for bringing the estimated torque value into agreement with the motor-mode torque command value or the generator-mode torque command value in a feedback mode. The voltage phase command is a command value of a phase of a voltage vector. The torque feedback control device 284 calculates the voltage phase command using the PI feedback techniques on the basis of the deviation of the estimated torque value with respect to the motor-mode torque command value or the generator-mode torque command value.

An operation signal generator 285 generates an operation signal of the inverter 260 based on the voltage amplitude command, the voltage phase command, and the electrical angle θ. Specifically, the operation signal generator 285 calculates a three-phase command voltages on the basis of the voltage amplitude command, the voltage phase command, and the electrical angle θ. The operation signal generator 285 then generates switch operation signals for the upper and lower arms in each phase by PWM control. The PWM control is based on magnitude comparison between a signal obtained by normalizing three-phase command voltages thus calculated with a power supply voltage, and a carrier signal such as a triangle wave signal. The switch operation signal generated by the operation signal generator 285 is output to the driver circuit 263 of the inverter 260. The driver circuit 263 turns on and off the switches 261 and 262 of the respective phases.

The operation signal generator 285 may alternatively generate the switch operation signal on the basis of: the pulse pattern information that is map information associating the voltage amplitude command, the voltage phase command, the electrical angle θ, and the switch operation signal with one another; the voltage amplitude command; the voltage phase command; and the electrical angle θ.

### Modification

Hereinafter, modifications of the above-described first embodiment will be described.

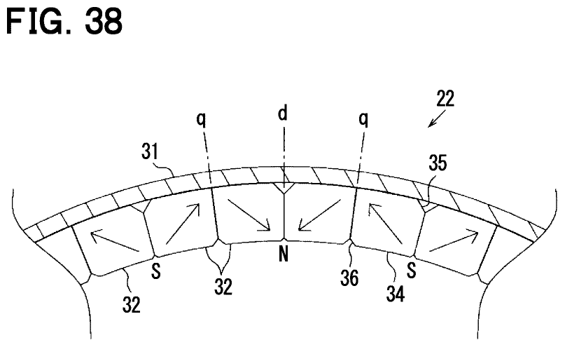

The configuration of the magnet 32 in the magnet unit 22 may be modified as follows. In the magnet unit 22 illustrated in FIG. 38, the direction of the easy axis of magnetization is oblique to the radial direction in the magnet 32, and a linear magnetic path is formed along the direction of the easy axis of magnetization. That is, the magnet 32 is linearly oriented as follows. Between a magnetic flux acting surface 34a on the stator 60 side (inner side in the radial direction) and a magnetic flux acting surface 34b on the opposite side to the stator (outer side in the radial direction), the direction of the easy axis of magnetization is oblique to the d-axis. At the same time, the easy axis of magnetization approaches the d-axis on the stator 60 side and separates from the d-axis on the opposite side to the stator in the circumferential direction. Also in this configuration, the length of the magnetic path of the magnet 32 can be made greater than the thickness dimension in the radial direction, and thus the permeance can be improved.

A Halbach array magnet can be used in the magnet unit 22.

In each winding segment 151, the direction of bending of a link portion 153 may be either inward or outward in the radial direction. A relationship between the direction of bending and the core assembly CA may be such that the first link portion 153A is bent toward the core assembly CA, or the first link portion 153A is bent toward the opposite side of the core assembly CA. In addition, the second link portion 153B may be bent either inward or outward in the radial direction as long as the second link portion 153B crosses over part of the first link portion 153A in the circumferential direction, on the outer side of the first link portion 153A in the axial direction.

The winding segments 151 may not include the two types of winding segments 151 (the first winding segment 151A and the second winding segment 151B), but may include one type of winding segment 151. Specifically, the winding segment 151 is preferably formed to have a substantially L shape or a substantially Z shape in a side view. When the winding segment 151 is formed in a substantially L shape in a side view, the link portion 153 is bent either inward or outward in the radial direction on one end side in the axial direction, and the link portion 153 is provided without being bent in the radial direction on the other end side in the axial direction. When the winding segment 151 is formed in a substantially Z shape in a side view, the link portion 153 is bent in directions opposite to each other in the radial direction on one end side in the axial direction and the other end side in the axial direction. In any case, the coil module 150 is preferably fixed to the core assembly CA by the insulating cover covering the link portion 153 as described above.

In the configuration described above, all the winding segments 151 are connected in parallel for each phase winding in the stator winding 61, but this may be modified. For example, all the winding segments 151 for each phase winding may be divided into a plurality of parallel connection groups, and the plurality of parallel connection groups may be connected in series. Specifically, all n winding segments 151 in each phase winding may be divided into two sets of parallel connection groups each including n/2 winding segments 151, three sets of parallel connection groups each including n/3 winding segments 151, or the like, and then those divided parallel connection groups may be connected in series. Alternatively, all of the plurality of winding segments 151 may be connected in series for each phase winding in the stator winding 61.

The stator winding 61 in the rotary electric machine 10 may include two-phase windings (U-phase winding and V-phase winding). In this case, with regard to the winding segment 151 for example, the pair of intermediate conductor portions 152 are separated at one coil pitch. One intermediate conductor portion 152 for the winding segment 151 of another phase is disposed between the pair of intermediate conductor portions 152.

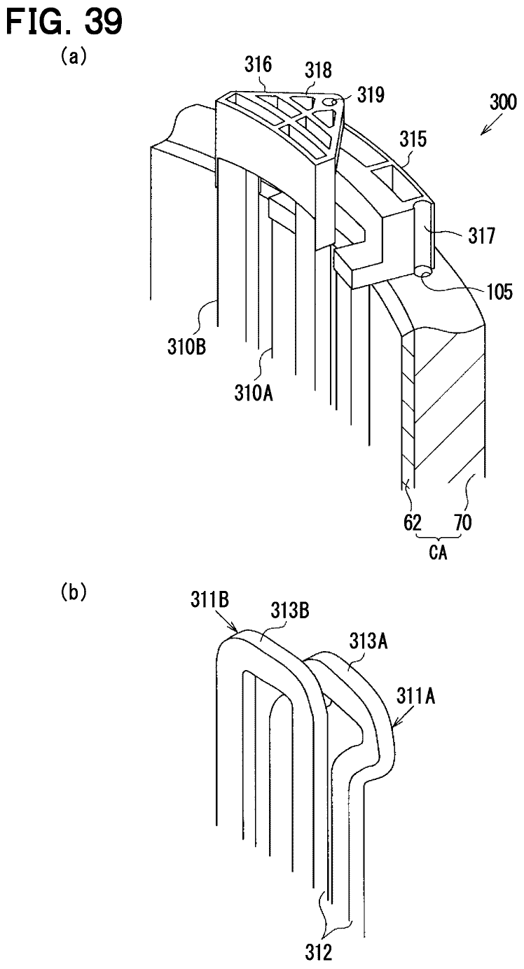

The rotary electric machine 10 can be embodied as an inner rotor type surface permanent magnetic rotary electric machine instead of the outer rotor type surface permanent magnetic rotary electric machine. (a) and (b) of FIG. 39 is a view illustrating a configuration of a stator unit 300 when employing an inner rotor structure. Of FIG. 39, (a) in FIG. 39 is a perspective view illustrating a state where coil modules 310A and 310B are assembled to the core assembly CA, and (b) in FIG. 39 is a perspective view illustrating winding segments 311A and 311B included in the coil modules 310A and 310B. In this example, the stator holder 70 is assembled to the outer side of the stator core 62 in the radial direction to form the core assembly CA. In addition, a plurality of the coil modules 310A and 310B are assembled to the inner side of the stator core 62 in the radial direction.

The winding segment 311A has a configuration substantially the same as or similar to that of the first winding segment 151A described above. The winding segment 311A includes a pair of intermediate conductor portions 312 and a link portion 313A formed to be bent to the core assembly CA side on both sides in the axial direction (outer side in the radial direction). The winding segment 311B has a configuration substantially the same as or similar to that of the second winding segment 151B described above. The winding segment 311B includes the pair of intermediate conductor portions 312 and a link portion 313B provided so as to cross over the link portion 313A in the circumferential direction on the outer side in the axial direction, on both sides in the axial direction. An insulating cover 315 is mounted to the link portion 313A of the winding segment 311A, and an insulating cover 316 is mounted to the link portion 313B of the winding segment 311B.

The insulating cover 315 includes semicircular recesses 317 extending in the axial direction at side surface portions on both sides in the circumferential direction. The insulating cover 316 includes a protrusion 318 protruding outward in the radial direction from the link portion 313B. A through-hole 319 extending in the axial direction is provided at an extending end of the protrusion 318.

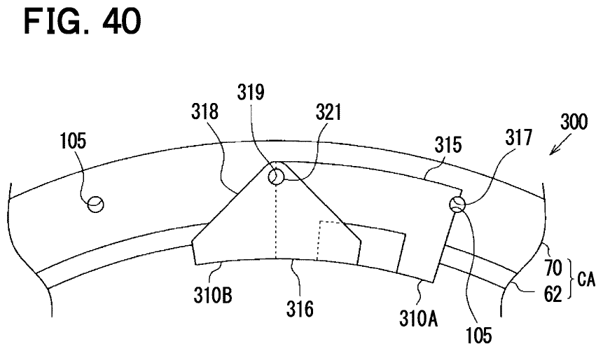

FIG. 40 is a plan view illustrating a state where the coil modules 310A and 310B are assembled to the core assembly CA. In FIG. 40, a plurality of recesses 105 are formed at equal intervals in the circumferential direction at the end surface of the stator holder 70 in the axial direction. The stator holder 70 has a cooling structure utilizing liquid coolant or air. As an air cooling structure, for example, a plurality of heat dissipation fins are preferably formed on the outer peripheral surface.

In FIG. 40, the insulating covers 315 and 316 are disposed to overlap each other in the axial direction. In addition, the recess 317 and the through-hole 319 are connected in the axial direction. The recess 317 is provided at the side surface portion of the insulating cover 315. The through-hole 319 is provided at the central position between one end and the other end in the circumferential direction of the insulating cover 316, in the protrusion 318 of the insulating cover 316. These parts are fixed with fastening pins 321.

In FIG. 40, the fixed position of each of the insulating covers 315 and 316 by the fastening pin 321 is the end surface of the stator holder 70 in the axial direction further on the outer side than the stator core 62 in the radial direction, and the stator holder 70 is fixed with the fastening pin 321. In this case, since the stator holder 70 includes the cooling structure, the heat generated in the winding segments 311A and 311B is easily transferred to the stator holder 70. With this configuration, the cooling performance of the stator winding 61 can be improved.

The stator 60 used in the rotary electric machine 10 may have a protrusion (e.g., tooth) extending from the back yoke. Also in this case, the coil module 150 and the like are only required to be assembled to the back yoke of the stator core.

The rotary electric machine is not limited to a star connection, and may be a A connection.

As the rotary electric machine 10, instead of a revolving-field type rotary electric machine in which a field element is a rotor and an armature is a stator, a revolving armature type rotary electric machine in which an armature is a rotor and a field element is a stator can also be adopted.

### Second Embodiment

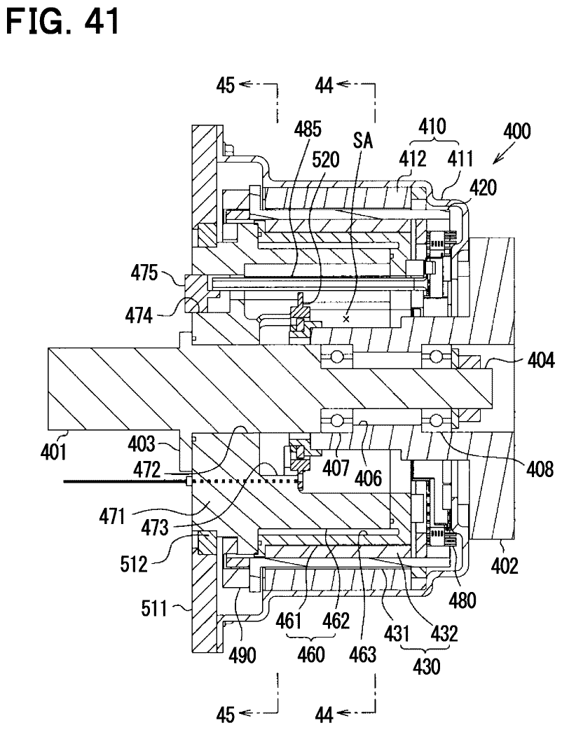

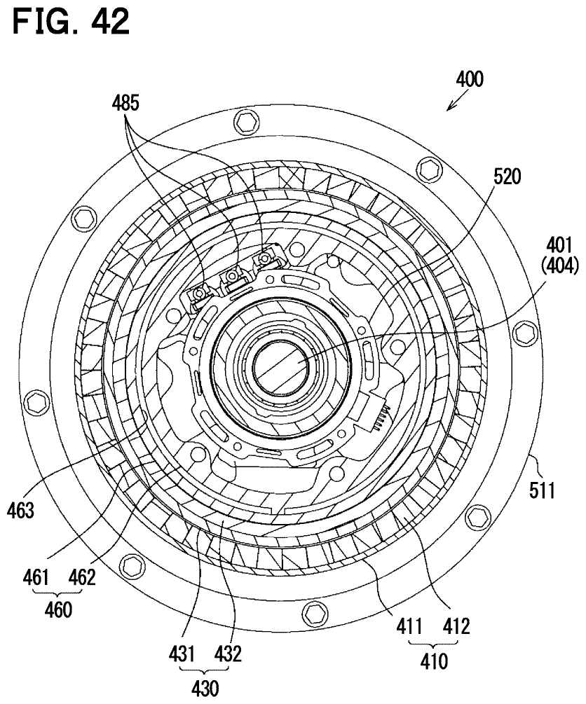

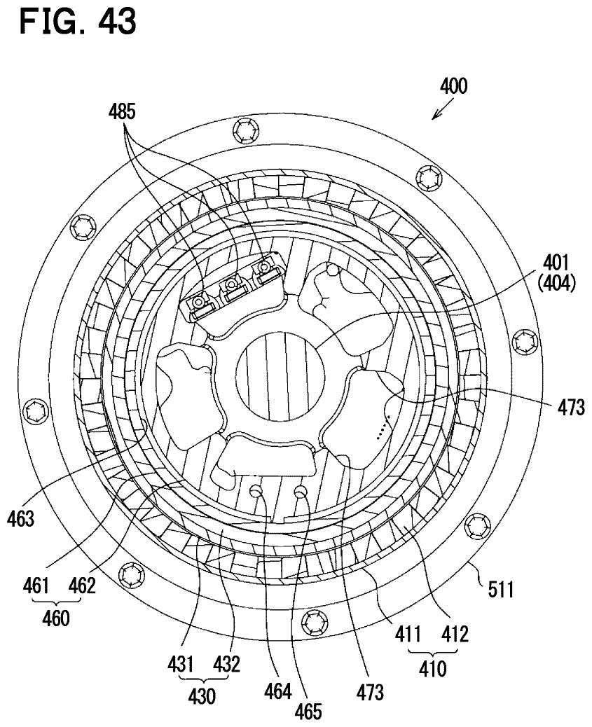

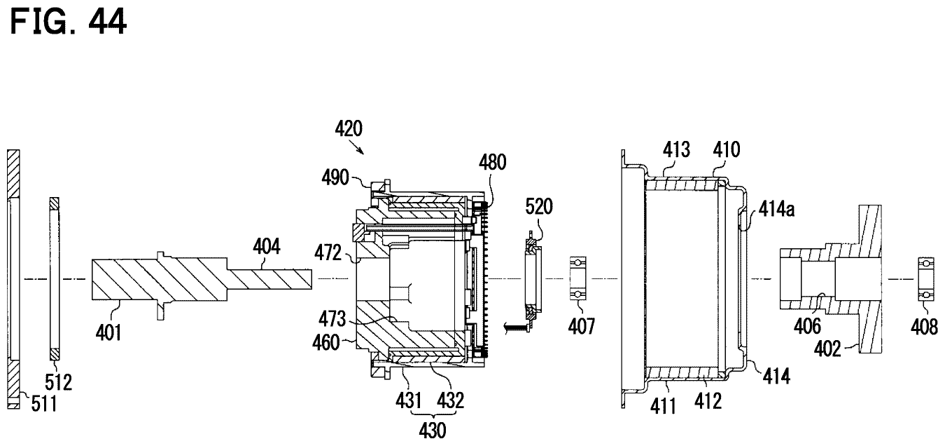

Next, a rotary electric machine 400 according to a second embodiment will be described. The rotary electric machine 400 according to the present embodiment is used as an in-wheel motor of a vehicle. An outline of the rotary electric machine 400 is illustrated in FIGS. 41 to 44. FIG. 41 is a longitudinal sectional view of the rotary electric machine 400. FIG. 42 is a transverse sectional view of the rotary electric machine 400 (a sectional view taken along line 44-44 in FIG. 41). FIG. 43 is a transverse sectional view of the rotary electric machine 400 (a sectional view taken along line 45-45 in FIG. 41). FIG. 44 is an exploded sectional view illustrating components of the rotary electric machine 400 in an exploded manner.

The rotary electric machine 400 is an outer rotor type surface permanent magnetic rotary electric machine. In the broad classification, the rotary electric machine 400 includes a rotary electric machine body including a rotor 410 and a stator unit 420 including a stator 430. The rotary electric machine 400 has a configuration in which a spindle 401 fixed to a vehicle body (not illustrated) and a hub 402 fixed to a wheel (not illustrated) are integrated with the rotary electric machine body. The spindle 401 and the hub 402 are required to have high strength, and are made of, for example, a steel material.

The spindle 401 includes a flange 403 and a stationary shaft 404. The flange 403 extends in a direction orthogonal to the axial direction. The stationary shaft 404 has a columnar shape, extends toward the center of the rotary electric machine from the flange 403, and is inserted through a hollow portion of the stator unit 420. The stationary shaft 404 preferably includes a large diameter portion and a small diameter portion as illustrated in the drawing. The hub 402 includes an insertion hole 406 through which the stationary shaft 404 is inserted. The hub 402 is rotatably supported by the pair of bearings 407 and 408 while the stationary shaft 404 is inserted through the insertion hole 406 of the hub 402. The hub 402 is rotatably supported by the bearings 407 and 408 at two positions in the axial direction. The bearings 407 and 408 are, for example, radial ball bearings and each has an outer race, an inner race, and a plurality of balls disposed therebetween. The bearings 407 and 408 may be roller bearing (needle roller bearing, tapered roller bearing) using rollers as rolling elements instead of balls.

In the rotary electric machine 400, the axial direction thereof is the direction in which the axis, serving as a rotation center, extends (a left-right direction in FIG. 41). The rotary electric machine 400 is attached to the vehicle such that the axial direction of the rotary electric machine 10 becomes a horizontal direction or a substantially horizontal direction. When the wheels have a camber angle, the axial direction of the rotary electric machine 400 is preferably directed along the substantially horizontal direction while inclination corresponding to the camber angle is applied.

In the rotary electric machine 400, the rotor 410 and the stator 430 are arranged to face each other in the radial direction with an air gap therebetween. The fixed piece unit 420 is fixed to the spindle 401, and the rotor 410 is fixed to the hub 402. Therefore, the hub 402 and the rotor 410 are rotatable with respect to the spindle 401 and the stator unit 420.

As illustrated in FIG. 44, the rotor 410 includes a substantially cylindrical rotor carrier 411 and an annular magnet unit 412 fixed to the rotor carrier 411. The rotor carrier 411 includes a cylindrical portion 413 having a cylindrical shape and an end plate portion 414 provided on one end side in the axial direction of the cylindrical portion 413. The magnet unit 412 is fixed to the inner side of the cylindrical portion 413 in the radial direction to have an annular shape. The other end side of the rotor carrier 411 in the axial direction is open. The rotor carrier 411 serves as a magnet retainer. A through-hole 414a is formed in the central portion of the end plate portion 414. The hub 402 is fixed to the end plate portion 414 by using a fixing tool such as a bolt while the hub 402 is inserted through the through-hole 414a (see FIG. 41).

The magnet unit 412 includes a plurality of permanent magnets disposed such that the polarities are alternately changed along the circumferential direction of the rotor 410. The magnet unit 412 corresponds to a “magnet unit”. With this configuration, the magnet unit 412 has a plurality of magnetic poles in the circumferential direction. The magnet unit 412 has, for example, the configuration described as the magnet unit 22 according to the first embodiment in FIGS. 6 and 7. For the permanent magnet, a sintered neodymium magnet having an intrinsic coercive force of 400 [kA/m] or more and the remanent flux density Br of 1.0 [T] or more is used. Similarly to the magnet unit 22 in FIG. 7, the magnet unit 412 includes a plurality of polar anisotropic permanent magnets. In each magnet, the directions of the easy axis of magnetization differ between the d-axis side (portion closer to the d-axis) and the q-axis side (portion closer to the q-axis). The direction of the easy axis of magnetization on the d-axis side is parallel or nearly parallel to the d-axis, whereas the direction of the easy axis of magnetization on the q-axis side is orthogonal or nearly orthogonal to the q-axis. In this case, a magnet magnetic path is formed in an arc shape along the directions of the easy axes of magnetization. In short, each magnet is oriented such that the direction of the easy axis of magnetization is nearly parallel to the d-axis serving as the center of the magnetic pole on the d-axis side as compared with that on the side of q-axis serving as the boundary of the magnetic pole.

Note that each magnet of the magnet unit 412 is preferably fixed to each other by adhesion or the like in the circumferential direction, and a fixing member such as a yarn is preferably attached, thereby being integrated each other at the outer peripheral portion. An annular end plate member is preferably attached to an end of each magnet in the axial direction.

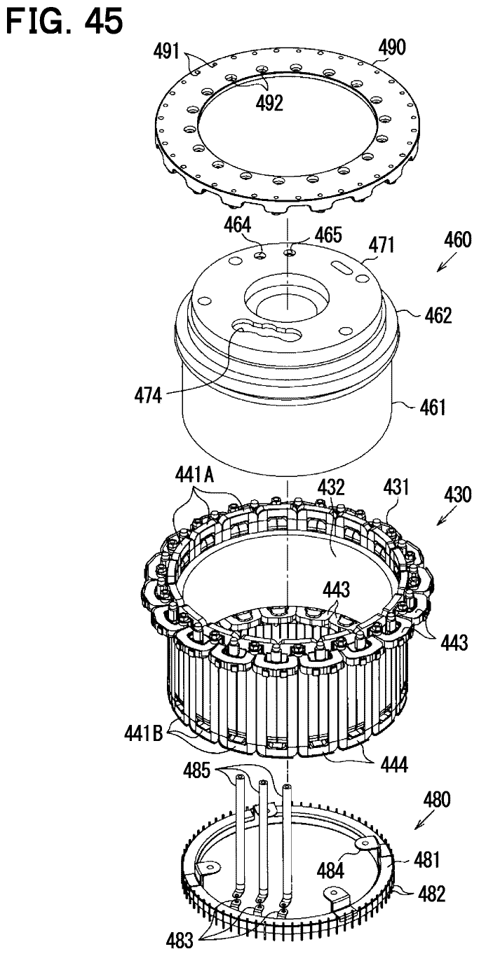

Next, a configuration of the fixed piece unit 420 will be described. FIG. 45 is an exploded perspective view of the stator unit 420. The stator unit 420 includes the annular tubular stator 430, a stator holder 460 that holds the stator 430, a wiring module 480 attached to one end side in the axial direction, and a coil end cover 490 attached to the other end side in the axial direction of the stator 430.

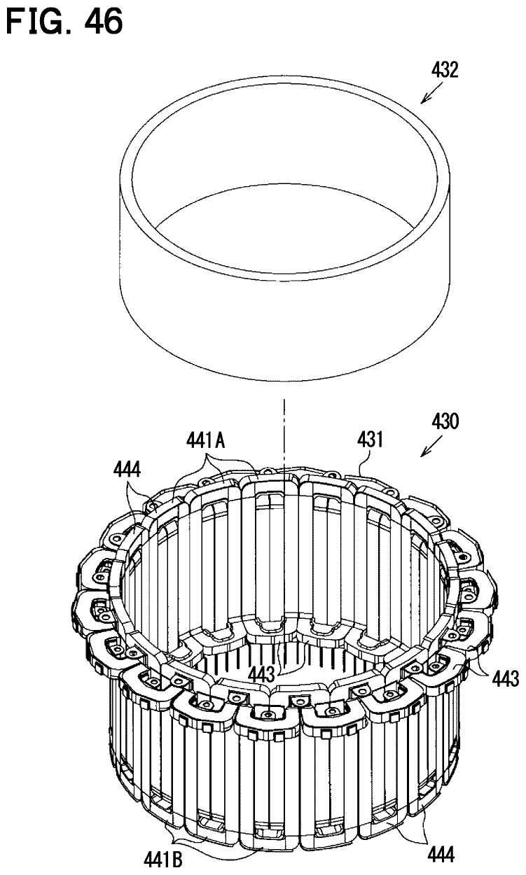

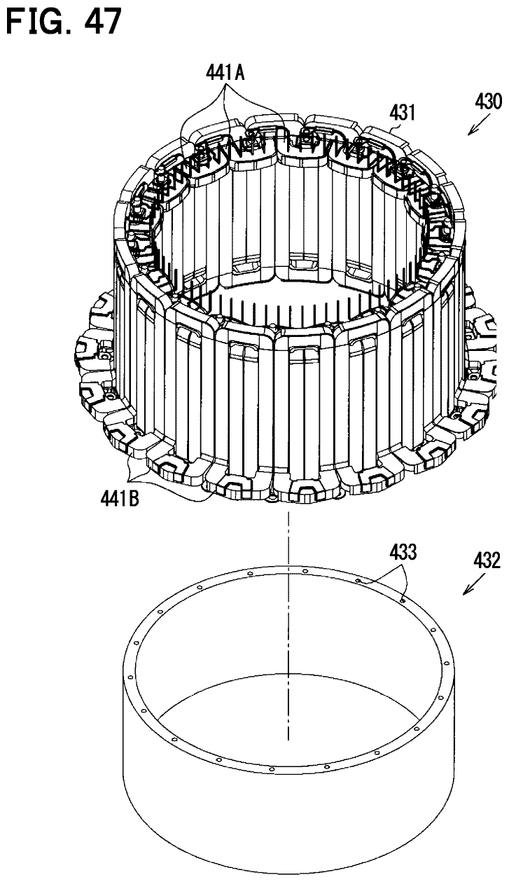

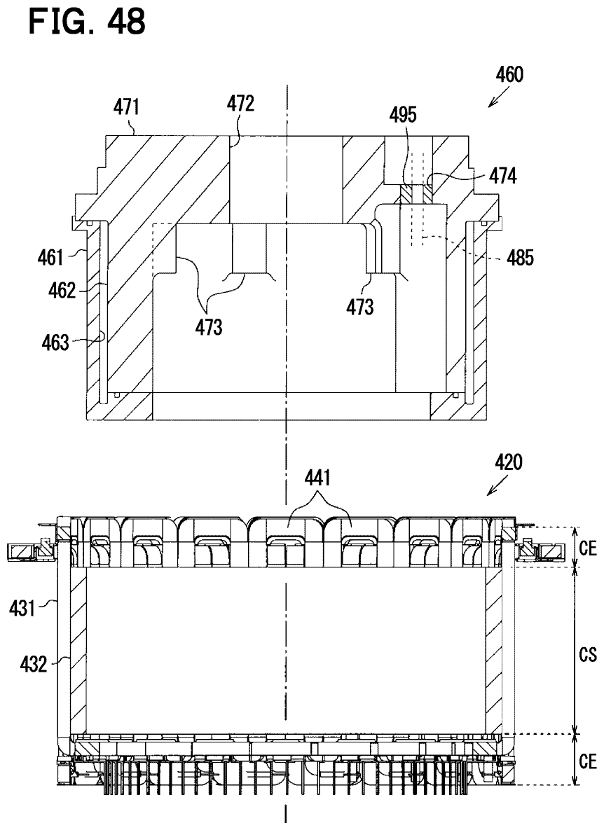

First, the stator 430 will now be described. FIGS. 46 and 47 are exploded perspective views of the stator 430, and FIG. 48 is an exploded sectional view of the stator unit 420. FIGS. 46 and 47 are exploded perspective views of the stator 430 viewed from different directions in the axial direction.

The stator 430 includes a stator winding 431 as an armature winding and a stator core 432 as a winding support member. In the stator 430, the stator winding 431 includes three phase windings 431U, 431V, and 431W, and each of the phase windings 431U, 431V, and 431W is composed of a plurality of partial windings 441. The winding segments 441 are provided in accordance with the number of poles of the rotary electric machine 400, and the plurality of winding segments 441 are connected in parallel or in series for each phase (details will be described later). In the present embodiment, the number of magnetic poles is 24, but the number of magnetic poles may be set to an appropriate number.

As illustrated in FIG. 48, the stator 430 includes, in the axial direction, a portion corresponding to the coil side CS facing the stator core 432 in the radial direction, and a portion corresponding to the coil end CE that is the outer side of the coil side CS in the axial direction. The coil side CS is also a portion facing the magnet unit 412 of the rotor 410 in the radial direction. The winding segments 441 are assembled to the outer side of the stator core 432 in the radial direction. In this case, the winding segments 441 are assembled in a state where both end portions thereof in the axial direction protrude outward from the stator core 432 in the axial direction (that is, to the coil end CE side).

Each of the winding segments 441 is provided such that one of both ends in the axial direction is bent in the radial direction and the other is not bent in the radial direction. Among the winding segments 441 that is half the number of all the winding segments 441, one end side in the axial direction (lower side in FIG. 46) is a bent side, and is bent inward in the radial direction on the bent side. In the winding segments 441 that is remaining half of all the winding segments 441, the other end side in the axial direction (upper side in FIG. 46) is a bent side, and is bent outward in the radial direction on the bent side. In the following description, among the winding segments 441, the winding segment 441 having the portion bent inward in the radial direction is also referred to as a “first winding segment 441A”, and the winding segment 441 having the portion bent outward in the radial direction is also referred to as a “second winding segment 441B”.

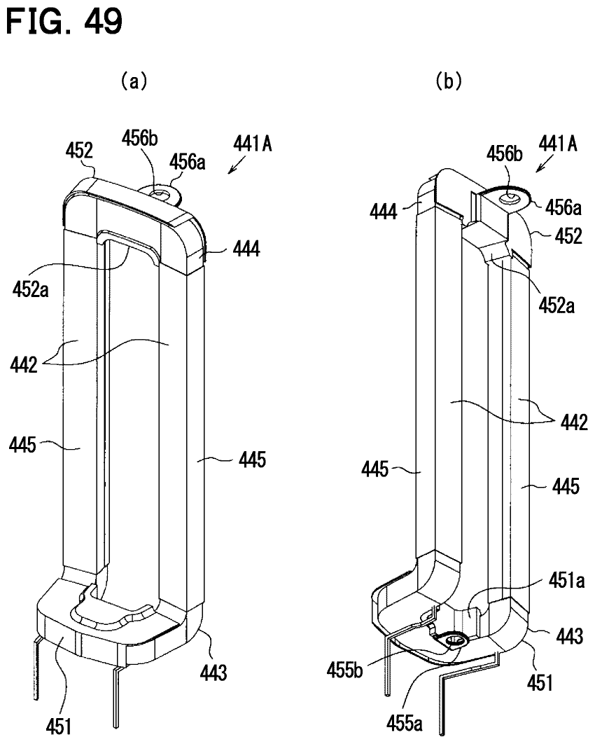

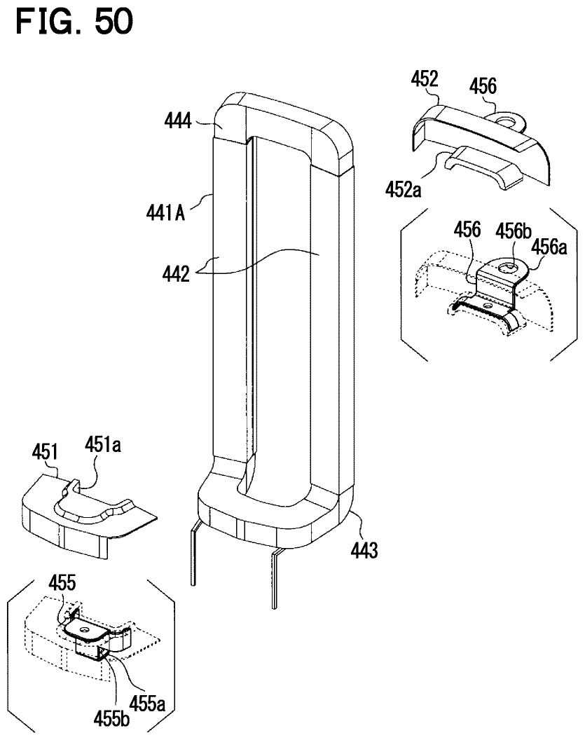

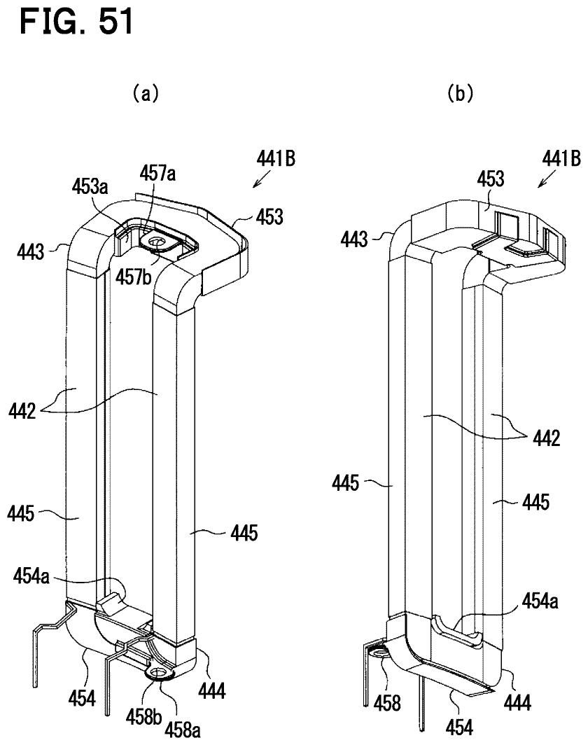

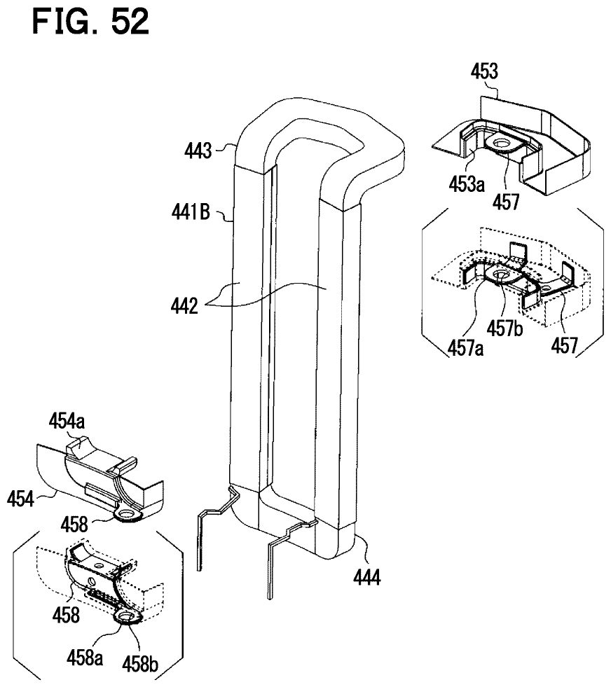

The configuration of the partial windings 441A and 441B will be described in detail. In FIG. 49, (a) and (b) are perspective views illustrating the configuration of the first winding segment 441A. FIG. 50 is an exploded perspective view illustrating insulating covers 451 and 452 respectively attached to link portions 443 and 444 in the first winding segment 441A in an exploded manner. In FIG. 51, (a) and (b) are perspective views illustrating the configuration of the second winding segment 441B. FIG. 52 is an exploded perspective view illustrating insulating covers 453 and 454 respectively attached to the link portions 443 and 444 in the second winding segment 441B in an exploded manner. In FIG. 49, (a) and (b) are perspective views of the first winding segment 441A as viewed from the inner side and the outer side in the radial direction, respectively. Similarly, (a) and (b) of FIG. 51 are similarly perspective views of the second winding segment 441B as viewed from the inner side and the outer side in the radial direction, respectively.

The winding segments 441A and 441B are each formed by multiply winding the conductive wire member CR. The winding segments 441A and 441B each include a pair of intermediate conductor portions 442 and a pair of the link portions 443 and 444. The pair of intermediate conductor portions 442 are provided to be in parallel to each other and have a linear shape. The pair of link portions 443 and 444 connect the pair of intermediate conductor portions 442 at both ends in the axial direction. The winding segments 441A and 441B are formed to have an annular shape by the pair of intermediate conductor portions 442 and the pair of link portions 443 and 444. The pair of intermediate conductor portions 442 are separated at a predetermined coil pitch. The intermediate conductor portions 442 of the winding segments 441 of the other phases can be disposed between the pair of intermediate conductor portions 442 in the circumferential direction. In the present embodiment, the pair of intermediate conductor portions 442 are separated at two coil pitches. One intermediate conductor portion 442 for each of the winding segments 441 of the other two phases is disposed between the pair of intermediate conductor portions 442.

In the winding segments 441A and 441B, each intermediate conductor portion 442 is covered with a sheet-like insulating jacket 445. The configuration of the insulating jacket 445 is same as or similar to that of the insulating jacket 157 of the winding segment 151 according to the first embodiment described above. Specifically, the insulating jacket 445 employs a film member having at least a length of a range of an intermediate conductor portion 442 to be covered with and insulated in the axial direction as an axial dimension. The insulating jacket 445 is provided by winding the film member around the intermediate conductor portion 442. The insulating jacket 445 is provided around the intermediate conductor portion 442 with the ends of the film member in the circumferential direction overlapping each other.

Each of the link portions 443 and 444 on both sides in the axial direction is provided as a portion corresponding to the coil end CE (see FIG. 48). One of the link portions 443 and 444 is bent in the radial direction, and the other of the link portions 443 and 444 is not bent in the radial direction. In this configuration, the winding portions 441A and 441B are substantially L-shaped when viewed from the lateral side.

In the winding segments 441A and 441B, the bending directions of the link portion 443 in the radial direction are different. In the first winding segment 441A, the link portion 443 is bent inward in the radial direction. In the second winding segment 441B, the link portion 443 is bent outward in the radial direction. In this case, assuming that the winding segments 441A and 441B are disposed side by side in the circumferential direction, the shapes of the link portions 443 in the winding segments 441A and 441B in plan view (planar shapes in the radial direction) are preferably different from each other. The width of the link portion 443 of the first winding segment 441A in the circumferential direction preferably decreases toward the extending end side, and the width of the link portion 443 of the second winding segment 441B in the circumferential direction preferably increases toward the extending end side.

In each of the winding segments 441A and 441B, the intermediate conductor portion 442 is provided as a coil side conductor portion arranged one by one in the circumferential direction at the coil side CS. Each of the link portions 443 and 444 is provided as a coil end conductor portion connecting the intermediate conductor portions 442 of the identical phase at two positions different in the circumferential direction at the coil end CE.

Similarly to the winding segment 151 described above, the winding segments 441A and 441B are each formed by multiply winding a conductive wire member such that the transverse section of a bunch of conductive wire members CR is quadrangular. The conductive wire member CR is arranged in a plurality of rows in the circumferential direction and arranged in a plurality of rows in the radial direction, so that the intermediate conductor portion 442 is formed to have a substantially rectangular transverse section (see FIG. 20).

Next, the insulating covers 451 to 454 attached to each of the winding segments 441A and 441B will be described. The insulating covers 451 to 454 are an insulating member provided to ensure insulation between the winding segments 441 at each of the link portions 443 and 444. The insulating covers 451 to 454 are each formed of an insulating material such as synthetic resin.

As illustrated in (a) and (b) of FIG. 49 and in FIG. 50, in the first winding segment 441A, the insulating cover 451 is attached to the link portion 443 on one end side in the axial direction, and the insulating cover 452 is attached to the link portion 444 on the other end side in the axial direction. A bracket 455 made of, for example, a metal plate is embedded in the insulating cover 451. The bracket 455 has a protrusion 455a protruding outward in the radial direction from the extending end of the link portion 443, and a through-hole 455b passing through the protrusion 455a in the axial direction (vertical direction in the drawing) is provided at the protrusion 455a. A bracket 456 made of, for example, a metal plate is embedded in the insulating cover 452. The bracket 456 has a protrusion 456a protruding outward in the radial direction from the extending end of the link portion 444, and a through-hole 456b passing through the protrusion 456a in the axial direction (vertical direction in the drawing) is provided in the protrusion 456a.

The insulating covers 451 and 452 respectively have engagement portions 451a and 452a that respectively engage with the inner side of the curved portion at the extending end of the link portions 443 and 444. Part of the brackets 457 and 458 is preferably integrated with the engagement portions 453a and 454a as a base material. The brackets 455 and 456 may be fixed to the outer surface of the insulating covers 451 and 452 by adhesion or the like in addition to being embedded in the insulating covers 451 and 452.

As illustrated in (a) and (b) of FIG. 51 and in FIG. 52, in the second winding segment 441B, the insulating cover 453 is attached to the link portion 443 on one end side in the axial direction, and the insulating cover 454 is attached to the link portion 444 on the other end side in the axial direction. A bracket 457 made of, for example, a metal plate is embedded in the insulating cover 453. The bracket 457 has a protrusion 457a protruding outward in the radial direction from the extending end of the link portion 443, and a through-hole 457b passing through the protrusion 457a in the axial direction (vertical direction in the drawing) is provided at the protrusion 457a. A bracket 458 made of, for example, a metal plate is embedded in the insulating cover 454. The bracket 458 has a protrusion 458a protruding outward in the radial direction from the extending end of the link portion 444, and a through-hole 458b passing through the protrusion 458a in the axial direction (vertical direction in the drawing) is provided at the protrusion 458a.

The insulating covers 453 and 454 respectively have engagement portions 453a and 454a that respectively engage with the inner side of the curved portion at the extending ends of the link portions 443 and 444. Part of the brackets 457 and 458 is preferably integrated with the engagement portions 453a and 454a as a base material. The brackets 457 and 458 may be fixed to the outer surface of the insulating covers 453 and 454 by adhesion or the like in addition to being embedded in the insulating covers 453 and 454.

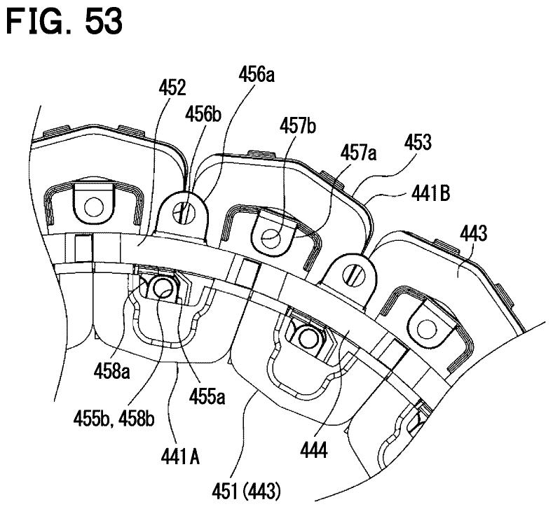

FIG. 53 is a plan view illustrating a state where the winding segments 441A and 441B are disposed side by side in the circumferential direction. FIG. 53 is a plan view of the stator winding 431 illustrated in FIG. 46 as viewed from one side in the axial direction (upper side of the drawing).

In FIG. 53, the link portion 443 of the first winding segment 441A extends inward in the radial direction, and the link portion 443 of the second winding segment 441B extends outward in the radial direction. Further on the inner side of each of the winding segments 441A and 441B in the radial direction than the intermediate conductor portion 442, on one end side in the axial direction of the stator winding 431 (the back side of the paper surface of FIG. 53), the protrusion 455a of the bracket 455 provided on the insulating cover 451 of the first winding segment 441A and the protrusion 458a of the bracket 458 provided on the insulating cover 454 of the second winding segment 441B overlap each other in the axial direction. Furthermore, the positions of the through-holes 455b and 458b of the protrusions 455a and 458a match each other in plan view.

On the other hand, further on the outer side of each of the winding segments 441A and 441B in the radial direction than the intermediate conductor portion 442, on the other end side in the axial direction of the stator winding 431 (the front side of the paper surface of FIG. 53), the protrusion 456a of the bracket 456 provided on the insulating cover 452 of the first winding segment 441A and the protrusion 457a of the bracket 457 provided on the insulating cover 453 of the second winding segment 441B are alternately arranged at equal intervals in the circumferential direction. In this case, the through-holes 456b and 457b of the protrusions 456a and 457a have the same distance from the planar center of the stator 430 in the radial direction and are disposed at equal intervals in the circumferential direction.

As illustrated in FIGS. 46 and 47, the stator winding 431 is formed in an annular shape by the winding segments 441A and 441B, and the stator core 432 is assembled to the inner side thereof in the radial direction. A fixed piece core 42 is formed as a core-sheet laminate body in which core sheets each formed of an electromagnetic steel sheet that is a magnetic body are laminated in the axial direction. The fixed piece core 42 has a cylindrical shape having a predetermined thickness in the radial direction. The inner peripheral surface and the outer peripheral surface of the stator core 432 has a curved surface shape without protrusions and recesses. The stator core 432 functions as a back yoke. The stator core 432 is formed by stacking a plurality of core sheets in the axial direction. The core sheet is punched into, for example, an annular plate shape. However, a stator core having a helical core structure may be used as the stator core 432.

The stator winding 431 may be assembled to the stator core 432 by individually assembling the winding segments 441A and 441B to the stator core 432. Alternatively, after the annular stator winding 431 is formed by the winding segments 441A and 441B, the stator winding 431 may be assembled to the stator core 432.

As illustrated in FIG. 47, a plurality of recesses 433 are formed at predetermined intervals in the circumferential direction on the end surface on one end side in the axial direction of the stator core 432. In a state where the stator winding 431 and the stator core 432 are integrated, the respective through-holes 455b and 458b of the brackets 455 and 458 in the insulating covers 451 and 454 and the recess 433 on the end surface of the stator core 432 in the axial direction are aligned further on the inner side of each of the winding segments 441A and 441B in the radial direction than the intermediate conductor portion 442. The winding segments 441A and 441B are fixed to the stator core 432 by assembling a joining member made of, for example, a metal fastening pin to the through-holes 455b and 458b and the recess 433.

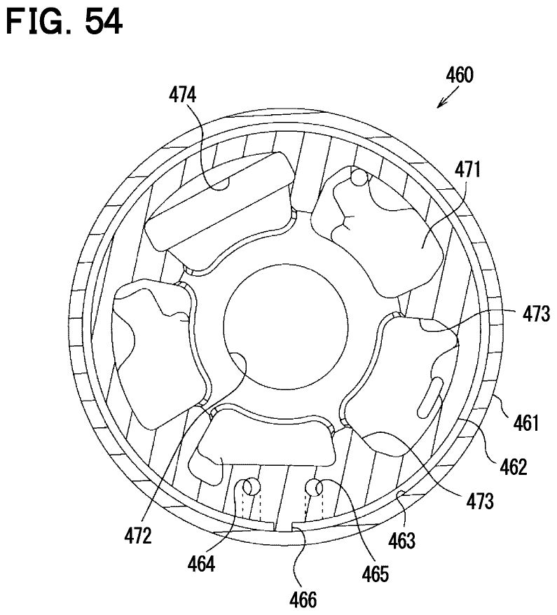

Next, a configuration of the stator holder 460 will be described. Here, the configuration of the stator holder 460 will be described with reference to FIGS. 48 and 54. FIG. 54 is a transverse sectional view of the stator holder 460 (a transverse sectional view at the same position as FIG. 43).

As illustrated in FIGS. 48 and 54, the stator holder 460 includes an outer cylinder member 461 and an inner cylinder member 462, both of which have a cylindrical shape. The outer cylinder member 461 is disposed on the outer side in the radial direction, and the inner cylinder member 462 is disposed on the inner side in the radial direction, and they are integrally assembled to form the stator holder 460. Each of these members 461 and 462 is formed of, for example, metal such as aluminum or cast iron, or carbon fiber reinforced plastic (CFRP).

An inner diameter dimension of the cylindrical part of the outer cylinder member 461 is greater than an outer diameter dimension of the cylindrical part of the inner cylinder member 462. Therefore, in a state where the inner cylinder member 462 is assembled to the inner side of the outer cylinder member 461 in the radial direction, an annular gap is formed between these members 461 and 462. The gap space serves as a coolant path 463 through which a coolant such as cooling water flows. The coolant path 463 is provided to have an annular shape in the circumferential direction of the stator holder 460. The inner cylinder member 462 includes an inlet path 464 serving as an inlet of the coolant and an outlet path 465 serving as an outlet of the coolant. A partition 466 is provided between the inlet path 464 and the outlet path 465 in the coolant path 463. The inlet path 464 and the outlet path 465 communicate with the coolant path 463 on both sides with the partition 466 interposed therebetween, and are provided so as to extend in the axial direction. A coolant flowing in from the inlet path 464 to flow in the coolant path 463 in the circumferential direction, and then flow out from the outlet path 465.

One end of each of the inlet path 464 and the outlet path 465 is open to the end surface of the inner cylinder member 462 in the axial direction. On the end surface in the axial direction, although not illustrated, an inlet pipe port is provided in the opening of the inlet path 464, and an outlet pipe is provided in the opening of the outlet path 465. A circulation path for circulating the coolant is connected to the inlet pipe port and the outlet pipe port. The circulation path includes, for example, an electric pump and a heat dissipation device such as a radiator. The coolant circulates through the circulation path and the coolant path 463 of the rotary electric machine 400 due to the driving of the pump.

The stator core 432 is assembled to the outer side of the stator holder 460 in the radial direction, more specifically, to the outer side of the outer cylinder member 461 in the radial direction. The stator core 432 is assembled with respect to the stator holder 460 (outer cylinder member 461) by, for example, adhesion. Alternatively, the stator core 432 may be fitted and fixed to the stator holder 460 with a predetermined interference by shrink-fitting or press-fitting.

The inner cylinder member 462 has a cylindrical shape and has an end plate portion 471 on one end side in the axial direction. A through-hole 472 penetrating in the axial direction is provided at the center of the end plate portion 471, and the stationary shaft 404 of the spindle 401 can be inserted into the through-hole 472.

A plurality of protrusions 473 are provided at predetermined intervals in the circumferential direction on the inner peripheral side of the inner cylinder member 462. Each of these protrusions 473 is provided so as to protrude inward in the radial direction in the hollow portion of the inner cylinder member 462, and is provided in a range from the end plate portion 471 to the intermediate position in the axial direction (see FIG. 48). The protrusion 473 functions as a reinforcing member of the inner cylinder member 462.

The end plate portion 471 of the inner cylinder member 462 includes an opening 474 passing therethrough in the axial direction at a position on the outer side of the through-hole 472 in the radial direction. The opening 474 is an insertion hole portion through which a power line 485 of each phase to be described later is inserted in the axial direction. The opening 474 includes a terminal block 475 (see FIG. 41), and an external wiring (not illustrated) is connected to the terminal block 475.

Next, the wiring module 480 will be described. The wiring module 480 is a winding connection member electrically connected to the winding segments 441A and 441B in the stator winding 431. Through the wiring module 480, the winding segments 441 of respective phases are connected in parallel or in series for each phase and the phase windings 431U, 431V, and 431W of respective phases are connected to a neutral point. As illustrated in FIG. 41, the wiring module 480 is provided on one end side among both ends of the stator 430 in the axial direction, specifically, on the end plate portion 414 side of the rotor carrier 411.

More specifically, the stator winding 431 includes the first winding segment 441A and the second winding segment 441B. One end side of the first winding segment 441A in the axial direction is bent inward in the radial direction. The other end side of the second winding segment 441B in the axial direction is bent outward in the radial direction. The bent side of the first winding segment 441A and the non-bent side of the second winding segment 441B are directed to the end plate portion 414 side of the rotor carrier 411, and the winding segments 441A and 441B are disposed side by side while partially overlapping each other in the circumferential direction. The wiring module 480 is provided on the end plate portion 414 side of the rotor carrier 411 among both ends of the stator winding 431 in the axial direction.

As illustrated in FIG. 45, the wiring module 480 includes an annular ring 481 having an annular shape, and a plurality of connection terminals 482 provided side by side in the circumferential direction along the annular ring 481. The annular ring 481 is formed to have an annular shape by using, for example, an insulating member such as resin. Wiring for each phase, wiring for a neutral point, and the like (details will be described later) are embedded in the annular ring 481, and the connection terminal 482 is electrically connected to each wiring. The connection terminal 482 is provided for each winding segment 441 and is fixed in a direction extending in the axial direction.

In the wiring module 480, a bus bar 483 is connected to the wiring of each phase embedded in the annular ring 481 for each phase. The bus bars 483 are part of power wiring for U-phase power, V-phase power, and W-phase power, respectively, and are provided in a direction protruding inward in the radial direction.

In the stator winding 431, the link portions 444 that are not bent in the radial direction are disposed in an annular arrangement at the lower end in FIG. 45. The wiring module 480 is provided on the inner side of the link portion 444 in the radial direction. That is, the annular ring 481 of the wiring module 480 is formed to have a diameter smaller than that of the annular ring formed by the link portion 444 arranged in the circumferential direction. The annular ring 481 includes an attaching member 484 for attaching the wiring module 480 to the stator holder 460. The attaching member 484 includes, for example, a metal plate, and has a plurality of attaching portions at predetermined intervals in the circumferential direction.

The power line 485 that supplies power to the stator winding 431 for each phase is connected to each bus bar 483 of the wiring module 480. The power lines 485 are disposed side by side in the circumferential direction and are disposed to extend in the axial direction. Preferably, the conductor itself of the power line 485 is a rigid body such as a metal bus bar, or the conductor of the power line 485 is inserted through a tube that is a rigid body such as a synthetic resin. With this configuration, even if vibration occurs in the rotary electric machine 400, the power line 485 can be made less susceptible to the influence of the vibration. The power line 485 can also include a flexible harness. In this case, the disconnection can be prevented by absorbing the vibration in the rotary electric machine 400.

Preferably, the power line 485 further has a shield layer on the outer periphery. The shield layer can prevent a magnetic field from being generated outside the shield layer. In addition, the outer coated layer of the power line 485 is preferably a fluorine film. In this case, assuming that the temperature of the power line 485 rises, and the heat resistance can be improved.

Next, the coil end cover 490 will be described.

As illustrated in FIG. 45, the coil end cover 490 has an annular shape, and is provided at a coil end portion on one end side of the stator 430 in the axial direction. In other words, the coil end cover 490 is provided at the coil end portion on a side where the link portion 443 is bent outward in the radial direction among the coil end portions at both ends in the axial direction of the stator 430. The coil end portion of the stator winding 431 is covered with the coil end cover 490 in the axial direction. The coil end cover 490 defines the positioning of the winding segments 441A and 441B on the one end side in the axial direction.

The coil end cover 490 includes a plurality of through-holes 491 at equal intervals in the circumferential direction. The plurality of through-holes 491 alternately correspond to the through-hole 456b of the bracket 456 in the insulating cover 452 of the first winding segment 441A and the through-hole 457b of the bracket 457 in the insulating cover 453 of the second winding segment 441B. In this case, the respective through-holes 491 on the coil end cover 490 side are aligned with the through-holes 456b and 457b on the insulating covers 452 and 453 side while the coil end cover 490 is mounted to one end side of the stator 430 in the axial direction. The coil end cover 490 is fixed to the stator 430 by further assembling a joining member made of, for example, a metal fastening pin to each through-hole 491. In such a state, one end side of each of the winding segments 441A and 441B in the axial direction is fixed by the coil end cover 490.

The coil end cover 490 includes a plurality of attachment holes 492 for attaching the coil end cover 490 to the stator holder 460. Assuming a state where the coil end cover 490 is attached to the stator winding 431, the plurality of through-holes 491 arranged in the circumferential direction are disposed further on the outer side in the radial direction than the link portion 444 extending in the axial direction without being bent in the radial direction in the stator winding 431 (i.e., the position of the intermediate conductor portion 442). The plurality of attachment holes 492 similarly arranged in the circumferential direction are disposed further on the inner side in the radial direction than the link portion 444 of the stator winding 431.

In the stator unit 420, the stator winding 431 including the plurality of winding segments 441A and 441B and the stator core 432 are integrated. At this time, on one end side in the axial direction (the lower end side in FIG. 45), the winding segments 441A and 441B are fixed to the stator core 432 using the brackets 455 and 458 of the insulating covers 451 and 454. Furthermore, the stator holder 460 is assembled to the stator 430 including the stator windings 431 and the stator core 432 from one side in the axial direction, and the coil end cover 490 is attached to the stator holder 460. At this time, a fixing tool such as a fastening pin or a screw is inserted into the attachment hole 492 of the coil end cover 490, and the coil end cover 490 is fixed to the stator holder 460. A fixing tool such as a fastening pin or a screw is inserted into the through-hole 491 of the coil end cover 490, and the coil end cover 490 is fixed to the stator winding 431 (each of the winding segments 441A and 441B).

On the opposite side of the coil end cover 490 in the axial direction, the wiring module 480 is attached to the stator holder 460 by the attaching member 484. In this state, in the hollow portion of the stator holder 460 (inner cylinder member 462), the power line 485 of each phase is provided to extend from one end side to the other end side of the stator unit 420 in the axial direction. Each of the power lines 485 is connected to external wiring.

Each power line 485 is preferably clamped with respect to the inner cylinder member 462 (stator holder 460). Specifically, as illustrated in FIG. 48, a clamp member 495 made of anti-vibration rubber is provided in the opening 474 of the inner cylinder member 462, and the power line 485 provided passing through the opening 474 is clamped by the clamp member 495. In this case, each power line 485 is clamped by the inner cylinder member 462, so that the earthquake resistance of each power line 485 can be improved. In particular, the vibration resistance can be further improved by using the anti-vibration rubber as the clamp member 495. The clamping position of the power line 485 in the inner cylinder member 462 may be a position other than the opening 474.

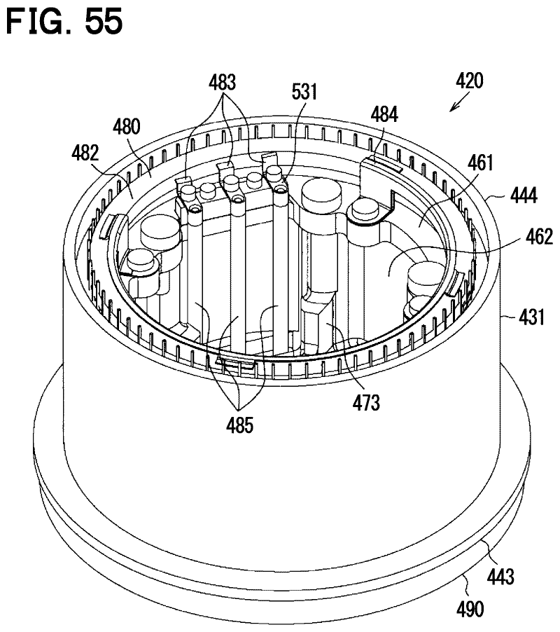

FIG. 55 is a perspective view of the stator unit 420 as viewed from the wiring module 480 side (i.e., the opposite side of the coil end cover 490). In FIG. 55, for convenience, specific illustration of each winding segment 441 in the stator winding 431 is omitted, and the stator winding 431 is illustrated as an integrated cylindrical body.

As illustrated in FIG. 55, in one coil end portion of the stator 430, the wiring module 480 is disposed on the inner side of the stator winding 431 in the radial direction (specifically, on the inner side in the radial direction of each link portion 444 arranged in the circumferential direction). In this case, the upper side of FIG. 55 is the hub 402 side in the axial direction of the rotary electric machine 400, that is, the wheel side. The wiring module 480 is disposed on the hub 402 side in the axial direction, that is, the wheel side. In this configuration, the wiring module 480 is disposed on the inner side of the stator winding 431 in the radial direction at the coil end portion (on the inner side of each link portion 444 in the radial direction). Accordingly, the wiring module 480 does not protrude outward in the radial direction, and the stator unit 420 can be downsized.

In the stator winding 431 according to the present embodiment, the link portion 443 is bent inward in the radial direction at the coil end portion on the hub 402 side. The link portion 443 is bent outward in the radial direction at the coil end on the opposite side of the hub. The wiring module 480 is disposed on the hub 402 side (the side where the link portion 443 is bent inward in the radial direction). In this case, assuming a configuration in which the wiring module 480 is disposed on the opposite side of the hub, the wiring module 480 and the coil end cover 490 are provided so as to protrude toward the outer side of the link portion 444 in the radial direction. Thus, there is a concern that the protrusion extending outward in the radial direction becomes large. However, according to the configuration according to the present embodiment, such inconvenience is eliminated.

A terminal block 531 is provided on an end surface of the stator holder 460 in the axial direction (more specifically, an end surface of the outer cylinder member 461 in the axial direction). The bus bar 483 of the wiring module 480 and the power line 485 are connected via the terminal block 531. Specifically, the terminal portion of the bus bar 483 and the terminal portion of the power line 485 overlap each other, and the bus bar 483 and the power line 485 are fixed to the terminal block 531 by using a fixing tool such as a screw in the overlapping state. In this case, each power line 485 can be securely fixed. That is, simply connecting the bus bar 483 and the power line 485 to each other may cause disconnection at the connection portion due to vibration generated in the rotary electric machine 400. In view of the above, the bus bar 483 and the power line 485 are connected to each other at the terminal block 531 of the stator holder 460 (inner cylinder member 462), disconnection of the connection portion due to vibration can be prevented.

The portion where the bus bar 483 and the power line 485 are connected preferably includes a rotation prevention mechanism for preventing relative rotation of the bus bar 483 and the power line 485. In this way, occurrence of unintended positional shift of the power line 485 with respect to the bus bar 483 can be prevented, and thus ease of assembly and insulation property of the power line 485 can be improved.

The bus bar 483 has a bent structure, and an intermediate portion thereof is bent in a cranked shape. In this way, vibration in the terminal block 531 and the annular ring 481 can be suitably absorbed.

When the stator 430 and the stator holder 460 are assembled, the stator holder 460 and the stator core 432 may be assembled in advance, and the stator winding 431 may be assembled to the integrated object of the stator holder 460 and the stator core 432 (i.e., assembly of the winding segments 441A and 441B).

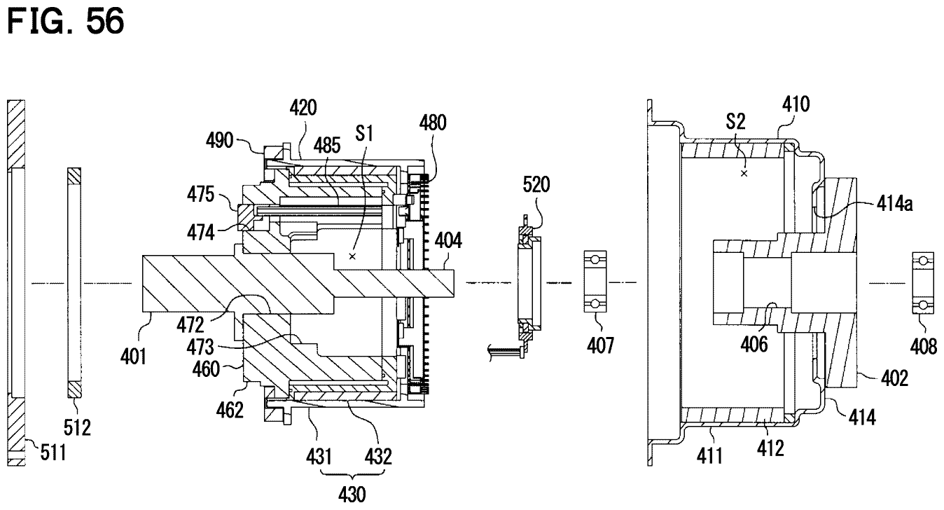

Next, the overall configuration of the rotary electric machine 400 including the rotor 410 and the stator unit 420 described above will be described with reference to FIGS. 41 and 56. FIG. 56 is an exploded sectional view of the rotary electric machine 400 in a state where the spindle 401 and the stator unit 420 are integrated as a stationary object and the hub 402 and the rotor 410 are integrated as a rotary object.

The spindle 401 is assembled to the stator unit 420 while being inserted through the through-hole 472 of the stator holder 460. Specifically, the stationary shaft 404 of the spindle 401 is inserted through the through-hole 472 of the stator holder 460. In this state, the spindle 401 is fixed to the end plate portion 471 of the inner cylinder member 462 by using a fixing tool such as a bolt. On the other hand, the hub 402 is fixed to the rotor 410. Specifically, the hub 402 is inserted through the through-hole 414a of the rotor carrier 411, and in this state, the hub 402 is fixed to the end plate portion 414 by using a fixing tool such as a bolt.

While the stationary shaft 404 of the spindle 401 is inserted through the insertion hole 406 of the hub 402, the stator unit 420 and the rotor 410 are respectively disposed at positions on the inner side and the outer side in the radial direction with respect to each other. Here, as illustrated in FIG. 56, an annular space S1 is formed around the stationary shaft 404 of the spindle 401 in an integrated object of the spindle 401 and the stator unit 420. An annular space S2 is formed around the hub 402 in an integrated object of the hub 402 and the rotor 410. The hub 402 enters the annular space S1 and the stator unit 420 enters the annular space S2, whereby the integrated object of the spindle 401 and the stator unit 420, and the integrated object of the hub 402 and the rotor 410 are assembled to each other.

The bearings 407 and 408 are assembled between the stationary shaft 404 of the spindle 401 and the hub 402, and the hub 402 is rotatably supported by the bearings 407 and 408. That is, the hub 402 and the rotor 410 are rotatably supported with respect to the spindle 401 and the stator unit 420 by using the bearings 407 and 408. In the bearings 407 and 408, the inner race is assembled to the stationary shaft 404 side, and the outer race is assembled to the hub 402 side.

While the integrated object of the spindle 401 and the stator unit 420, and the integrated object of the hub 402 and the rotor 410 are assembled to each other, a rotor cover 511 is fixed to the open end side of the rotor 410, that is, the opposite side of the hub 402 in the axial direction (the opposite side of the end plate portion 414 of the rotor carrier 411). The rotor cover 511 has an annular plate shape. The rotor cover 511 is fixed to the rotor carrier 411 by using a fixing tool such as a bolt, with a bearing 512 interposed between the rotor cover 511 and the inner cylinder member 462.

While the integrated object of the spindle 401 and the stator unit 420, and the integrated object of the hub 402 and the rotor 410 are assembled to each other, an annular closed space SA closed in the axial direction and the radial direction is formed on the inner peripheral side of the stator unit 420. A resolver 520 as a rotation sensor is provided in the closed space SA. The resolver 520 has an annular shape, and includes a resolver stator fixed to the inner cylinder member 462 of the stator unit 420 on the stationary object side, and a resolver rotor fixed to the hub 402 on the rotary object side. The resolver rotor is disposed on the inner side of the resolver stator in the radial direction so as to face the resolver stator.

In the present embodiment, as described above, the plurality of protrusions 473 is provided at predetermined intervals in the circumferential direction on the inner peripheral side of the inner cylinder member 462 in the stator holder 460 (see FIG. 54). The resolver 520 (resolver stator) is attached to the end surface of the protrusion 473 of the inner cylinder member 462 in the axial direction.

Next, a mode of connection of the winding segments 441A and 441B in the stator winding 431 will be described with reference to FIG. 57. As described above, the phase windings 431U, 431V, 431W of each phase (in this embodiment, three phases: U phase, V phase, and W phase) that make up the stator winding 431 are formed by connecting a plurality of partial windings 441. At this time, as illustrated in FIG. 57, the first winding segment 441A and the second winding segment 441B are connected in series to form a series-connected part 600, and the plurality of series-connected parts 600 are further connected in parallel to form the phase windings 431U, 431V, and 431W. The phase windings 431U, 431V, 431W are star-connected at the neutral point to form the stator winding 431.

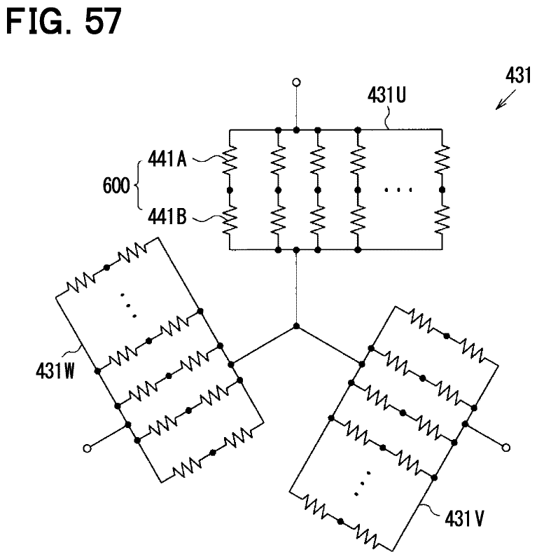

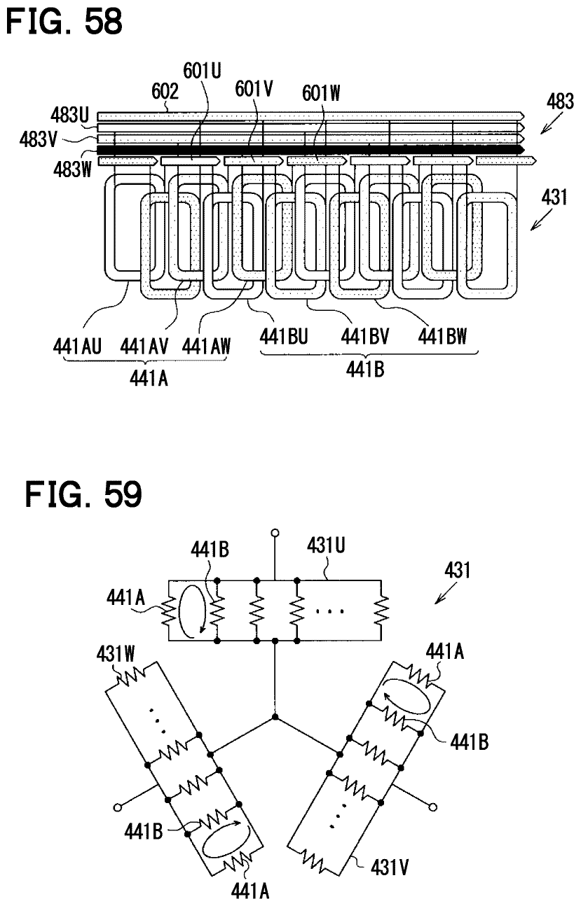

Here, how the winding segments 441 are connected in the wiring module 480 will be described with reference to FIG. 58. FIG. 58 is a developed view in which the circumferential direction of the stator winding 431 and the wiring module 480 is developed in the left-right direction. In FIG. 58, the winding segments 441 are illustrated in two stages of upper and lower stages. The winding segment 441 in the upper stage corresponds to the first winding segment 441A bent inward in the radial direction, and the winding segment 441 in the lower stage corresponds to the second winding segment 441B bent outward in the radial direction. In FIG. 58, the partial windings 441 constituting the U-phase winding 431U are indicated as a first partial winding 441AU and a second partial winding 441BU. Similarly, the partial windings 441 constituting the V-phase winding 431V are respectively indicated as a first partial winding 441AV and a second partial winding 441BV, and the partial windings 441 constituting the W-phase winding 431W are respectively indicated as a first partial winding 441AW and a second partial winding 441BW.

As illustrated in FIG. 58, the second winding segment 441B is disposed at a position separated at about two coil pitches from the first winding segment 441A of the phase identical to that of the second winding segment 441B. Since the configurations are the same as or similar to each other in all phases, only the U-phase winding 431U will be described below.

As shown in FIG. 58, one end of the U-phase first partial winding 441AU is connected to a U-phase wiring 483U embedded in the wiring module 480. More specifically, in FIG. 58, one end on the left side of the U-phase first winding segment 441AU (a portion corresponding to the intermediate conductor portion 442 disposed on one side in the circumferential direction) is connected to the U-phase wiring line 483U via the connection terminal 482.

The other end of the U-phase first winding segment 441AU is connected to one end of a connection wiring line 601U embedded in the wiring module 480. More specifically, in FIG. 58, the other end on the right side of the U-phase first winding segment 441AU (a portion corresponding to the intermediate conductor portion 442 disposed on the other side in the circumferential direction) is connected to the left side of the connection wiring line 601U via the connection terminal 482.

One end of the U-phase second winding segment 441BU disposed at a position separated at two coil pitches from the first winding segment 441AU is connected to the other end of the connection wiring line 601U. More specifically, in FIG. 58, one end on the left side of the U-phase second winding segment 441BU (a portion corresponding to the intermediate conductor portion 442 disposed on one side in the circumferential direction) is connected to the right side of the connection wiring line 601U via the connection terminal 482. As described above, the connection wiring line 601U is configured to have a length of about two coil pitches in the circumferential direction in order to connect between the first winding segment 441AU and the second winding segment 441BU disposed at a position separated at about two coil pitches from the first winding segment 441AU.

As illustrated in FIG. 58, the other end of the U-phase second winding segment 441BU is connected to a neutral wiring line 602 embedded in the wiring module 480. More specifically, in FIG. 58, the other end on the right side of the U-phase second winding segment 441BU (a portion corresponding to the intermediate conductor portion 442 disposed on the other side in the circumferential direction) is connected to the neutral wiring line 602 via the connection terminal 482.

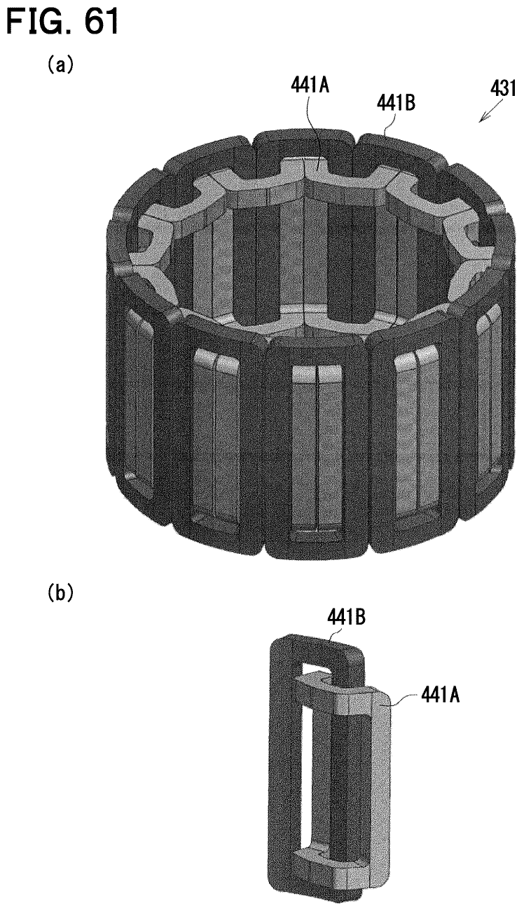

Each of the phase wirings 483U, 483V, 483W, the connection wirings 601U, 601V, 601W and the neutral point wiring 602 is formed in a circular or arc shape and is made of a thin plate-like conductive member. The winding segments 441 constituting the stator windings 431 of the other phases (V-phase, W-phase) are connected in the same or similar manner. Therefore, the connection wiring lines 601U, 601V, and 601W connecting the first winding segment 441A and the second winding segment 441B each have a length of about two coil pitches and do not overlap each other in the circumferential direction. Therefore, as illustrated in FIG. 61, the connection wiring lines 601U, 601V, and 601W are embedded in the wiring module 480 while being disposed side by side in the circumferential direction such that the positions in the axial direction are the same. Accordingly, the height of the wiring module 480 in the axial direction is reduced.

Operation of connecting the winding segments 441 in this manner will be described. As described above, the first winding segment 441A and the second winding segment 441B have different shapes. In particular, each of the winding segments 441A and 441B are disposed side by side in the circumferential direction. Thus, the width of the link portion 443 of the first winding segment 441A in the circumferential direction decreases toward the extending end side, and the width of the link portion 443 of the second winding segment 441B in the circumferential direction increases toward the extending end side. Therefore, the coil resistance is highly likely to be different between the first winding segment 441A and the second winding segment 441B.

Therefore, when the phase winding 431U, 431V, or 431W of each phase is formed by connecting all the winding segments 441 in parallel as in the comparative example of FIG. 59, the following problem occurs. That is, a difference in coil resistance between the first winding segment 441A and the second winding segment 441B may cause a flow of circulating current (denoted by an arrow). In particular, when the stator 430 having the tooth-less or slot-less structure is adopted as in the above-described embodiment, the magnetic flux from the magnet unit 412 directly passes through the stator winding 431, and the magnetic flux passing through the stator winding 431 increases. As a result, the circulating current may increase.

In view of the above, as illustrated in FIG. 57, the first winding segment 441A and the second winding segment 441B, whose shapes are different, i.e., whose coil resistance may be different from each other, are connected in series to form the series-connected part 600. The series-connected parts 600 are connected in parallel to form the phase winding 431U, 431V or 431W of each phase. With this configuration, the coil resistance of each series-connected part 600 connected in parallel can be equalized as a whole, and as a result, the circulating current between the series-connected parts 600 connected in parallel can be reduced.

According to the present embodiment described in detail above, the following excellent effects can be obtained.

As illustrated in FIG. 57, the first winding segment 441A and the second winding segment 441B, both having coil resistance different from each other, are connected in series to form the series-connected part 600. The series-connected parts 600 are connected in parallel to form the phase winding 431U, 431V, or 431W of each phase. With this configuration, the coil resistances between the series-connected parts 600 connected in parallel can be equalized, and the circulating current between the series-connected parts 600 can be reduced. Since the series-connected part 600 can be increased in number of turns as compared with the stator winding 431 of the comparative example illustrated in FIG. 59, series connection enables effective field-weakening control. Since the phase winding 431U, 431V, or 431W of each phase is not formed by connecting all the winding segments 441 in series, eddy-current loss can be reduced.

The first partial winding 441A and the second partial winding 441B have different shapes. Accordingly, the lengths of the conductive wire members CR as the wire constituting the winding segment are made different. With this configuration, the winding segment 441 can be made to have a shape tailored to the arrangement of the winding segments 441, the arrangement space, and the like. As a result, the output can be increased while reducing the size.

The intermediate conductor portions 442 of the winding segments 441 are disposed side by side in the circumferential direction. The link portion 443 on one end side in the axial direction is bent inward in the radial direction to form the first winding segment 441A, and the link portion 443 on the other end side in the axial direction is bent outward in the radial direction to form the second winding segment 441B. With this configuration, the cylindrical members can be assembled to the inner side and the outer side of the intermediate conductor portion 442 in the radial direction by moving the cylindrical members along the axial direction after the winding segments 441 are assembled to form the stator winding 431.

For example, as illustrated in FIG. 46, the stator core 432 can be disposed so as to be in contact with the inner side of the intermediate conductor portion 442 in the radial direction without causing the stator core 432 to interfere with the bent portion of the first winding segment 441A by moving the stator core 432 along the axial direction from above the stator winding 431 in FIG. 46 (from the non-bent portion side of the first winding segment 441A) after the stator winding 431 is assembled.

Similarly, as illustrated in FIG. 45, the stator holder 460 can be disposed so as to be in contact with the inner side of the stator 430 in the radial direction without causing the stator holder 460 to interfere with the bent portion of the first winding segment 441A by moving the stator holder 460 along the axial direction from above the stator 430 in FIG. 45 (from the non-bent portion side of the first winding segment 441A) after the stator 430 is assembled.

Similarly as well, as illustrated in FIG. 44, the rotor carrier 411 can be disposed on the inner side of the stator 430 in the radial direction without causing the rotor carrier 411 to interfere with the bent portion of the second winding segment 441B by moving the rotor carrier 411 along the axial direction from above the stator 430 in FIG. 44 (from the non-bent portion side of the second winding segment 441B) after the stator 430 is assembled. At this time, the bent portion of the second winding segment 441B is disposed outside the rotor carrier 411 as illustrated in FIG. 43, so that the gap between the magnet unit 412 and the intermediate conductor portion 442 can be reduced as much as possible.

As a result, the degree of freedom for the assembly order at the time of manufacturing can be increased, and assembly becomes easy. Further, the rotary electric machine 10 can be downsized.

The connection wiring line 601U, 601V, and 601W connect the first partial winding 441A to the second partial winding 441B that constitutes the same phase and is arranged at a position two coil pitches away. As such, the connection wiring line 601U, 601V, or 601W only needs to have a length corresponding to about two coil pitches. The connection wiring lines having this length can be prevented from overlapping each other in the circumferential direction. Therefore, the dimension of the connection wiring lines 601U, 601V, and 601W in the axial direction can be reduced and the rotary electric machine 10 can be downsized by embedding the connection wiring lines 601U, 601V, and 601W in the wiring module 480 in a state where the connection wiring lines 601U, 601V, and 601W are disposed so as to be arranged in the circumferential direction at positions identical to each other in the axial direction.

As illustrated in FIG. 20, each winding segment 441 is formed by winding the conductive wire member CR a plurality of times. This configuration makes it possible to reduce eddy-current loss.

### Modified Example of Second Embodiment

In the second embodiment described above, the shape and size of the sectional area, the shape, material, thickness, length, and the like of the conductive wire member CR may be made different between the first winding segment 441A and the second winding segment 441B. Furthermore, the number of turns of the conductive wire member CR may be changed between the first winding segment 441A and the second winding segment 441B. The shapes of the coil modules may be the same when the coil resistance thereof is different.

In the second embodiment described above, the configuration of the first winding segment 441A may optionally be modified. For example, the winding segments 441 connected in series or in parallel may serve as the first winding segment 441A. Similarly, the configuration of the second winding segment 441B may optionally be modified. For example, the winding segments 441 connected in series or in parallel may serve as the second winding segment 441B.

In the second embodiment described above, the configurations of the winding segments 441A and 441B of the stator winding 431 may be modified as follows.

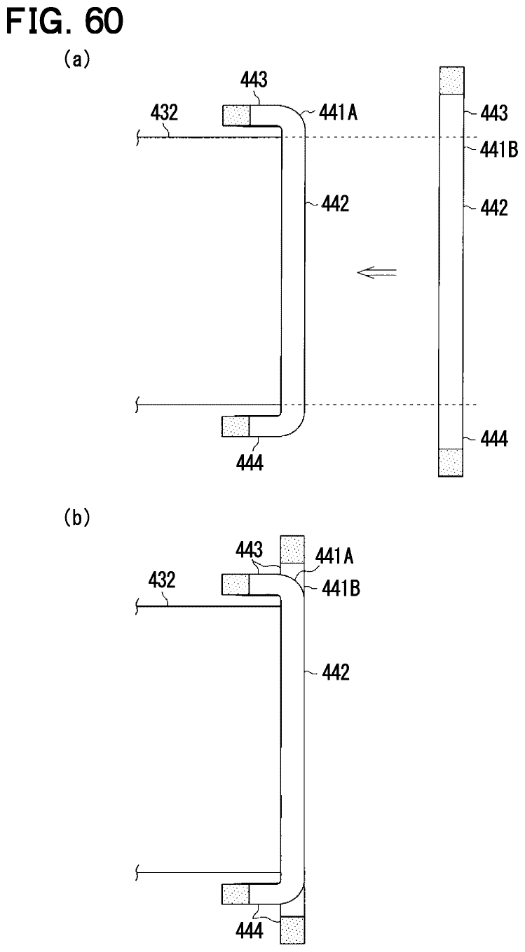

In FIG. 60, (a) and (b) are front views showing an assembling state of the winding segments 441A and 441B to the stator core 432. In FIG. 60, (a) shows the winding segments 441A and 441B in a separated state, and (b) shows the winding segments 441A and 441B in an assembled state.

The winding segments 441A and 441B have different lengths in the axial direction and different shapes of ends on both sides in the axial direction (shapes of link portions). The first winding segment 441A has a substantially C-shape in the side view, and the second winding segment 441B has a substantially I-shape in the side view. In (a) and (b) in FIG. 60, dotted parts indicate the conductor parts at the ends of the link portions of the respective partial windings 441A and 441B. In the state where the winding segments 441A and 441B are assembled, the intermediate conductor portions 442 are arranged in the circumferential direction. The link portions 443 overlap each other in the axial direction, and the link portions 444 overlap each other in the axial direction.

The first winding segment 441A and the second winding segment 441B are different in order of assembly to the stator core 432. The first winding segment 441A having the bent portions at both ends in the axial direction is assembled to the stator core 432 first, and thereafter the second winding segment 441B having no bent portions at both ends in the axial direction is assembled from the outer side in the radial direction.

The first winding segment 441A and the second winding segment 441B are assembled in an annular shape in this manner, whereby the stator winding 431 is formed in an annular shape as illustrated in (a) in FIG. 61. In FIG. 61, (b) is a perspective view showing a state in which the first winding segment 441A and the second winding segment 441B are assembled.

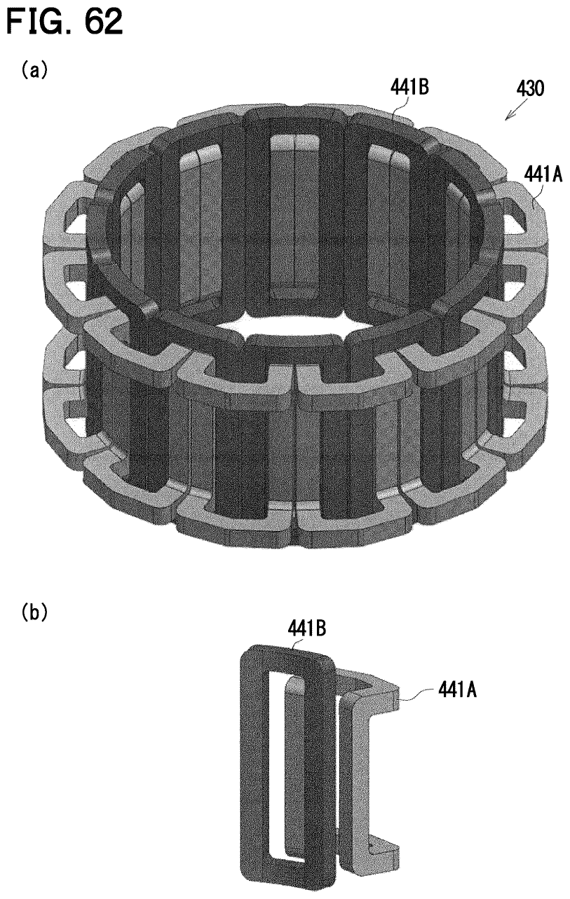

As illustrated in (a) and (b) of FIG. 62, the second winding segment 441B having no bent portions at both ends in the axial direction may be assembled to the stator core 432 first, and thereafter the first winding segment 441A having the bent portions at both ends in the axial direction may be assembled from the outer side in the radial direction.

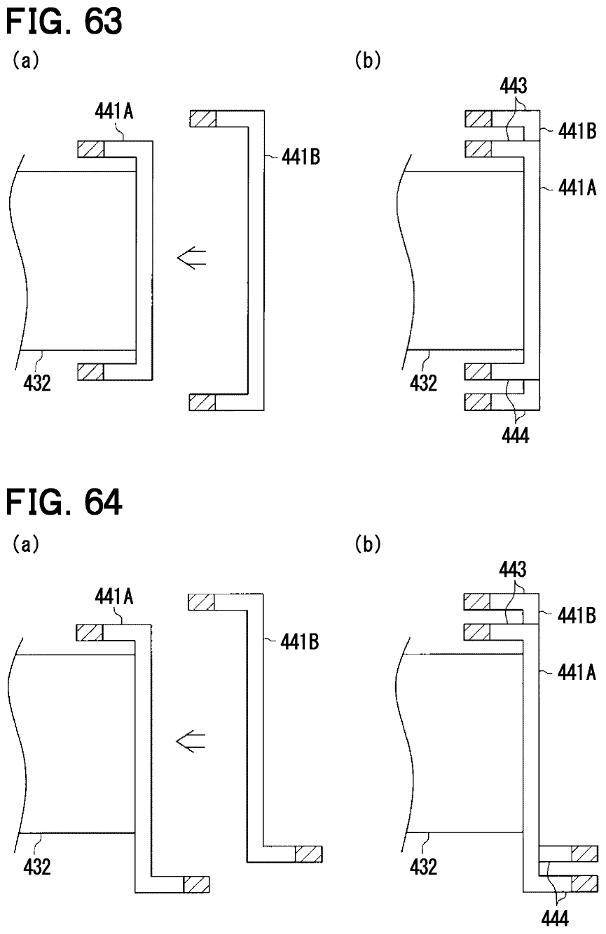

In the configuration illustrated in (a) and (b) of FIG. 63, both the first winding segment 441A and the second winding segment 441B have a substantially C shape in a side view, and lengths in the axial direction (axial lengths) thereof are different from each other. That is, in each of the winding segments 441A and 441B, the link portions 443 and 444 on both sides in the axial direction are formed to be bent toward the stator core 432 (the opposite side of the magnet unit 412) in the radial direction. The axial length of the second winding segment 441B is greater than the axial length of the first winding segment 441A. Thus, on one end side and the other end side in the axial direction, the link portions 443 and 444 of the first winding segment 441A are on the inner side in the axial direction, and the link portions 443 and 444 of the second winding segment 441B are on the outer side in the axial direction. Then, the second winding segment 441B is assembled from the outer side in the radial direction in a state where the first winding segment 441A is pre-assembled to the stator core 432.

In the configuration shown in (a) and (b) of FIG. 64, both the first partial winding 441A and the second partial winding 441B are substantially Z-shaped when viewed from the lateral side. That is, in each of the winding segments 441A and 441B, the link portions 443 and 444 on both sides in the axial direction are formed to be bent toward sides opposite to each other in the radial direction. The winding segments 441A and 441B have the same shape in a side view and are assembled to the stator core 432 in a state where assembling positions in the axial direction are shifted from each other. The second winding segment 441B is assembled from the outer side in the radial direction in a state where the first winding segment 441A is pre-assembled to the stator core 432.

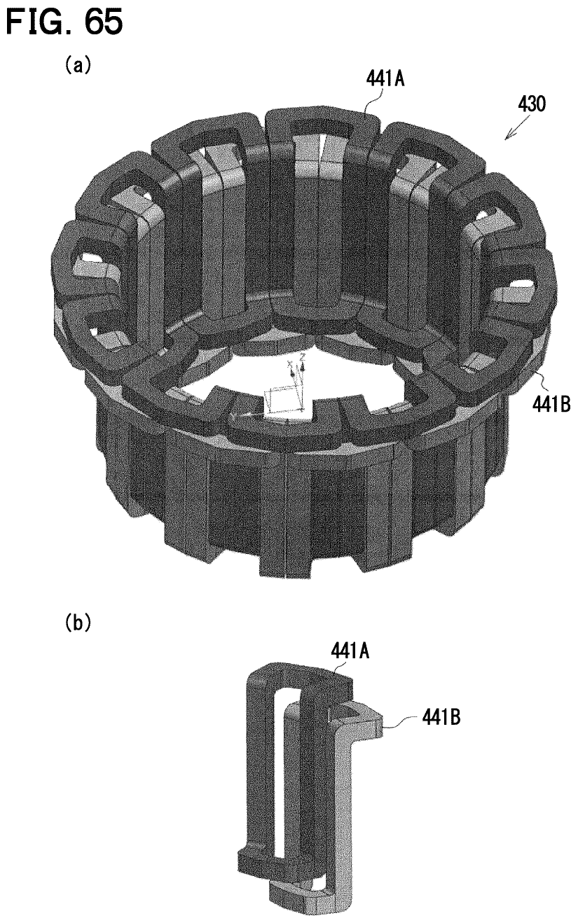

The first winding segment 441A and the second winding segment 441B are assembled in an annular shape in this manner, whereby the stator winding 431 is formed in an annular shape as illustrated in (a) in FIG. 65. In FIG. 65, (b) is a perspective view showing a state in which the first winding segment 441A and the second winding segment 441B are assembled.

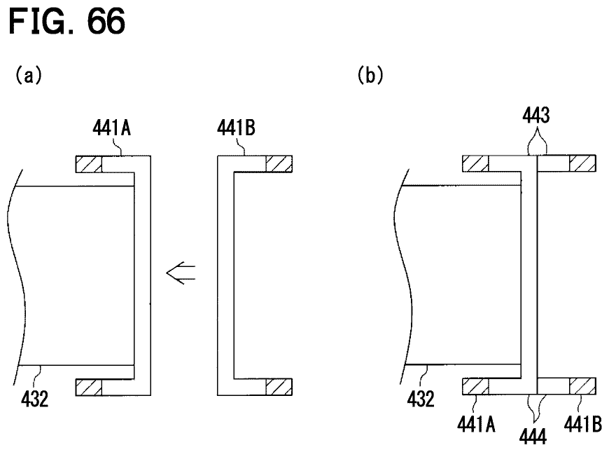

In the configuration illustrated in (a) and (b) of FIG. 66, the first winding segment 441A and the second winding segment 441B both have a substantially C shape in a side view and are assembled in directions opposite to each other in the radial direction. That is, in the first winding segment 441A, the link portions 443 and 444 on both sides in the axial direction are bent toward the stator core 432, and in the second winding segment 441B, the link portions 443 and 444 on both sides in the axial direction are bent toward the opposite side of the stator core 432. Then, the second winding segment 441B is assembled from the outer side in the radial direction in a state where the first winding segment 441A is pre-assembled to the stator core 432. In the configuration of FIG. 66, the link portions 443 and 444 of the first winding segment 441A respectively overlap the link portions 443 and 444 of the second winding segment 441B in the radial direction.

Even when configured as in FIGS. 60 to 66 in this manner, the winding segments 441 are desirably connected as in the second embodiment. In other words, preferably, the first winding segment 441A and the second winding segment 441B are connected in series to form the series-connected part 600, and the plurality of series-connected parts 600 are connected in parallel to form the phase winding 431U, 431V, or 431W of each phase. This arrangement enables to reduce the circulating current.

Regarding the configurations of FIGS. 64 to 66 described above, the second winding segment 441B may be assembled from the radial direction, and furthermore, the second winding segment 44B may be assembled in the axial direction.

### Third Embodiment

In the above embodiments, the configuration of the conductive wire member CR serving as the conductive wire may be modified as follows. Hereinafter, a third embodiment will be described. FIG. 67 shows an enlarged cross-sectional view of the conductive wire member CR.

In the third embodiment, the cross section of the conductive wire CR is a rectangular shape. The cross section of the conductive wire CR is not limited to the rectangular shape and may be various shapes, for example, a polygonal shape or a circle other than the rectangular shape.

The conductor wire member CR is formed by covering a plurality of wires 501 in a bundled state with an insulating coating 502. This ensures insulation between the conductor wire members CR that overlap each other in the circumferential or radial direction and insulation between the conductor wire members CR and the stator core 62.

The wire 501 includes a conductor 503 through which a current flows, and a fusion layer 504 that covers the surface of the conductor 503. The conductor 503 is, for example, a conductive metal such as copper. The conductor 503 is a rectangular wire having the rectangular cross section, however may be a round wire or a wire in another shape (for example, polygonal shape, elliptical shape, or the like). The fusion layer 504 is, for example, an epoxy adhesive resin. Its heat resistance is about 150° C.

The fusion layer 504 is thinner than the insulating coating 502, and has a thickness of, for example, 10 μm or less. In the wire 501, only a fusion layer 504 is formed on the surface of the conductor 503, and no insulating layer is provided additionally. The fusion layer 504 may be made of an insulating material. In other words, the concept is to combine the resin and insulation of the self-fusing wire. The insulating layer and the fusing layer are usually separate, nevertheless, the epoxy adhesive resin that constitutes the adhesive layer 504 also serves as an insulating layer. An insulating layer is missing. Noted that, a normal insulating layer may be provided.

The fusion layer 504 melts at a lower temperature than the insulating coating 502. The fusion layer 504 has a characteristic of having a high dielectric constant. The characteristic of melting at a low temperature has an effect of facilitating electrical conductivity at the ends of the wires 501. In addition, fusing and others are easy. The reason why the dielectric constant may be high is a prerequisite that the potential difference between the wires 501 is smaller than that between the conductive wires CR. By setting in this manner, even if the fusion layer 504 melts, the eddy current loss can be effectively reduced by the contact resistance alone.

When the plurality of wires 501 are bundled together, the fusion layers 504 are in contact with each other and fused together. This allows adjacent wires 501 to be fixed to each other, suppressing vibrations and noise caused by the wires 501 rubbing against each other. In addition, the wires 501 each having the fusion layer 504 are bundled together, and the fusion layers 504 are fused together to maintain the shape.

The insulating coating 502 is made of resin, for example, modified PI enamel resin having a heat resistance of 220° C. to 240° C. The modified PI gains oil resistance. It is designed to protect the devise from hydrolysis and sulfur attack due to the ATF and other substances. In this case, the linear expansion coefficient of the epoxy adhesive resin is greater than that of the modified PI enamel resin. The insulating coating 502 is formed in a wide tape shape and is wound around the outer periphery of the bundled wires 501.

The insulating coating 502 has a higher insulating performance than that of the fusion layer 504 of the wire 501 and is configured to provide insulation between the phases. For example, when the thickness of the fusion layer 504 of the wire 501 is set to about 1 μm, it is desirable to set the total thickness of the insulating coating 502 to about 9 μm to 50 μm so as to provide a suitable insulation between the phases. Specifically, when the insulating coating 502 is formed in two layers, the thickness of each layer may be about 5 μm.

Naturally, the outer insulating coating 502 varies depending on the system voltage and line voltage used in the rotary electric machine. For example, the coating thickness generally used for high-speed charging of vehicles is preferably around 200 μm for use as phase-to-phase insulation, and 40 to 100 μm for use as phase-to-phase voltage insulation.

### Modified Example of Third Embodiment

The configuration of the conductor wire CR and the stator winding 61 described above may be modified as described below.

In the third embodiment, the linear expansion coefficient (linear expansion rate) of the fusion layer 504 may be different from that of the linear expansion coefficient of the insulating coating 502. That is, as described above, the potential difference between the conductors 503 is small. Even when the fusion layer 504 is broken when bundling the multiple wires 501 or covering the insulating coating 502, the area of contact between the conductors 503 is very small, and the contact resistance is very large. Therefore, even when the conductors 503 are not completely insulated, it is possible to suppress the flow of eddy currents between the conductors 503. Therefore, there is actually no problem even when the fusion layer 504 breaks, and the conductors 503 come into contact with each other after manufacturing. Therefore, various materials having a linear expansion coefficient different from that of the insulating coating 502 can be selected for the bonding layer 504, and the configuration facilitates the design easier. For example, the linear expansion coefficient of the adhesive layer 504 may be set to be greater than the linear expansion coefficient of the insulating coating 502.

Naturally, the linear expansion coefficient of the adhesive layer 504 may be set smaller than the linear expansion coefficient of the insulating coating 502. When the linear expansion coefficient is set small, the fusion layer 504 is less likely to break, the number of contact points between the conductors 503 does not increase, and increase in eddy current loss can be suppressed.

In the third embodiment, the linear expansion coefficient (linear expansion rate) of the fusion layer 504 may be the same as the linear expansion coefficient of the insulating coating 502. This enables to prevent the adhesive layer 504 and the insulating coating 502 from cracking at the same time.

In the third embodiment, the linear expansion coefficient (linear expansion rate) of the fusion layer 504 may be the same as the linear expansion coefficient of the conductors 503. When the linear expansion coefficient (linear expansion rate) of the fusion layer 504 is between the linear expansion coefficient of the conductor 503 and the linear expansion coefficient of the insulating coating 502, the fusion layer 504 acts as a cushion and enables to prevent the insulating coating 502 from cracking.

In the third embodiment, the insulating coating 502 may be made of PA, PI, PAI, PEEK, or the like. The adhesive layer 504 may be made of fluorine, polycarbonate, silicon, epoxy, polyethylene naphthalate, or LCP.

In the third embodiment, the conductor 503 of the wire 501 may be a composite body in which thin fibrous conductive members are bundled together. For example, the conductor may be a composite of CNT (carbon nanotube) fibers. As the CNT fibers, fibers including boron-containing fine fibers in which at least a portion of carbon is replaced with boron may be used. As the carbon-based fine fibers, vapor grown carbon fibers (VGCF) and the like may be used in addition to CNT fibers, nevertheless, CNT fibers are preferable.

In the third embodiment, the conductor wire CR may be formed by twisting a plurality of wires 501 together. In this case, generation of eddy currents in each wire 501 is further suppressed. In addition, by twisting each wire 501, portions arise in each wire 501 to which the magnetic field is applied in the opposite directions, thereby canceling out the counter electromotive voltages. Therefore, this enables to reduce eddy currents. In particular, by forming the wire 501 from a fibrous conductive material, it is possible to make the wire thinner and significantly increase the number of twists, thereby to enable to more effectively reduce eddy currents.

### Fourth Embodiment

The configurations of the above-described embodiments may be modified as follows. Next, a fourth embodiment will be described.

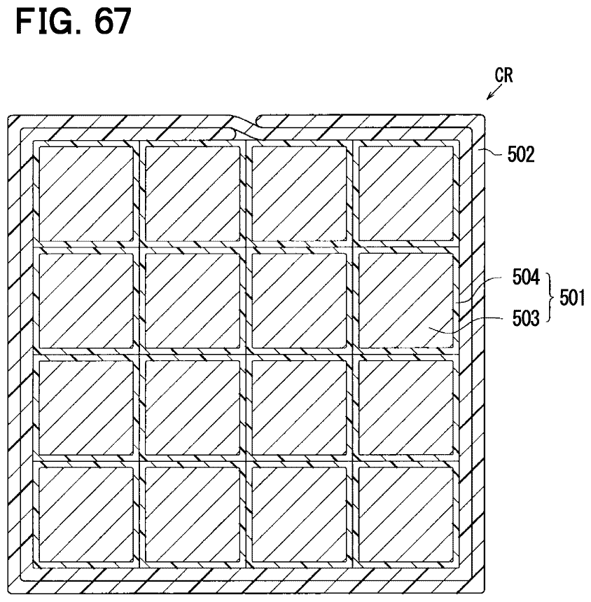

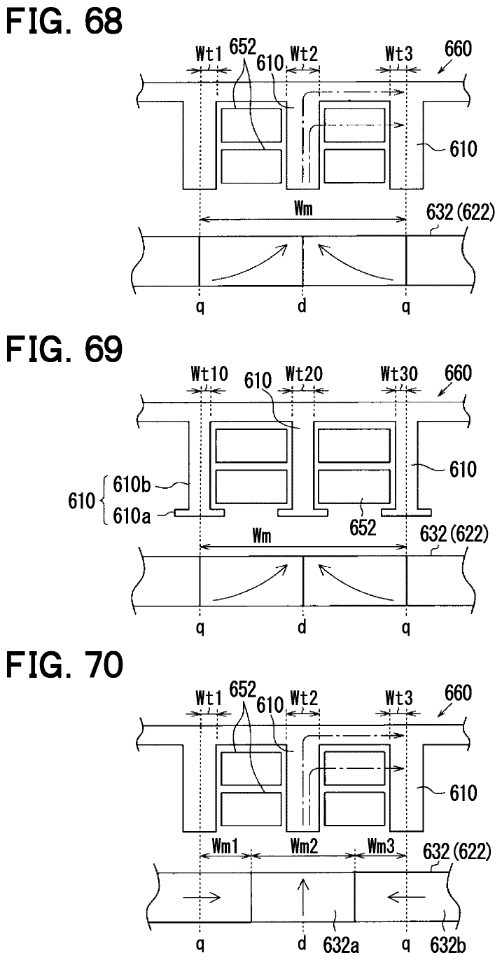

In each of the above embodiments, the stator 60, 430 has the slotless structure that does not have the teeth for forming the slots. The fourth embodiment of the stator 660 has the following modifications. FIG. 68 is a schematic cross-sectional view of a magnet unit 622 and the stator 660.

As shown in FIG. 68, in the stator 660, teeth 610 are provided as inter-conductor members between intermediate conductor portions 652 as conductor portions in the circumferential direction. Furthermore, for the teeth 610, the circumferential width of the teeth 610 in one magnetic pole is Wt, the saturation magnetic flux density of the teeth 610 is B100, the circumferential width of a magnet 632 in one magnetic pole is Wm, and the residual magnetic flux density of the magnet 632 is Br. A magnetic material that satisfies the relationship Wt×B100≤ Wm×Br is used. In FIG. 68, the left-right direction corresponds to the circumferential direction, and the up-down direction corresponds to the radial direction. Although an inner rotor is assumed, an outer rotor may be used.

Here, the saturation magnetic flux density is set to B100. A supplementary explanation will be given. In the above embodiment, it is assumed that the magnet 632 that generates a strong magnetic field is used. For this reason, it is desirable to calculate the saturation magnetic flux density using “B100” (magnetic flux density at a magnetizing force of 10,000 A/m) rather than “B50” (magnetic flux density at a magnetizing force of 5,000 A/m) which is used in ordinary rotary electric machines.

That is, when the teeth 610 are provided in the stator 660, it is desirable that the teeth 610 be made of a magnetic material that satisfies the relationship Wt×B100≤ Wm×Br. By designing in this way, it is possible to obtain a more accurate effect than the “B50” used in the design of ordinary rotary electrical machines.

Here, additional information regarding the measurement method for “B100” will be provided. It is preferable that “B100” be measured by the Epstein test. The Epstein test is a magnetic measurement test specified in JIS C 2550. To give an overview, rectangular samples (such as iron cores used in rotary electrical machines) in a crisscross pattern are placed in a coil frame to create an Epstein ring. A magnetic field of 10,000 A/m is applied by a coil attached to the coil frame, the B value (in tesla) is measured, and this is used as the value of “B100”.

Furthermore, when the Epstein ring cannot be created, “B100” is measured by a micro single sheet magnetic property test (SST test). The micro single sheet magnetic property test is specified in JIS C 2556. To give an outline, a sheet-shaped sample is clamped between a yoke and excited using the H-coil method or the excitation current method, a magnetic field of 10,000 A/m is applied, and the B value (tesla) is measured and used as the value of “B100”.

When no strong strain has been applied (for example, when a 0.5 mm thick material has not been rolled to 0.3 mm), the catalog value or the manufacturer's measured value may be used as the value of “B100”.

In the case where the teeth 610 are provided, assuming Wt×B100≤ Wm×Br, then in principle the teeth 610 will be magnetically saturated. When magnetic flux saturation occurs in the teeth 610 and magnetic flux leakage occurs, the magnetic flux is induced in the adjacent teeth 610 that is closest in the circumferential direction, as shown by the dashed dotted line in FIG. 68. For this reason, it is desirable that the intermediate conductor portion 652 between the teeth 610 to have a flat cross section whose circumferential length is longer than its radial length. In this case, as shown in FIG. 68, a plurality of layers may be stacked in the radial direction. Moreover, it is preferable that the intermediate conductor portion 652 is formed by bundling the conductor wire CR. This enables to suppress eddy currents.

In the fourth embodiment, similarly to the above-described embodiments, the stator winding 661 of the stator 660 may employ either distributed winding or concentrated winding. A supplementary explanation will be given below regarding the case where the concentrated winding is employed. The concentrated winding referred to here is one in which the width of one pole pair of the magnetic pole is different from the width of one pole pair of the stator winding 661. Examples of the concentrated winding include three intermediate conductor portions 652 for one magnetic pole pair (two poles, three slots (2P3S)), three intermediate conductor portions 652 for two magnetic pole pairs (four poles, three slots (4P3S)), nine intermediate conductor portions 652 for four magnetic pole pairs (eight poles, nine slots (8P9S)), and nine intermediate conductor portions 652 for five magnetic pole pairs (ten poles, nine slots (10P9S)). There are also others such as the 14P15S.

When the concentrated winding is used and multiple teeth 610 exist within one magnetic pole of the magnet unit 622, the total circumferential width of the teeth 610 within one magnetic pole of the magnet unit 622 may be Wt. For example, in the case of FIG. 68, three teeth 610 (all or part) are present within the circumferential width Wm of the magnet 632 in one magnetic pole. In this case, the sum of these (Wt1+Wt2+Wt3) may be set as Wt. One magnetic pole refers to a range of 180 electrical degrees around the d-axis, which is the center of the magnetic pole.

As shown in FIG. 69, when the width of the teeth 610 is not uniform in the radial direction, it is desirable to determine Wt based on the narrowest value among the widths of the teeth 610 in the circumferential direction. That is, since saturation of the magnetic circuit basically occurs at the narrowest point of the teeth 610, it is desirable to use the narrowest part in width. In the example of FIG. 69, Wt is determined based on the width of the teeth main body portion 610b other than a flange portion 610a protruding on both circumferential sides at the tip of the tooth 610. In other words, since there are three teeth 610 (all or part) within the circumferential width Wm of the magnet 632 in one magnetic pole, the width of the narrowest part of these teeth 610 (Wt10+Wt20+Wt30) is defined as Wt.

In addition, an average circumferential width Wta of the teeth main body portion 610b other than the flange portions 610a arranged on the magnet unit 622 side and protruding on both circumferential sides of the tooth 610 may be calculated, and Wt may be determined based on this. That is, an average magnetic resistance may be taken into consideration.

In the fourth embodiment, a Halbach array may be adopted, similarly to the above embodiments. The Halbach array will now be described. As shown in FIG. 70, the Halbach array is formed by the magnet unit 622 in which a plurality of first magnets 632a and a plurality of second magnets 632b are arranged alternately in the circumferential direction. The magnetic flux path of the first magnet 632a is arranged to be closer to parallel to the radial direction than the magnetic flux path of the second magnet 632b. In FIG. 70, the magnetic flux path of the first magnet 632a is provided linearly along the radial direction, and the magnetic flux path of the second magnet 632b is provided linearly along the circumferential direction. The first magnet 632a is provided on the d-axis side, and the second magnet 632b is provided on the q-axis side.

The circumferential width of the magnet unit 622 for one magnetic pole when the Halbach array is adopted will be described. When the Halbach array is adopted, the circumferential width Wm of the magnet unit 622 in one magnetic pole is calculated as the sum of the circumferential width of the first magnet 632a present in one magnetic pole and the circumferential width of the second magnet 632b present in the one magnetic pole (Wm1+Wm2+Wm3). In the Halbach array, “in one magnetic pole” is the range between the adjacent q axes in the circumferential direction. That is, the magnetic pole refers to a range of 180 electrical degrees around the d-axis, which is the center of the magnetic pole.

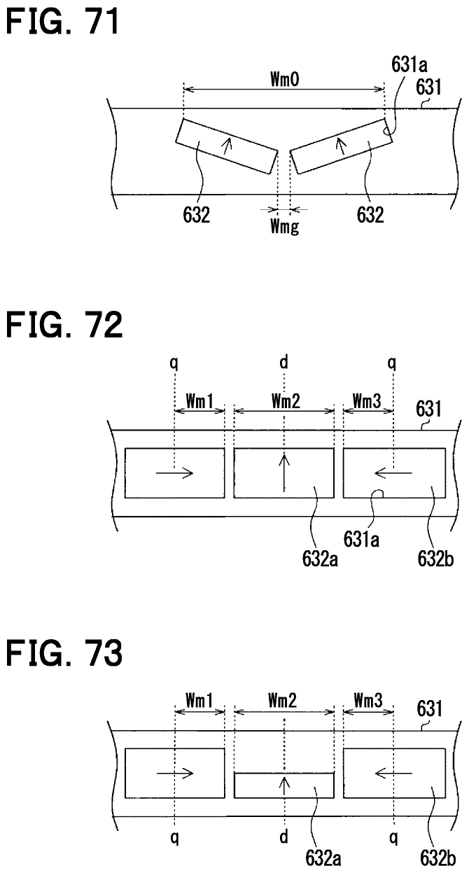

In the above embodiment, an IPM may be adopted. For example, as shown in FIG. 71, an IPM type rotor may be adopted, in which magnet accommodating holes 631a are formed in a magnet holder 631 (rotor core), and magnets 632 are inserted into the magnet accommodating holes 631a. In addition, as shown in FIG. 71, when an IPM is adopted, and when the magnet 632 is divided into multiple parts in one magnetic pole, Wm can be set to a value (Wm0−Wmg) obtained by subtracting the circumferential width Wmg between the magnets from the circumferential width Wm0 from one end to another end of the magnet 632 in one magnetic pole.

Also, while adopting an IPM, magnets 632a and 632b in the Halbach array may be used. For example, as shown in FIG. 72, a Halbach array IPM type rotor may be adopted, in which the magnet accommodating holes 631a are formed in the magnet holder 631 (rotor core) and the magnets 632a, 632b are inserted into the magnet accommodating holes 631a. The circumferential width of the magnet unit 622 in one magnetic pole in this case will be described.

The magnet holder 631 is made of a magnetic material and is not prone to cause magnetic flux leakage, so as described above, the circumferential width is calculated as the sum of the circumferential width of the first magnet 632a present in one magnetic pole and the circumferential width of the second magnet 632b present in the one magnetic pole (Wm1+Wm2+Wm3). The same is applicable when the radial thickness of the first magnet 632a is thinner than that of the second magnet 632b and is positioned radially opposite to the stator (lower side in FIG. 73) from the second magnet 632b, as shown in FIG. 73.

### Fifth Embodiment

In the above embodiment, the magnets 32 constituting the magnet unit 22 may be modified. A magnet 732 in the fifth embodiment will be described below.

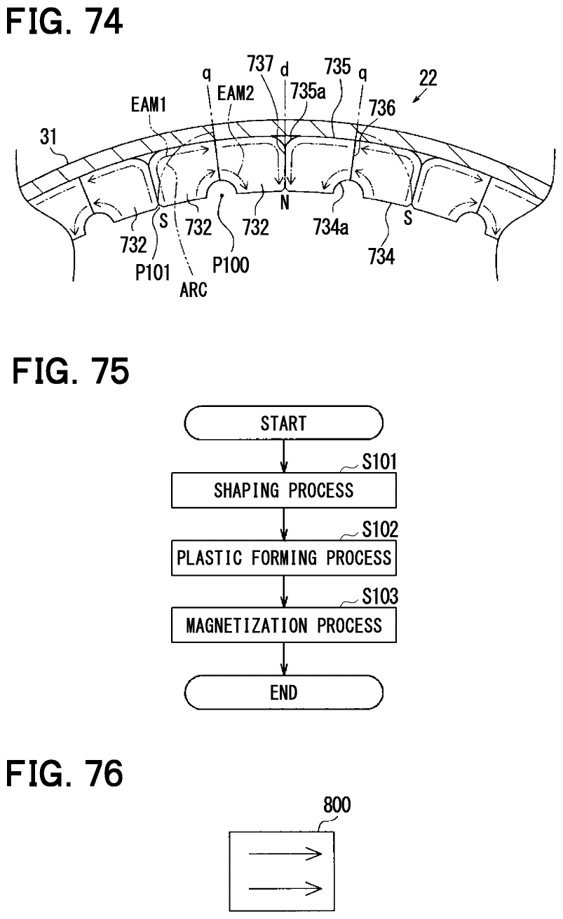

As shown in FIG. 74, the magnet unit 22 of the fifth embodiment includes a plurality of magnets 732 fixed to the inner circumferential surface of the magnet holder 31, similarly to the first embodiment. In the magnet unit 22, the magnets 732 are provided side by side such that the polarities are alternately changed along the circumferential direction of the rotor 20. As a result, the magnet unit 22 has a plurality of magnetic poles in the circumferential direction. The magnet 732 is a polar anisotropic permanent magnet, a hot worked Nd—Fe—B magnet with an intrinsic coercive force of 400 kA/m or more and a residual magnetic flux density Br of 1.0 T or more.

The radially inner (stator 60 side) peripheral surface of the magnet 732 is a stator side peripheral surface 734 (armature side peripheral surface) that faces the stator 60, and is a magnetic flux action surface where magnetic flux is exchanged. The stator side peripheral surface 734 has a flat surface. However, the stator side peripheral surface 734 may have a curved surface along the circumferential direction. The stator side peripheral surface 734 has a recess 734a recessed in the radial direction in a predetermined range including the q-axis.

The radially outer (magnet holder 31 side) peripheral surface of the magnet 732 is an anti-stator side peripheral surface 735 on the radially opposite side to the stator 60. The anti-stator side peripheral surface 735 is curved in the circumferential direction along the inner peripheral surface of the magnet holder 31, however may also be flat. In this case, the gap with the inner peripheral surface of the magnet holder 31 may be filled with a resin adhesive or the like. The anti-stator side peripheral surface 735 of the magnet 732 has a recess 735a that is recessed in the radial direction within a predetermined range including the d-axis.

Two magnets 732 adjacent to each other in the circumferential direction as one set constitutes one magnetic pole. In other words, the multiple magnets 732 arranged circumferentially in the magnet unit 22 have side surfaces that extend radially along the d-axis and q-axis, respectively, and each of the magnets 732 is arranged in abutment or close proximity to each other. The side surface of magnet 732 on the q-axis side is indicated as a q-axis side surface 736, and the side surface on the d-axis side is indicated as a d-axis side surface 737.

Next, the easy axis of magnetization in the fifth embodiment will be described. In FIG. 74, as indicated by the dashed arrow, the magnet 732 has an easy axis of magnetization that extends along the radial direction and then bends to extend circumferentially toward the q-axis. In particular, a d-axis side portion (e.g., the surface portion) of the magnet 732 has the easy axis of magnetization that extends along the d-axis side surface 737 and bends along the anti-stator side peripheral surface 735 in the portion on the anti-stator side peripheral surface 735 side to extend toward the q-axis. The magnetic flux path is formed along the magnetic flux path. However, the magnetization direction differs depending on whether the magnetic flux path is the N pole or the S pole.

In addition, in the stator side peripheral surface 734, the radius of curvature of the bent portion of the easy axis of magnetization EAM1 in the portion on the d-axis side (for example, the outer portion closest to the d-axis side surface 737) has a center point P100 on the q-axis. It is smaller (i.e., the curvature is larger) than the radius of curvature of the arc ARC (indicated by a two-dot chain line) passing through an intersection P101 between the d axis and the stator side peripheral surface 734. That is, the easy axis of magnetization EAM1 is bent at a steep angle so as to be along the d-axis side surface 737 and the anti-stator side peripheral surface 735.

In the stator side peripheral surface 734 of the magnet 732, the radius of curvature of the curved portion of the easy axis of magnetization (e.g., EAM1) on the d-axis side is smaller than the radius of curvature of the curved portion of the easy axis of magnetization (e.g., EAM2) on the q-axis side. That is, the easy axis of magnetization tends to bend at a steeper angle as it approaches the d-axis side surface 737 (or the d-axis side), and to bend at a gentler angle as it approaches the q-axis side surface 736 (or the q-axis side). The radius of curvature of the bent portion of the easy axis of magnetization (for example, EAM2) on the q-axis side may be larger than the radius of curvature of the arc ARC (i.e., the curvature may be smaller).

When the easy axis of magnetization is formed as described above and the magnetic flux path is formed along the easy axis of magnetization, the magnet unit 22 generates magnetic flux concentrated in the area near the d-axis, which is the magnetic pole center, in the stator side peripheral surface 734 (magnetic flux action surface) of the magnet 732. In this case, depending on the direction of the easy axis of magnetization of the magnet 732, the magnetic flux path becomes short near the q-axis on the stator side peripheral surface 734 (inner peripheral surface) of the magnet 732. For this reason, even when the recess 734a is formed, the recess 734a only removes the portion where the magnetic path length of the magnet is short, so there is little effect on the magnetic flux density in the d-axis.

Furthermore, the magnet 732 has the magnetic flux path as described above. On the q axis, the N poles and the S poles of the adjacent magnets 732 in the circumferential direction face each other. Therefore, the permeance around the q-axis can be improved. In addition, since the magnets 32 on both sides across the q-axis attract each other, the magnets 32 can maintain the state where the magnets 32 are in contact with each other. Therefore, this further contributes to improvement of permeance.

In the magnet unit 22, each magnet 732 causes the magnetic flux to flow between the adjacent N and S poles along the easy axis of magnetization, so the magnetic flux path is longer than that of, for example, a radial anisotropic magnet. Therefore, as illustrated in FIG. 8, the shape of the magnetic flux density distribution is close to a sine wave. Accordingly, implementation of the magnet unit 22 can be suitably performed in which the surface magnetic flux change from the q-axis to the d-axis is gentle in each magnetic pole. This feature makes it possible to restrict the generation of eddy currents.

In the magnet 732, the magnetic path is formed in the bent shape as described above, so that the length of the magnetic path is longer than the thickness dimension of the magnet 732 in the radial direction. With this configuration, the permeance of the magnet 32 increases, and the magnet 32 can exhibit an ability equivalent or corresponding to a magnet having a large volume of a magnet, without changing the volume of the magnet.

The magnet unit 22 may use the magnets 32 whose number is identical to the number of the magnetic poles. For example, the magnet 32 may be provided such that one magnet is disposed between the d-axes, which serve as the centers of two magnetic poles adjacent to each other in the circumferential direction. In this case, the magnet 732 has a center in the circumferential direction on the q-axis and has a division surface on the d-axis.

Next, a method for manufacturing the magnet 732 will be described with reference to FIGS. 75 and 76.

First, a shaping process (step S101) is performed in which alloy powder is compression-molded while aligning the easy axis of magnetization of the alloy powder in a predetermined direction using a magnetic field molding machine. As a result, a rectangular molded body 800 is formed, which has a linear easy axis of magnetization as indicated by the arrow in FIG. 76.

Next, a plastic forming process (step S102) is performed in which the molded body 800 obtained in the shaping process is pressed into a die 801 to bend the easy axis of magnetization and plastically form the molded body 800 so that its shape becomes that of the magnet 732. Here, the die 801 and the plastic forming in step S102 will be described in detail.

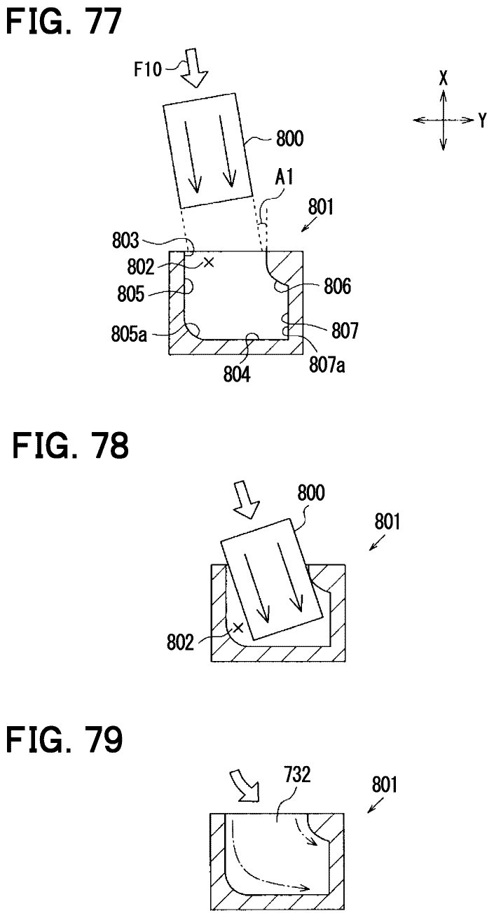

FIG. 77 is a cross-sectional view of the die 801. In FIG. 77, the up-down direction of the die 801 is defined as an X direction, the left-right direction as a Y direction, and the depth direction as a Z direction. As shown in FIG. 77, a die 801 has a cavity 802 into which the molded body 800 is pressed. The cavity 802 is formed to extend in the X direction and has a rectangular cross section. An opening 803 is provided at one end of the cavity 802 in the X direction, and a bottom surface 804 is provided at the other end. The molded body 800 is pushed in through the opening 803, and the shape of the opening 803 corresponds to the shape (dimensions in the Y and Z directions, etc.) of the stator side peripheral surface 734 of the magnet 732. In addition, the bottom surface 804 is formed to correspond to the anti-stator side peripheral surface 735 of the magnet 732. In other words, the bottom surface 804 is formed into a curved surface along the circumferential direction, similarly to the anti-stator side peripheral surface 735.

The cavity 802 is formed by being surrounded by four side walls, namely, a first to fourth side walls. These first to fourth side walls are raised upright relative to the bottom surface 804 of the cavity 802. A first side wall 805 is formed in a flat shape corresponding to the d-axis side surface 737 of the magnet 732. In other words, the X-direction dimension of the first side wall 805 is formed to correspond to the radial length dimension of the d-axis side surface 737, and the Z-direction dimension of the first side wall 805 is formed to correspond to the axial length dimension of the d-axis side surface 737.

Between the first side wall 805 and the bottom surface 804, a curved surface portion 805a is formed, which is curved in correspondence with the recess 735a of the anti-stator side peripheral surface 735 of the magnet 732.

A second side wall 806 faces the first side wall 805 in the Y direction, and is formed to correspond to the recess 734a of the magnet 732. In other words, the X-direction dimension of the second side wall 806 corresponds to the radial length dimension of the recess 734a, and the Z-direction dimension of the second side wall 806 is formed to correspond to the axial dimension of the recess 734a. In addition, since the recess 734a has a curved surface, the second side wall 806 also has a curved surface. The radius of curvature of the second side wall 806 is larger than the radius of curvature of the curved surface portion 805a (that is, the second side wall 806 has a smaller curvature).

The third side wall, not shown, is formed in a planar shape corresponding to one end face of the magnet 732 in the axial direction, and the fourth side wall, not shown, faces the third side wall in the Z direction and is formed in a planar shape corresponding to the other end face of the magnet 732 in the axial direction.

The second side wall 806 has a lateral hole 807 formed therein, which extends in the Y direction along the bottom surface 804 of the cavity 802. That is, the lateral hole 807 is formed in the second side wall 806, opens toward the first side wall 805, and is recessed in the Y direction. A bottom surface 807a of the lateral hole 807 is formed in a flat shape corresponding to the q-axis side surface 736 of the magnet 732. In other words, the X-direction dimension of the bottom surface 807a of the lateral hole 807 corresponds to the radial length dimension of the q-axis side surface 736, and the Z-direction dimension of the bottom surface 807a of the lateral hole 807 is formed to correspond to the axial dimension of the q-axis side surface 736. The Y-direction dimension from the first side wall 805 to the bottom surface 807a of the lateral hole 807 corresponds to the circumferential dimension of the magnet 732.

Then, in the plastic forming process of step S102, first, as shown in FIG. 77, the pressing direction (arrow F10) is aligned with the X direction of the die 801 and the direction of the easy axis of magnetization of the molded body 800, and the molded body 800 is pressed into the opening 803 of the cavity 802. When the molded body 800 is pressed into the cavity 802, the molded body 800 may be pressed straight along the X direction, or the molded body 800 may be pressed in an oblique direction as shown in FIG. 77. In other words, the molded body 800 may be pressed in obliquely with respect to the X direction from the first side wall 805 side toward the second side wall 806 side. Specifically, as shown in FIG. 77, the molded body 800 may be pushed in at an angle in the Y direction away from the second side wall 806 so that the tip of the molded body 800 is pushed into the lateral hole 807. At this time, the pushing direction may be inclined at a predetermined angle A1 (approximately 1 to 15 degrees) with respect to the X direction.

Thereafter, as shown in FIG. 78, by further pushing in after hitting the bottom surface 804 of the cavity 802, the molded body 800 is bent so as to escape along the bottom surface 804 into the lateral hole 807. At this time, since the curved surface portion 805a is formed between the first side wall 805 and the bottom surface 804, the tip of the molded body 800 can be easily guided into the lateral hole 807.

Thereafter, as shown in FIG. 79, the molded body 800 is pushed into the lateral hole 807 until the molded body 800 abuts against the bottom surface 807a of the lateral hole 807. At this time, the pushing direction may be further tilted toward the Y direction so as to push the molded body 800 further into the lateral hole 807. As a result, the molded body 800 is pressed to have the shape of the cavity 802, i.e., the shape of the magnet 732. Accordingly, the axis of easy magnetization is bent into a substantially L-shape along the first side wall 805 and the bottom surface 804.

Further, the radius of curvature of the second side wall 806 is larger than the radius of curvature of the curved surface portion 805a. Therefore, after being pressed into the die 801, the easy axis of magnetization tends to bend at a steeper angle as it approaches the d-axis side surface 737 (or the d-axis side), as shown in FIG. 74, and to bend at a further gentle angle as it approaches the q-axis side surface 736 (or the q-axis side).

The plastic forming process in step S102 is hot pressing. That is, the molded body 800 is pressed into the die 801 while being heated.

Then, as shown in FIG. 75, after the plastic forming step, various processes (not shown) such as sintering, surface processing (cutting, flat grinding, etc.), and surface treatment (plating, etc.) are carried out on the plastic processed product obtained in the plastic processing step, and then a magnetization process (step S103) is carried out in which the product is magnetized to generate magnet 732. This completes the magnet 732. The magnetization process may be performed after fixing to the magnet holder 31.

According to the fifth embodiment, the following effects are obtained.

In the magnet 732, the d-axis side portion has the approximately L-shaped easy axis of magnetization which extends along the d-axis side surface 737, and then bends along the anti-stator side peripheral surface 735 in the portion of the anti-stator side peripheral surface 735 and extends toward the q-axis side. For example, the radius of curvature of the curved portion of the easy axis of magnetization EAM1 is smaller than the radius of curvature of the arc ARC. Therefore, the magnetic flux path of the magnet can be made longer than when the axis of easy magnetization is provided in an arc shape. In other words, even when the amount of magnet is the same, the magnetic flux density can be improved. Alternatively, even when the magnetic flux density is the same, the amount of magnet can be reduced.

In the stator side peripheral surface 734 of the magnet 732, the radius of curvature of the curved portion of the easy axis of magnetization (e.g., EMA1) on the d-axis side is smaller than the radius of curvature of the curved portion of the easy axis of magnetization (e.g., EMA2) on the q-axis side. That is, the easy axis of magnetization tends to bend at a steeper angle as it approaches the d-axis side surface 737 (or the d-axis side), and to bend at a gentler angle as it approaches the q-axis side surface 736 (or the q-axis side). When the easy axis of magnetization is formed as described above and the magnetic flux path is formed along the easy axis of magnetization, the magnet unit 22 generates magnetic flux concentrated in the area near the d-axis, which is the magnetic pole center, in the stator side peripheral surface 734 (magnetic flux action surface) of the magnet 732.

In addition, the radius of curvature of the easy axis of magnetization changes gradually. This allows the magnetic flux density to be gradually increased toward the d-axis side.

Furthermore, the molded body 800 is pressed into die 801 to bend the easy axis of magnetization, and is plastically formed so that the molded body 800 takes on the shape of a magnet 832. That is, the easy axis of magnetization is changed correspondingly to the shape of the magnet 732. Therefore, the magnet 732 can be manufactured efficiently. In addition, since the lateral hole 807 is formed in the cavity 802, by pressing the molded body 800 into the die 801, the magnet 732 can be processed into an approximately L-shape and the axis of easy magnetization can be bent into an approximately L-shape.

The distance from A first side wall 705 to a second side wall 706 is set so as to gradually increase in the X direction from the opening 803 toward the bottom surface 804. Therefore, by pushing the molded body 800 into the die 801, the tip of the molded body 800 can be easily guided into the lateral hole 807 provided in the second side wall 806. In other words, the axis of easy magnetization is easily bent into an L shape.

In addition, the second side wall 806 is formed in a curved shape, and a curved portion 805a is provided between the first side wall 805 and the bottom surface 804 in order to guide the pressed molded body 800 into the lateral hole 807. Therefore, by pushing the molded body 800 into the die 801, the tip of the molded body 800 can be easily guided into the lateral hole 807 provided in the second side wall 806.

Furthermore, the radius of curvature of the curved surface portion 805a is smaller than the radius of curvature of the second side wall 806. For this reason, the axis of easy magnetization is bent at a steeper angle as it approaches the d-axis side surface 737 (or the d-axis side), and is bent at a gentler angle as it approaches the q-axis side surface 736 (or the q-axis side).

### Modification of Fifth Embodiment

Although the second side wall 806 is formed to have a curved surface, the shape of the second side wall 806 may be modified arbitrarily. For example, the first side wall 805 and the second side wall 806 may be formed by an inclined surface such that the distance from the first side wall 805 to the second side wall 806 gradually increases in the X direction. Also, it may be formed in a stepped shape.

Although the curved surface portion 805a is provided between the first side wall 805 and the bottom surface 804, the shape of the curved surface portion 805a may be modified arbitrarily. For example, it may have an inclined surface. Moreover, the curved surface portion 805a need not be provided. In this case, for example, the first side wall 805 may be provided to rise approximately perpendicular to the bottom surface 804. The first side wall 805 may be inclined at a predetermined angle with respect to the bottom surface 804.

A plurality of dies 801 may be arranged in a circular ring shape, and each molded body 800 may be simultaneously pressed in from the radially outer side. This allows processing to be done all at once.

In addition, the magnet per magnetic pole may be divided and processed in various manners. For example, the magnet 732 may be divided into two parts, and each of which may be processed.

### Sixth Embodiment

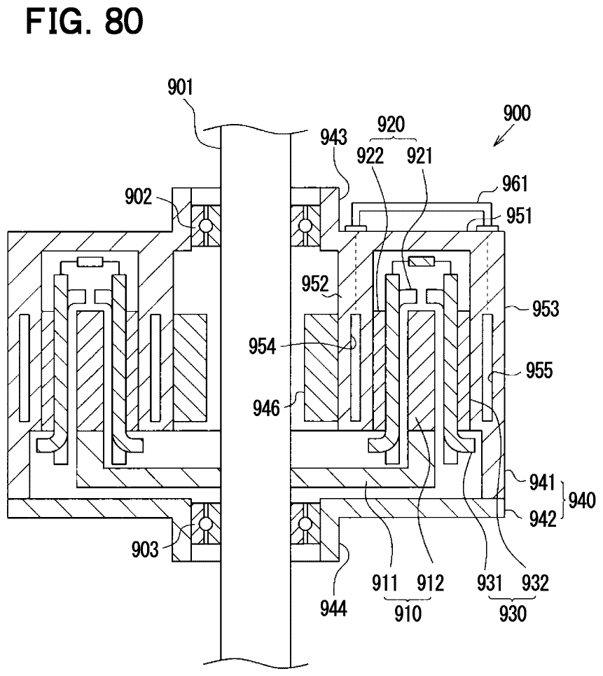

In the above embodiment, a so-called double stator type rotary electric machine having stators on both the radial inside and the radial outside of a rotor may be used. The double stator type rotary electric machine according to the sixth embodiment will be described in detail. As shown in FIG. 80, a rotary motor 900 includes a rotor 910 fixed to a rotary shaft 901 so as to be rotatable integrally therewith, a first stator 920 provided radially inside the rotor 910, a second stator 930 provided radially outside the rotor 910, and a stator holder 940 as a stator holding member that holds each of these stators 920, 930. Each of these members is provided in a cylindrical shape coaxial with the rotary shaft 901. The rotary shaft 901 is rotatably supported by a pair of bearings 902 and 903 provided on the radially inner side of the stator holder 940.

The rotor 910 has a rotor carrier 911 formed in a hollow cylindrical shape, and an annular magnet unit 912 fixed to the rotor carrier 911. The rotor carrier 911 is fixed to the rotary shaft 901 and functions as a magnet holding member. The magnet unit 912 has a plurality of magnets 913 arranged so that their polarities alternate along the circumferential direction of the rotor 910. As a result, the magnet unit 912 has a plurality of magnetic poles in the circumferential direction. The magnet unit 912 corresponds to a “magnet unit”.

As shown in FIG. 81, the magnet unit 912 has a cylindrical rotor core 914, and the rotor core 914 is formed with a plurality of magnet accommodating holes 915 at predetermined intervals in the circumferential direction. The magnet 913 is housed in each of the magnet housing holes 915. The magnet 913 is a radially anisotropic permanent magnet whose magnetization direction is in the radial direction. The magnet 913 may be a parallel anisotropic permanent magnet whose magnetization directions are parallel. It is preferable that the magnet 913 be a high Br sintered neodymium magnet having an intrinsic coercive force of 400 kA/m or more and a residual magnetic flux density Br of 1.0 T or more. As described in the above embodiments, a magnet having an arc-shaped or curved easy axis of magnetization (and magnetic flux path) may be used.

The rotor 910 has an embedded magnet type rotor structure, but may alternatively have a surface magnet type rotor structure. A surface magnet type rotor structure may be, for example, configured such that a pair of magnets 913 are arranged circumferentially at a predetermined interval on the inside and outside in the radial direction of the rotor core 914 for each magnetic pole.

The first stator 920 is arranged facing the radially inner side of the rotor 910 with a predetermined air gap between them, and the second stator 930 is arranged facing the radially outer side of the rotor 910 with a predetermined air gap between them. The first stator 920 is an inner stator, and the second stator 930 is an outer stator. The first stator 920 has a stator winding 921 and a stator core 922, and the second stator 930 has a stator winding 931 and a stator core 932. The stator winding 921 is also referred to as a first stator winding 921, and the stator winding 931 is also referred to as a second stator winding 931. The stator cores 922, 932 are configured as a core sheet laminate in which a plurality of core sheets made of electromagnetic steel plates are stacked in the axial direction. Furthermore, the stator cores 922 and 932 are cylindrical with no irregularities on their outer circumferential surfaces, and function as back yokes. In other words, each of the stators 920, 930 has a teethless structure. It is noted that, teeth may be provided.

As described in the above embodiment, each of the stators 920, 930 has a plurality of coil modules provided for each partial winding, and these coil modules are assembled to each of the stator cores 922, 932. For details regarding the configuration of the coil modules and the assembly of each coil module to the stator cores 922, 932, please refer to FIG. 46 and the like. The coil module has a pair of intermediate conductor portions arranged at a predetermined distance apart, and transition portions connecting the intermediate conductor portions at one and the other axial ends, one of the transition portions being bent radially.

One of the two axial ends is bent radially so as to be roughly L-shaped in the side view, and this bend suppresses interference between circumferentially adjacent coil modules. Each coil module may have both axial ends bent in opposite directions to each other, forming a substantially Z-shape in side view. Furthermore, both ends of each coil module in the axial direction do not have to be bent.

Next, the stator holder 940 will be described. The stator holder 940 has a holder body 941 having a cylindrical shape with a bottom, and a cover 942 fixed to one axial end of the holder body 941. The holder body 941 and the cover 942 each has a boss portion 943, 944 at the radial center. As shown in FIG. 81, a rotary shaft 901 is rotatably supported by bearings 902 and 903 at boss portions 943 and 944. An internal space surrounding the rotary shaft 901 is formed within the holder body 941, and the magnet unit 912 of the rotor 910 and the stators 920 and 930 are housed in this internal space.

The holder body 941 has a disk-shaped end plate portion 951, an inner cylindrical portion 952 extending axially from the end plate portion 951, and an outer cylindrical portion 953 similarly extending axially from the end plate portion 951. The inner cylindrical portion 952 and the outer cylindrical portion 953 are arranged concentrically at radially inner and outer positions, and the magnet unit 912 of the rotor 910 and the stators 920, 930 are arranged in the annular space formed between these cylindrical portions 952, 953 (see FIG. 80). More specifically, a first stator 920 is fixed to the radial outside of the inner cylindrical portion 952, and the second stator 930 is fixed to the radial inside of the outer cylindrical portion 953, and the magnet unit 912 of the rotor 910 is arranged between the first stator 920 and the second stator 930. In other words, each of the stators 920, 930 is held by an inner cylindrical portion 952 and the outer cylindrical portion 953 on the radially opposite side (opposite the magnet unit side) of the magnet unit 912. Each of the stators 920, 930 is assembled to the stator holder 940 by fixing the stator cores 922, 932 to the respective cylindrical portions 952, 953 by press fitting, heat caulking, adhesive or the like.

With the magnet unit 912 and the stators 920 and 930 housed within the holder body 941, a cover 942 is fixed to the holder body 941 by fasteners such as bolts.

The configuration of the stator holder 940 is not limited to that described above, and can be modified as appropriate. For example, the inner cylindrical portion 952 may be integrally formed with the end plate portion 951 of the holder body 941, and the outer cylindrical portion 953 may be integrally formed with the cover 942. In this configuration, an inner cylindrical portion 952 and the outer cylindrical portion 953 are provided radially inside and outside by fixing the cover 942 to the holder body 941, and the stators 920, 930 are fixed to the cylindrical portions 952, 953, respectively. In the stator holder 940, in a configuration in which the member fixing the first stator 920 (holder body 941) and the member fixing the second stator 930 (cover 942) are separable, it is possible to fix each stator 920, 930 to its corresponding member, and then assemble the members for each stator 920, 930 to each other. This is expected to facilitate the fixing operation of the stators 920, 930 compared to a configuration in which the stators 920, 930 are fixed to the same member (for example, the holder main body 941).

Furthermore, as shown in FIG. 80, an annular space is formed radially inside the inner cylindrical portion 952 of the stator holder 940, and electrical components 946 constituting an inverter as a power converter are preferably arranged in the annular space in contact with or in close proximity to the inner cylindrical portion 952. The electric component is, for example, an electric module in which a semiconductor switching element or a capacitor is packaged.

It is preferable that a common inverter is provided for the first stator winding 921 and the second stator winding 931, and that the inverter is mounted on the radially inner side of the inner cylindrical portion 952. However, if the first stator winding 921 and the second stator winding 931 each have their own inverter, only the inverter on the first stator winding 921 side may be mounted radially inside the inner cylindrical portion 952. For example, the inverter on the side of the second stator winding 931 is mounted on the outside of the outer cylindrical portion 953 or the cover 942. Moreover, both inverters may be mounted on the radially inner side of the inner cylindrical portion 952.

The stator holder 940 has a cooling structure for cooling the stators 920, 930, and in particular has a structure for cooling each of the stators 920, 930 individually. More specifically, annular refrigerant passages 954, 955 for passing a refrigerant such as cooling water are formed in an inner cylindrical portion 952 and the outer cylindrical portion 953 of the stator holder 940, respectively. The refrigerant passage 954 provided in the inner cylindrical portion 952 is also referred to as a “first refrigerant passage 954”, and the refrigerant passage 955 provided in the outer cylindrical portion 953 is also referred to as a “second refrigerant passage 955”. The first stator 920 is cooled by the refrigerant flowing through the first refrigerant passage 954, and the second stator 930 is cooled by the refrigerant flowing through the second refrigerant passage 955. The refrigerant passages 954, 955 are connected to each other via a relay pipe 961, allowing the refrigerant to flow from the first refrigerant passage 954 to the second refrigerant passage 955, or in the opposite direction.

### Seventh Embodiment

In the above embodiment, a rotary electric machine may be used in which magnet units are arranged on both the radially inner side and the radially outer side of the stator. This rotary electric machine will now be described in detail.

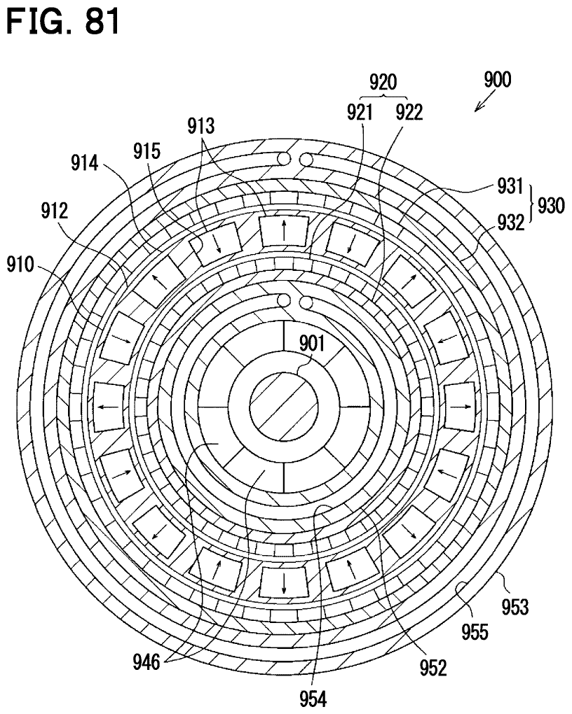

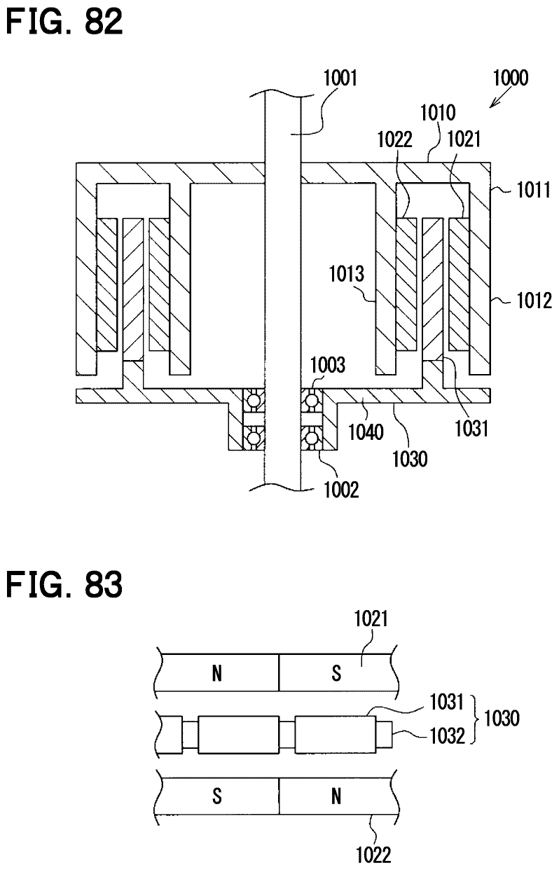

As shown in FIG. 82, a rotary electric machine 1000 includes a rotor 1010 fixed to a rotary shaft 1001 so as to be rotatable together with the rotor 1010, and a stator 1030 provided radially inward of the rotor 1010. Each of these members is provided in a cylindrical shape coaxial with the rotary shaft 901. The rotary piece 20 corresponds to a “field element”, and the fixed piece 40 corresponds to an “armature”.

The rotor 1010 has a rotor carrier 1011 formed in a hollow cylindrical shape, an annular first magnet unit 1021, and an annular second magnet unit 1022 arranged radially inward of the first magnet unit 1021. The rotor carrier 911 is fixed to the rotary shaft 901 and functions as a magnet holding member. The rotor carrier 1011 is formed in a hollow cylindrical shape, and includes an inner cylindrical portion 1013 inside an outer cylindrical portion 1012. The first magnet unit 1021 has a plurality of magnets arranged so that their polarities alternate along the circumferential direction of the rotor 1010, and is fixed to the inner circumferential surface of the outer cylindrical portion 1012. The first magnet unit 1021 has a plurality of magnets arranged so that their polarities alternate along the circumferential direction of the rotor 1010, and is fixed to the inner circumferential surface of the outer cylindrical portion 1012.

The first magnet unit 1021 and the second magnet unit 1022 may be of the embedded magnet type or the surface magnet type as described above. Furthermore, each magnet may be a radial anisotropic permanent magnet or a parallel anisotropic permanent magnet. As described in the above embodiments, a magnet having an arc-shaped or curved easy axis of magnetization (and magnetic flux path) may be used. It is also preferable to use a high Br sintered neodymium magnet having an intrinsic coercive force of 400 kA/m or more and a residual magnetic flux density Br of 1.0 T or more.

The stator 1030 is disposed between the first magnet unit 1021 and the second magnet unit 1022 in the radial direction. That is, the stator 1030 is arranged facing the radially inner side of the first magnet unit 1021 with a predetermined air gap between them, and the second magnet unit 1022 is arranged facing the radially inner side of the stator 1030 with a predetermined air gap between them.

The stator 1030 includes a stator winding 1031 and a stator core 1032. As shown in FIG. 83, the stator cores 1032 are erected to extend in the axial direction at a predetermined interval in the circumferential direction, and the intermediate conductor portion of the stator winding 1031 is arranged between each of the stator cores 1032. In addition, a teethless structure (coreless structure) may be used.

As described in the above embodiment, each stator 1030 has a plurality of coil modules provided for each partial winding, and these coil modules are assembled to each stator core 1032.

The stator 1030 is provided upright relative to a stator holder 1040. The stator holder 1040 is configured in a disk shape, and the rotary shaft 1001 is rotatably supported by bearings 1002 and 1003 at the radial center.

### Eighth Embodiment

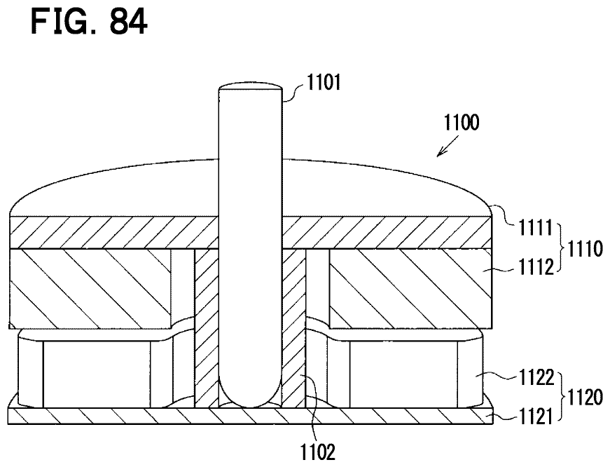

In the above embodiment, an axial gap type rotary electric machine may be used. FIG. 84 is a vertical cross-sectional view showing a schematic configuration of an axial gap type rotary electric machine 1100.

As shown in FIG. 84, a rotary electric machine 1100 has a rotor 1110 fixed to a rotary shaft 1101 so as to be rotatable together with the rotor 1110, and the stator 1120 disposed opposite the rotor 1110 in the axial direction. Although not shown, the rotor 1110 and the stator 1120 are accommodated in a housing that is integral with the stator 1120. The rotary piece 20 corresponds to a “field element”, and the fixed piece 40 corresponds to an “armature”.

The rotor 1110 has a disk-shaped rotor core 1111 and a magnet unit 1112 fixed to one side of the rotor core 1111 as a magnet unit. The rotor core 1111 is made of a magnetic material, and is formed, for example, by stacking a plurality of electromagnetic steel plates in the axial direction. The rotor core 1111 is fixed to the rotary shaft 1101. The stator 1120 also has a stator core 1121 and a multi-phase stator winding 1122 that is integral with the stator core 1121. A bearing 1102 is fixed to the stator 1120, and the rotary shaft 1101 is rotatably supported by the bearing 1102.

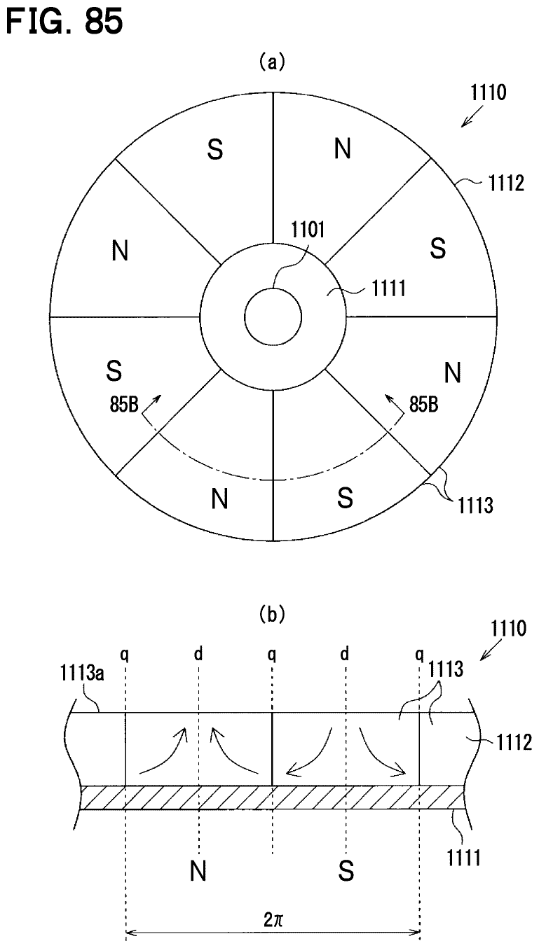

The configuration of the rotor 1110 will be described more specifically with reference to (a) and (b) in FIG. 85. In FIG. 85, (a) is a plan view showing the configuration of the rotor 1110, and (b) is a cross-sectional view of the rotor 1110 taken along line 85B-85B in (a). As shown in (a) in FIG. 85, the magnet unit 1112 has a plurality of magnets 1113 (permanent magnets) arranged to surround the rotary shaft 1101. The magnets 1113 are arranged in an annular pattern on one side of the plate surface of the rotor core 1111, and the magnets 1113 form a plurality of magnetic poles whose polarities alternate in the circumferential direction. In this example, eight magnets 1113 form eight magnetic poles. The magnet 1113 is formed using a sintered neodymium magnet having an intrinsic coercive force of 400 kA/m or more and a residual magnetic flux density Br of 1.0 T or more.

As shown in (b) in FIG. 85, each magnet 1113 has the magnetic flux action surface 1113a on the axial side facing the stator 1120 (upper side of the figure), and this magnetic flux action surface 1113a generates magnetic flux concentrated in the area near the d-axis, which is the magnetic pole center. Specifically, each magnet 1113 is a polar anisotropic magnet, and is configured so that the axis of easy magnetization is oriented parallel to the d-axis on the side of the d-axis, which is the magnetic pole center, compared to the q-axis on the side of the magnetic pole boundary. In other words, the orientation of the easy axis of magnetization differs between the d-axis side (the part closer to the d-axis) and the q-axis side (the part closer to the q-axis); on the d-axis side, the orientation of the easy axis of magnetization is closer to a direction parallel to the d-axis, and on the q-axis side, the orientation of the easy axis of magnetization is closer to a direction perpendicular to the q-axis. An arc-shaped magnetic flux path is formed by the orientation according to the direction of the easy axis of magnetization. In each magnet 1113, the axis of easy magnetization on the d-axis side may be oriented parallel to the d-axis, and the axis of easy magnetization on the q-axis side may be oriented perpendicular to the q-axis. As shown in the fifth embodiment, the axis of easy magnetization may be bent into a substantially L-shape.

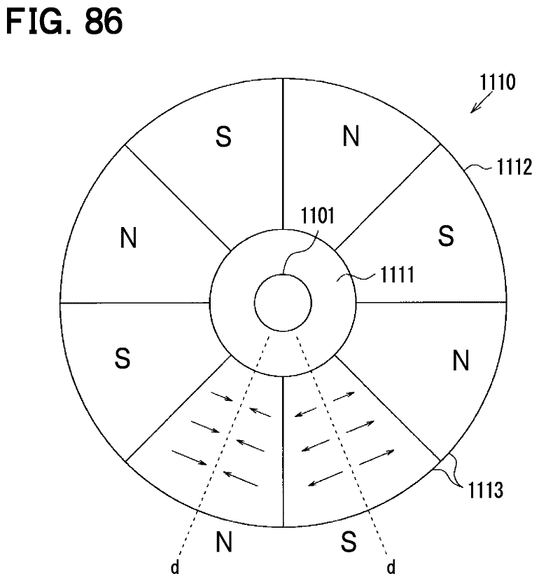

FIG. 86 is a diagram showing the direction of the magnetic flux path of each magnet 1113 on a plane perpendicular to the axial direction. In FIG. 86, in magnet 1113, the direction of the easy axis of magnetization is parallel on the radially inner side and the radially outer side, and a magnetic flux path is formed in which the north pole magnet is oriented toward the d-axis and the south pole magnet is oriented away from the d-axis.

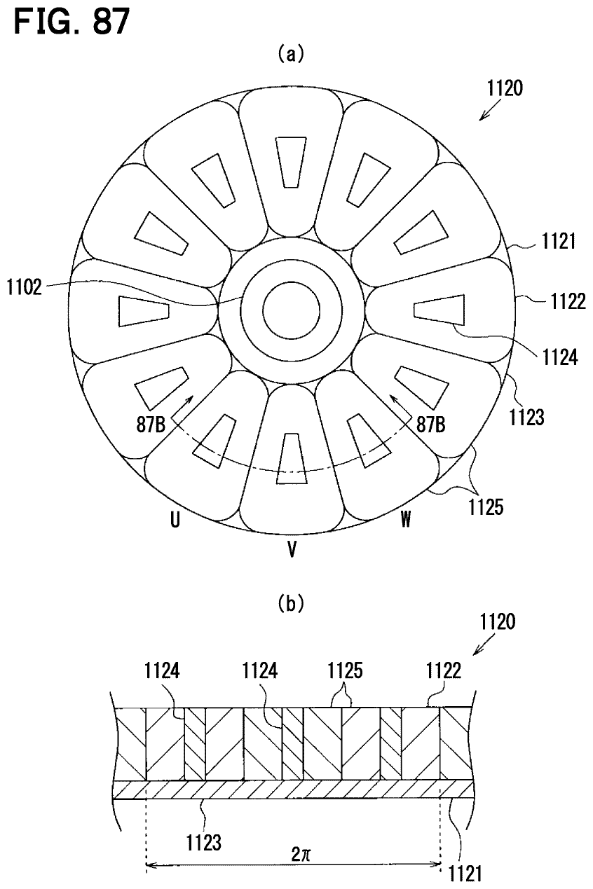

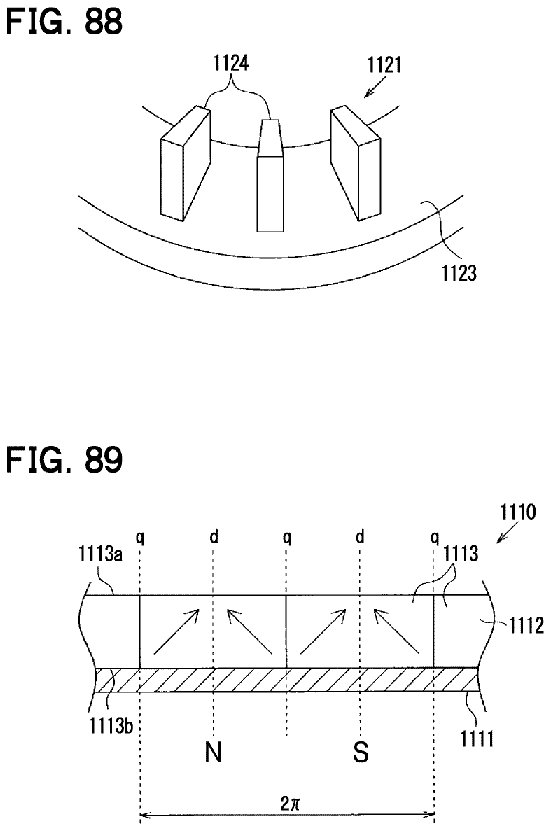

Next, the configuration of the stator 1120 will be described more specifically with reference to (a), (b) in FIGS. 87 and 88. In FIG. 87, (a) is a plan view showing the configuration of a stator 1120, and in FIG. 87, (b) is a cross-sectional view of the stator 1120 taken along line 87B-87B of (a) in FIG. 87. FIG. 88 is a perspective view showing the configuration of the stator core 1121.

As shown in (a), (b) in FIGS. 87 and 88, the stator core 1121 has a disk-shaped base portion 1123 and a plurality of columnar teeth 1124 extending axially from the base portion 1123. The teeth 1124 have a generally trapezoidal cross-sectional shape perpendicular to the axial direction that becomes wider radially outward, and are arranged at equal intervals circumferentially with the center of their short sides in the longitudinal direction facing toward the circular center of the stator core 1121. The axial ends of the teeth 1124 form flat surfaces perpendicular to the axial direction. Each of the teeth 1124 may have a generally rectangular cross-sectional shape with a uniform width on the radially outer side and the radially inner side.

A partial winding 1125 is wound around each of the teeth 1124. The partial winding 1125 is formed by winding a conductive wire multiple times around the teeth 1124. The partial windings 1125 are arranged, for example, such that the partial windings 1125 of different phases are arranged side by side in the circumferential direction. In other words, the stator winding 1122 has, for example, a U-phase winding, a V-phase winding, and a W-phase winding, and a U-phase partial winding 1125, a V-phase partial winding 1125, and a W-phase partial winding 1125 are arranged in a predetermined order in the circumferential direction. The partial winding 1125 is a concentrated winding coil, more specifically, a ⅔π short-pitch concentrated winding coil.

In addition, the partial winding 1125 may be made by winding a conductive wire in multiple layers and having its periphery covered with an insulating material such as synthetic resin. Alternatively, the partial winding 1125 may be integrated into a coil holder made of an insulating material. Although not shown in the figure, each partial winding 1125 is electrically connected to each other for each phase by a connecting member such as a bus bar.

In the stator core 1121, the teeth 1124 are formed from a powder magnetic core. The dust core is made by compression molding soft magnetic powder whose surface is covered with an insulating film, and is molded into the desired teeth shape. In this example, in the stator core 1121, the base portion 1123 is a laminated core in which a plurality of electromagnetic steel plates are laminated, and the teeth 1124 made of a powder magnetic core are fixed to the base portion 1123. However, it is also possible to mold the base portion 1123 and the teeth 1124 integrally using a powder magnetic core. Moreover, it is also possible to provide the base portion 1123 of the stator 1120 as a non-magnetic material.

### Modification of Eighth Embodiment

The configuration of the magnet unit 1112 in the rotor 1110 may be modified. For example, in the magnet unit 1112 shown in FIG. 89, the magnet 1113 has a magnetic flux action surface 1113a on the stator 1120 side (upper side of the figure) and a magnetic flux action surface 1113b on the opposite side, anti-stator side, and between these magnetic flux action surfaces 1113a, 1113b, the direction of the axis of easy magnetization is inclined with respect to the d-axis. Moreover, the coils are configured to be linearly oriented in the circumferential direction (left-right direction in the figure) so that they approach the d-axis on the stator 1120 side and move away from the d-axis on the opposite stator side. According to this configuration, a suitable configuration can be achieved for making the surface magnetic flux density distribution in the magnet unit 1112 a sine wave, and it is possible to achieve appropriate motor torque in the axial gap type rotary electric machine 1100 that uses the stator core 1121 whose teeth 1124 are made of a powder magnetic core.

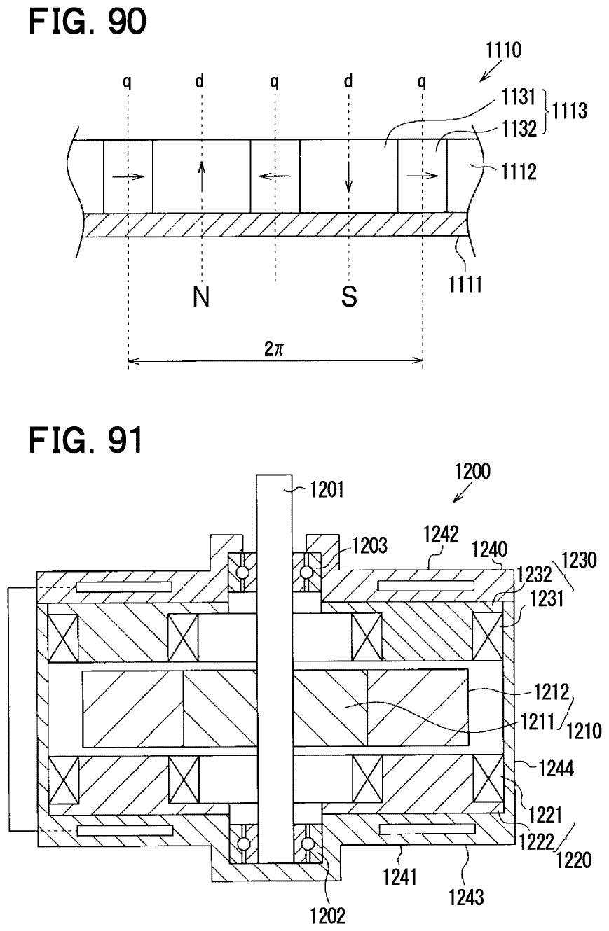

Also, as shown in FIG. 90, the magnet unit 1112 may have a Halbach array magnet structure. The magnet unit 1112 has, as magnets 1113, a first magnet 1131 whose magnetic path direction is the circumferential direction and a second magnet 1132 whose magnetic path direction is the circumferential direction, with the first magnet 1131 arranged on the d axis of each magnetic pole and the second magnet 1132 arranged on the q axis of each magnetic pole. In this configuration as well, the magnetic flux generated on the magnetic flux action surface of the magnet unit 1112 on the stator 1120 side in the axial direction can be concentrated in the region near the d-axis.

The double stator type rotary electric machine described in the sixth embodiment may be embodied as an axial gap type rotary electric machine 1200. FIG. 91 is a vertical cross-sectional view showing the configuration of the axial gap type rotary electric machine 1200.

In FIG. 91, the rotary electric machine 1200 includes a rotor 1210 fixed to a rotary shaft 1201 so as to be rotatable integrally therewith, a first stator 1220 and a second stator 1230 respectively provided on one side and the other side of the rotor 1210 in the axial direction, and a stator holder 1240 as a stator holding member for holding each of these stators 1220, 1230. The rotary shaft 1201 is rotatably supported by a pair of bearings 1202 and 1203 provided in the stator holder 1240.

The rotor 1210 has a disk-shaped rotor plate 1211 fixed to the rotary shaft 1201 and an annular magnet unit 1212 fixed to the radially outer side of the rotor plate 1211. The rotor plate 1211 functions as a magnet holding member. The magnet unit 912 has a plurality of magnets 913 arranged so that their polarities alternate along the circumferential direction of the rotor 910. As a result, the magnet unit 1212 has a plurality of magnetic poles in the circumferential direction. The magnet unit 912 corresponds to a “magnet unit”. Although not shown, the magnet unit 1212 has an annular rotor core fixed to the radially outer side of the rotor plate 1211, and a plurality of magnets are fixed to the rotor core at predetermined intervals in the circumferential direction. The magnet is a parallel anisotropic permanent magnet whose magnetization direction is the axial direction. The axis of easy magnetization (and the magnetic flux path) may be modified as desired, as described in the above embodiments.

The first stator 1220 is arranged opposite one axial side of the rotor 1210 with a specified air gap between them, and the second stator 1230 is arranged opposite the other axial side of the rotor 1210 with a specified air gap between them. The first stator 1220 has a stator winding 1221 and a stator plate 1222, and the second stator 1230 has a stator winding 1231 and a stator plate 1232. The stator windings 1221, 1231 are wound around teeth provided at predetermined intervals in the circumferential direction of each of the stator plates 1222, 1232.

The stator holder 1240 has a holder body 1241 having a cylindrical shape with a bottom, and a cover 1242 fixed to one axial end of the holder body 1241. The holder body 1241 has a disk-shaped end plate portion 1243 and a cylindrical portion 1244 extending axially from the end plate portion 1243. The first stator 1220 is fixed to the axially inner side of the end plate portion 1243 of the holder body 1241, and the second stator 1230 is fixed to the axially inner side of the cover 1242. The magnet unit 1212 of the rotor 1210 is disposed between the first stator 1220 and the second stator 1230.

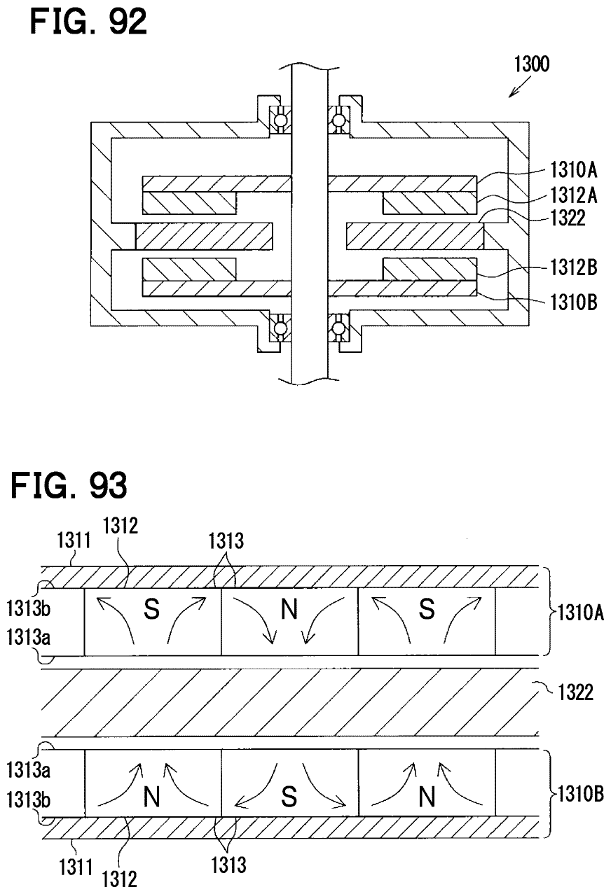

The rotary electric machine may be an axial gap type rotary electric machine employing a double rotor structure as described in the seventh embodiment. FIG. 92 is a vertical cross-sectional view showing a schematic configuration of an axial gap type rotary electric machine 1300 employing a double rotor structure. In FIG. 92, the up-down direction is the axial direction, and the left-right direction is the circumferential direction.

The rotary electric machine 1300 has a first rotor 1310A provided on one axial side and a second rotor 1310B provided on the other axial side, with a stator winding 1322 sandwiched therebetween. As shown in FIG. 93, the first rotor 1310A and the second rotor 1310B each include magnet units 1312A, 1312B having a plurality of magnets 1313 arranged in the circumferential direction, and each of the magnet units 1312A, 1312B generates magnetic flux concentrated in the area near the d-axis, which is the magnetic pole center, on the magnetic flux action surface on the stator winding 1322 side of the magnet.

In addition, magnet units 1312 of the rotors 1310A and 1310B have magnetic poles that are different from each other in the axial direction. In addition, each magnet 1313 is configured with an orientation such that the axis of easy magnetization on the d-axis side is parallel to the d-axis compared to the q-axis side, and this orientation forms an arc-shaped magnetic flux path. Of the two axial faces of each magnet 1313, the outer face on the opposite side to the stator (magnetic flux action surface 1313b) may be a magnet outer face where no magnetic flux flows in or out. Also, the axis of easy magnetization (and the magnetic flux path) may be bent into a substantially L-shape as in the fifth embodiment.

The magnet 1313 may be configured so that the direction of the axis of easy magnetization is oblique to the axial direction between a magnetic flux action surface 1313a on the stator winding 1322 side and the magnetic flux action surface 1313b on the opposite side, the anti-stator side, and is oriented so that in the circumferential direction, it is closer to the d-axis on a stator 1320 side and is away from the d-axis on the anti-stator side.

In the above configuration, the magnets 1313 of the magnet units 1312 in each rotor 1310A, 1310B generate magnetic flux concentrated in the area near the d-axis on the magnetic flux action surface 1313a on the stator 1320 side, thereby further strengthening the interlinked magnetic flux that interlinks with the stator winding 1322.

### Other Modifications

In the above embodiment, the bearings 12, 13, 407, and 408 are not limited to ball bearings, and roller bearings may be used. Furthermore, instead of radial ball bearings, thrust ball bearings or thrust roller bearings may be used.

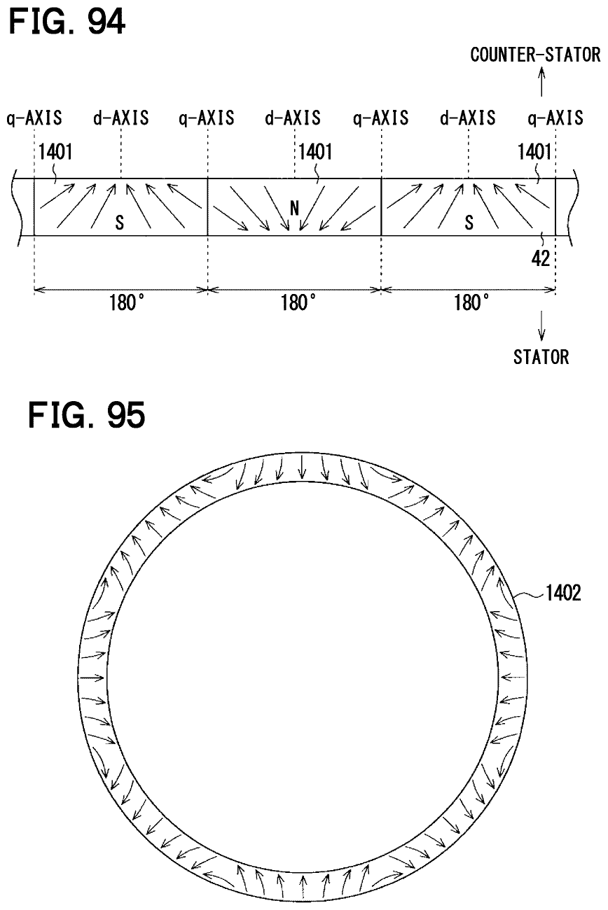

In the above embodiment, a diagonal parallel oriented magnet 1401 as shown in FIG. 94 may be used. In FIG. 94, multiple linear magnetic flux paths (axis of easy magnetization) are provided in parallel so as to be inclined toward the d-axis. This makes it possible to improve the magnetic flux density while still achieving a thin magnet. Also, as shown in FIG. 95, a magnet 1402 may be used which is a circular ring-shaped magnet in which multiple radial magnetic paths are formed for each magnetic pole. FIG. 95 shows an example of the magnet 1402 in the case of an inner rotor. It is preferable that the centers of the plurality of radially formed magnetic flux paths are located closer to the stator core than the air gap formed between the stator and each of the magnetic flux paths.

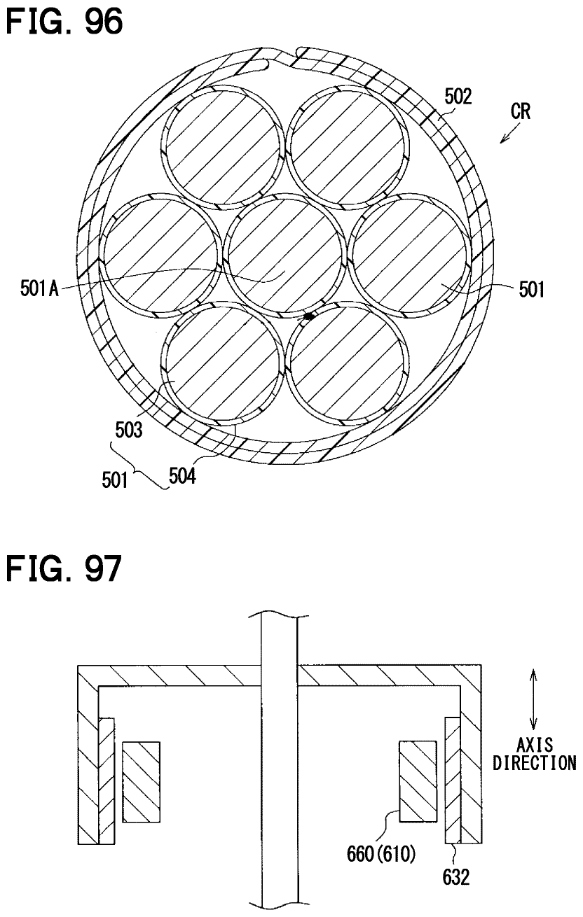

In the above embodiment, when the conductor wire CR is configured as a twisted wire, it is desirable to use 7-parallel, 19-parallel, 37-parallel, or the like. FIG. 96 shows an example of a 7-parallel twisted wire. In FIG. 96, seven wires 501 are twisted together and covered with an insulating coating 502 to form a conductor wire CR. Incidentally, the wire 501 in FIG. 96 is the same as the wire 501 in the third embodiment. In this configuration, when the stranded wire is compressed, a central strand 501A receives stress, making it easy to compress the stranded wire. In addition, when using an even number of parallel twisted wires, it is desirable to use a Rutherford cable (Rutherford winding) in which a large number of wires are twisted together to form a rectangular cross section. By using twisted wire, the power factor can be increased by basically lowering the self-inductance.

In the fourth embodiment, as shown in FIG. 97, the axial dimension of the magnet 632 may be larger than that of the stator 660 (particularly the teeth 610). This provides an advantage in that the axial center of the magnetic circuit can be maintained by magnetic force. The axial dimension of the stator 660 may be larger than that of the magnet 632. In this case, it is desirable to use a magnetic material for the teeth 610 such that, when the surface area (surface area on the rotor side) of the teeth 610 in one magnetic pole is St, the saturation magnetic flux density of the teeth 610 is B100, the surface area (surface area of the magnetic flux acting surface) of the magnet 632 in one magnetic pole is Sm, and the residual magnetic flux density of the magnet 632 is Br, the relationship St×B100≤Sm×Br is satisfied.

In addition, when an axial gap type rotary electric machine as shown in the eighth embodiment is adopted, it is desirable to similarly design based on the surface area. That is, for the teeth 1124 (see FIG. 87), if the surface area (surface area on the rotor side) of the teeth 1124 in one magnetic pole is St, the saturation magnetic flux density of the teeth 1124 is B100, the surface area (surface area of the magnetic flux acting surface, see FIG. 85) of the magnet 1113 in one magnetic pole is Sm, and the residual magnetic flux density of the magnet 1113 is Br, it is desirable to use a magnetic material that satisfies the relationship St× B100≤ Sm× Br.

Characteristic configurations extracted from each of the above-described embodiments will be described below.

### [Configuration 1]

A rotary electric machine comprises: a field element (20) including a magnet unit (622) having a plurality of magnetic poles, in which polarities alternate in a circumferential direction; and an armature (660) including a multi-phase armature winding (661). The field element or the armature is a rotor. The magnet unit includes a plurality of magnets (632) arranged in the circumferential direction. The magnet unit is configured, so that a direction of an easy axis of magnetization is closer to parallel to a d-axis on a side of the d-axis, which is a magnetic pole center, than an easy axis of magnetization on a side of the q-axis, which is a magnetic pole boundary. The armature winding includes conductor portions (652) arranged at predetermined intervals in the circumferential direction and facing the field element, and an inter-conductor member (610) provided between the conductor portions in the circumferential direction. The inter-conductor member is made of a magnetic material that satisfies a relationship Wt×B100≤ Wm×Br. Wt is a circumferential width of the inter-conductor member in one magnetic pole. B100 is a saturation magnetic flux density of the inter-conductor member. Wm is a circumferential width of the magnet in one magnetic pole. Br is a residual magnetic flux density of the magnet. B100 is the saturation magnetic flux density calculated with a magnetic flux density under a magnetizing force of 10,000 A/m.

### [Configuration 2]

The rotary electric machine is according to the configuration 1. The armature winding is formed by a concentrated winding. The inter-conductor member includes a plurality of the inter-conductor members in one magnetic pole of the magnet unit. Wt is a sum of widths of the inter-conductor members in one magnetic pole of the magnet unit in the circumferential direction.

### [Configuration 3]

The rotary electric machine is according to the configuration 1 or 2. The circumferential widths of the inter-conductor members are not uniform in the radial direction. Wt is a narrowest value among the circumferential widths of the inter-conductor members.

### [Configuration 4]

The rotary electric machine is according to the any one of configurations 1 to 3. The magnet unit is formed by arranging a plurality of first magnets (632a) and a plurality of second magnets (632b) alternately in the circumferential direction. A magnetic flux path of the first magnet is closer to parallel to a radial direction than a magnetic flux path of the second magnet. The first magnet is provided on the side of the d-axis. The second magnet is provided on the side of the q-axis. Wm is the circumferential width of the magnet unit in one magnetic pole that is calculated by a sum of a circumferential width of the first magnet in one magnetic pole and a circumferential width of the second magnet in the one magnetic pole.

### [Configuration 5]

The rotary electric machine is according to the any one of configurations 1 to 4. The magnet unit is formed by embedding the magnet in an iron core (631). The magnet is divided into a plurality of magnet portions in one magnetic pole. Wm is obtained by subtracting a circumferential width of a gap between the magnet portions from a circumferential width from an end of the magnet to an end of the magnet in the one magnetic pole.

### [Configuration 6]

The rotary electric machine is according to any one of configurations 1 to 5. The conductor portion has a cross section in a flat shape between the inter-conductor wire members. The cross section is longer in the circumferential direction than the cross section in the radial direction.

### [Configuration 7]

The rotary electric machine is according to the any one of configurations 1 to 6. The conductor portion is formed by bundling a wire.

Next, characteristic configurations 11 to 17 extracted from the above-mentioned fifth embodiment will be described.

Conventionally, in order to improve the output torque of rotary electric machines, technology has been proposed for improving maximum magnetic flux density by employing sintered magnets with an improved orientation direction of the axis of easy magnetization (for example, JP 2015-228762A).

In the magnets described above, it is generally desirable to configure the magnetic flux path as long as possible in order to improve the magnetic flux density. However, when a magnet is produced by forming alloy powder in a magnetic field former, while aligning the easy axis of magnetization of the alloy powder in the magnetic field direction, the shape of the easy axis of magnetization, i.e., the shape of the magnetic path of the magnet, depends on the magnetic field direction. For this reason, it is difficult to bend the magnetic flux path of the magnet extremely, and in this case, it is necessary to increase the thickness of the magnet or allow magnetic flux leakage.

Configurations 11 to 17 described below have been made in consideration of the above circumstances, and their main purpose is to provide a rotary electric machine that is thin and has a magnet with a long magnetic magnetic path, and a manufacturing method for the magnet.

### [Configuration 11]

A rotary electric machine comprising: a field element having a magnet unit (22) in which a plurality of magnets are arranged in a circumferential direction; and an armature having a multi-phase armature winding. Either the field element or the armature is a rotor. The magnet unit includes a plurality of magnets (732) arranged in a circumferential direction. The magnet is divided on a side of a d-axis, which is a magnetic pole center. When viewed from an axial direction of the rotary shaft of the rotor, the magnet includes an armature-side peripheral surface (734) facing the armature, an anti-armature-side peripheral surface (735) located on an opposite side of the armature in the radial direction, and a side surface (736, 737) along a radial direction at both ends of the magnet in the circumferential direction. The magnet has an easy axis of magnetization in a d-axis side portion, which extends along the side surface (737) on the side of the d-axis, then bends along the anti-armature side circumferential surface in the anti-armature side circumferential surface portion, and extends toward the side of the q-axis.

### [Configuration 12]

The rotary electric machine is according to configuration 11. A radius of curvature of a bent portion of the easy axis of magnetization, which extends along a d-axis side surface and then bends at a portion of the anti-armature side circumferential surface, is smaller than a radius of curvature of an arc (ARC) that has a center point (P100) on the q-axis and passes through an intersection (P101) between the d-axis and the armature side circumferential surface.

### [Configuration 13]

The rotary electric machine is according to the configuration 11 or 12. In the armature side peripheral surface of the magnet, a radius of curvature of a curved portion of the easy axis of magnetization (EAM1) on the side of the d-axis is smaller than a radius of curvature of a curved portion of the easy axis of magnetization (EAM2) on the side of the q-axis.

### [Configuration 14]

A manufacturing method is for a magnet to be used in a magnet section of a rotary electric machine. The rotary electric machine comprises: a field element having a magnet unit (22) having a plurality of magnetic poles in which polarities alternate in a circumferential direction; and an armature including a multi-phase armature winding. Either the field element or the armature is a rotor. The magnet unit includes a plurality of magnets (732) arranged in a circumferential direction. The magnet is divided on a side of a d-axis, which is a magnetic pole center. When viewed from an axial direction of the rotary shaft of the rotor, the magnet includes an armature-side peripheral surface (734) facing the armature, an anti-armature-side peripheral surface (735) located on an opposite side of the armature in the radial direction, and a side surface (736, 737) along a radial direction at both ends of the magnet in the circumferential direction. The armature-side peripheral surface has a recess (734a) recessed in the radial direction on the q-axis side, which is a magnetic pole boundary. The manufacturing method comprises: a shaping step (S101) of compressing and molding an alloy powder while aligning an easy axis of magnetization of the alloy powder in a predetermined direction using a magnetic field forming machine; a plastic forming step (S102) of pressing a molded body (800) obtained in the shaping step into a die (801) to bend the easy axis of magnetization and plastically form the molded body so that a shape of the molded body becomes a shape of the magnet; and a magnetization step (S103) of magnetizing the plastically formed product obtained in the plastic forming step to produce the magnet. The die has a cavity (802) with an opening (803) at one end and a bottom surface (804) at an other end. The side walls forming the cavity include a first side wall (805) formed in a planar shape corresponding to the d-axis side surface of the magnet, and a second side wall (806) facing the first side wall and formed in correspondence with the recess of the magnet. The second side wall is formed with a lateral hole (807) extending along the bottom surface of the cavity. In the plastic forming process, the molded body is pushed from the opening of the cavity along the direction of the molded body's easy axis of magnetization, and is further pushed even after the molded body hits the bottom surface, thereby bending the molded body so as to escape along the bottom surface into the lateral hole, and thereby bending the easy axis of magnetization to extend along the first side wall and the bottom surface.

### [Configuration 15]

The manufacturing method for the magnet is according to claim 14. In the plastic forming step, when the compact is pressed into the opening of the cavity, a vector direction of a pressing force is inclined obliquely with respect to the first side wall side so as to direct the molded body from the side of the first side wall toward the side of the second side wall.

### [Configuration 16]

The manufacturing method for the magnet is according to claim 14 or 15. The distance from the first side wall to the second side wall is gradually increased in a direction from the opening toward the bottom surface.

### [Configuration 17]

The manufacturing method is according to any one of configurations 14 to 16. The second side wall has a curved surface. A curved surface (805a) is provided between the first side wall and the bottom surface to guide the pressed molded body into the lateral hole. A radius of curvature of the curved surface between the first side wall and the bottom surface is smaller than a radius of curvature of the second side wall.

The disclosure in the present specification is not limited to the illustrated embodiments. The disclosure encompasses the illustrated embodiments and modifications based on the embodiments by those skilled in the art. For example, the disclosure is not limited to the combinations of components and/or elements shown in the embodiments. The disclosure may be implemented in various combinations. The disclosure may have additional portions that may be added to the embodiments. The disclosure encompasses omission of components and/or elements of the embodiments. The disclosure encompasses the replacement or combination of components and/or elements between one embodiment and another. The disclosed technical scope is not limited to the description of the embodiments. Several technical scopes disclosed are indicated by descriptions in the claims and should be understood to include all modifications within the meaning and scope equivalent to the descriptions in the claims.

Although the present disclosure has been described in accordance with the embodiments, it is understood that the present disclosure is not limited to the embodiments and structures disclosed therein. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. A rotary electric machine comprising:
a field element including a magnet unit having a plurality of magnetic poles, in which polarities alternate in a circumferential direction; and
an armature including a multi-phase armature winding, wherein
the field element or the armature is a rotor,
the magnet unit includes a plurality of magnets arranged in the circumferential direction,
the magnet unit is configured, so that a direction of an easy axis of magnetization is closer to parallel to a d-axis on a side of the d-axis, which is a magnetic pole center, than an easy axis of magnetization on a side of a q-axis, which is a magnetic pole boundary,
the armature winding includes
conductor portions arranged at predetermined intervals in the circumferential direction and facing the field element, and
an inter-conductor member provided between the conductor portions in the circumferential direction, and
the inter-conductor member is made of a magnetic material that satisfies a relationship Wt×B100≤Wm×Br, wherein
Wt is a circumferential width of the inter-conductor member in one magnetic pole,
B100 is a saturation magnetic flux density of the inter-conductor member,
Wm is a circumferential width of the magnet in one magnetic pole, and
Br is a residual magnetic flux density of the magnet, wherein
B100 is calculated with a magnetic flux density under a magnetizing force of 10,000 A/m.

2. The rotary electric machine according to claim 1, wherein
the armature winding is formed by a concentrated winding,
the inter-conductor member includes a plurality of the inter-conductor members in one magnetic pole of the magnet unit, and
Wt is a sum of widths of the inter-conductor members in one magnetic pole of the magnet unit in the circumferential direction.

3. The rotary electric machine according to claim 1, wherein
circumferential widths of the inter-conductor members are not uniform in a radial direction, and
Wt is a narrowest value among the circumferential widths of the inter-conductor members.

4. The rotary electric machine according to claim 1, wherein
the magnet unit is formed by arranging a plurality of first magnets and a plurality of second magnets alternately in the circumferential direction,
a magnetic flux path of the first magnet is closer to parallel to a radial direction than a magnetic flux path of the second magnet,
the first magnet is provided on the side of the d-axis,
the second magnet is provided on the side of the q-axis, and
Wm is the circumferential width of the magnet unit in one magnetic pole that is calculated by a sum of a circumferential width of the first magnet in one magnetic pole and a circumferential width of the second magnet in the one magnetic pole.

5. The rotary electric machine according to claim 1, wherein
the magnet unit is formed by embedding the magnet in an iron core,
the magnet is divided into a plurality of magnet portions in one magnetic pole, and
Wm is obtained by subtracting a circumferential width of a gap between the magnet portions from a circumferential width from an end of the magnet to an end of the magnet in the one magnetic pole.

6. The rotary electric machine according to claim 1, wherein
the conductor portion has a cross section in a flat shape between the inter-conductor wire members, and
the cross section is longer in the circumferential direction than the cross section in a radial direction.

7. The rotary electric machine according to claim 1, wherein
the conductor portion is formed by bundling a wire.
